(19) United States
(12) Patent Application Publication
(10) Pub. No.: US 2004/0214721 A1
(43) Pub. Date: Oct. 28, 2004

(54) Novel n-bisaryl- and n-aryl-cycloalkylidenyl-alpha-sulfin- and alpha-sulfonamino acid amides

(76) Inventors: Andre Jeanguenat, Basel (CH); Clemens Lamberth, Basel (CH); Martin Zeller, Muenchwilen (CH)

Correspondence Address: SYNGENTA CROP PROTECTION , INC., PATENT AND TRADEMARK DEPARTMENT, 410 SWING ROAD, GREENSBORO, NC, 27409, US

(21) Appl. No.: 10/481,967

(22) PCT Filed: Jun. 25, 2002
(86) PCT No.: PCT/EP02/07027

(30) Foreign Application Priority Data
Jun. 26, 2001 (GB) 0115602.5

(51) Int. Cl. A01N 41/06

(52) U.S. Cl. 504/333; 564/86

(57) ABSTRACT

The invention relates to novel pesticidally active N-bisaryl-and N-aryl-cycloalkylidenyl-α-sulfin-and α-sulfonamino acid amides of the general formula I, including the optical isomers thereof and mixtures of such isomers, wherein n is a number zero or one; R₁ is C₁-C₁₂alkyl; C₁-C₁₂alkyl substituted with C₁-C₄alkoxy, C₁-C₄alkylthio, C₁-C₄alkylsulfonyl, C₃-C₈cycloalkyl, cyano, C₁-C₆alkoxycarbonyl, C₃-C₆alkoxycarbonyl, C₃-C₆alkenyloxycarbonyl or C₃-C₆alkynyloxycarbonyl; C₂-C₁₂alkenyl; C₂-C₁₂alkynyl; C₁-C₁₂haloalkyl; or a group NR₁₁R₁₂ wherein R₁₁ and R₁₂ are each independently of the other C₁-C₆alkyl, or together are tetra- or penta-methylene; R₂ and R₃ ae each independently hydrogen; C₁-C₈alkyl; C₁-C₈alkyl substituted with hydroxy, mercapto, C₁-C₄alkoxy or C₁-C₄alkylthio; C₃-C₈alkenyl; C₃-C₈alkynyl; C₃-C₈cycloalkyl; C₃-C₈cycloalkyl-C₁-C₄alkyl; optionally substituted aryl; optionally substituted heteroaryl; or the two groups R₂ and R₃ together with the carbon atom to which they are bonded form a three- to eight-membered hydrocarbon ring; A is an optionally substituted saturated or unsaturated C₃-C₈-cycloalkylidene, optionally substituted phenylidene or optionally substituted saturated or unsaturated heterocyclylidene bridge, R₄ and R₅ are each independently hydrogen or an organic radicak, and R₆ is hydrogen; tri-C₁C₄alkyl-silyl; di-C₁-C₄alkyl-phenysilyl; C₁-C₄alkyl-diphenylsilyl; tri-phenylsilyl; optionally subsituted alkyl; optionally substituted alkenyl or optionally substituted alkynyl. The novel compounds possess plant-protecting properties and are suitable for protecting plants against infestation by phytophathogenic microorganisms.

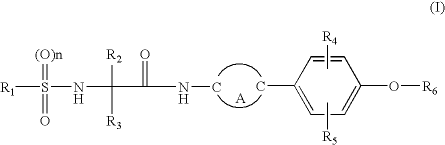

The present invention relates to novel N-bisaryl- and N-aryl-cycloalkylidenyl-α-sulfin- and α-sulfonamino acid amides of formula I below. It relates to the preparation of those substances and to agrochemical compositions comprising at least one of those compounds as active ingredient. The invention relates also to the preparation of the said compositions and to the use of the compounds or of the compositions in controlling or preventing the infestation of plants by phytopathogenic microorganisms, especially fungi.

The invention relates to N-bisaryl- and N-aryl-cycloalkylidenyl-α-sulfin- and α-sulfonamino acid amides of the general formula I

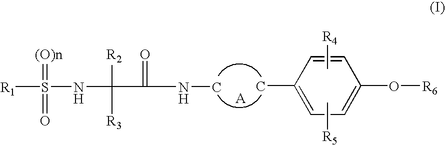

including the optical isomers thereof and-mixtures of such isomers,

wherein

n is a number zero or one;

R₁ is C₁-C₁₂alkyl; C₁-C₁₂alkyl substituted with C₁-C₄alkoxy, C₁-C₄alkylthio, C₁-C₄alkylsulfonyl, C₃-C₈cycloalkyl, cyano, C₁-C₆alkoxycarbonyl, C₃-C₆alkenyloxycarbonyl or C₃-C₆alkynyloxy-carbonyl; C₂-C₁₂alkenyl; C₂-C₁₂alkynyl; C₁-C₁₋₂haloalkyl; or a group NR₁₁R₁₂ wherein R₁₁ and R₁₂ are each independently of the other C₁-C₆alkyl, or together are tetra- or penta-methylene;

R₂ and R₃ are each independently hydrogen; C₁-C₈alkyl; C₁-C₈alkyl substituted with hydroxy, mercapto, C₁-C₄alkoxy or C₁-C₄alkylthio; C₃-C₈alkenyl; C₃-C₈alkynyl; C₃-C₈cycloalkyl; C₃-C₈cycloalkyl-C₁-C₄alkyl; optionally substituted aryl; optionally substituted heteroaryl; or the two groups R₂ and R₃ together with the carbon atom to which they are bonded form a three- to eight-membered hydrocarbon ring;

A is an optionally substituted saturated or unsaturated C₃-C₈-cycloalkylidene, optionally substituted phenylidene or optionally substituted saturated or unsaturated heterocyclylidene bridge,

R₄ and R₅ are each independently hydrogen or an organic radical, and

R₆ is hydrogen; tri-C₁-C₄alkyl-silyl; di-C₁-C₄alkyl-phenylsilyl; C₁-C₄alkyl-diphenylsilyl; tri-phenylsilyl; optionally substituted alkyl; optionally substituted alkenyl or optionally substituted alkynyl.

In the above definition aryl includes aromatic hydrocarbon rings like phenyl, naphthyl, anthracenyl, phenanthrenyl, with phenyl being preferred.

Heteroaryl stands for aromatic ring systems comprising mono-, bi- or tricyclic systems being formed by 1 or 2 five- to six-membered condensed rings wherein at least one oxygen, nitrogen or sulfur atom is present as a ring member. Typically heteroaryl comprises 1 to 4 identical or different heteroatoms selected from nitrogen, oxygen and sulfur, wherein the number of oxygen and sulfuratoms normally does not exceed one. Examples are furyl, thienyl, pyrrolyl, imidazolyl, pyrazolyl, thiazolyl, isothiazolyl, oxazolyl, isoxazolyl, oxadiazolyl, thiadiazolyl, triazolyl, tetrazolyl, pyridyl, pyridazinyl, pyrimidinyl, pyrazinyl, triazinyl, tetrazinyl, indolyl, benzothiophenyl, benzofuranyl, benzimidazolyl, indazolyl, benzotriazolyl, benzothiazolyl, benzoxazolyl, quinolinyl, isoquinolinyl, phthalazinyl, quinoxalinyl, quinazolinyl, cinnolinyl and naphthyridinyl.

The above aryl and heteroaryl groups may carry one or more identical or different substituents. Normally not more than three substituents are present at the same time. Examples of substituents of aryl or heteroaryl groups are: alkyl, alkenyl, alkynyl, cycloalkyl, cycloalkyl-alkyl, phenyl and phenyl-alkyl, it being possible in turn for all of the preceding groups to carry one or more identical or different halogen atoms; alkoxy; alkenyloxy; alkynyloxy; alkoxyalkyl; haloalkoxy, alkylthio; haloalkylthio; alkylsulfonyl; formyl; alkanoyl; hydroxy; halogen; cyano; nitro; amino; alkylamino; dialkylamino; carboxyl; alkoxycarbonyl; alkenyloxycarbonyl; alkynyloxycarbonyl.

In the above definitions “halogen” or the prefix “halo” includes fluorine, chlorine, bromine and iodine.

The alkyl, alkenyl and alkynyl radicals may be straight-chain or branched. This applies also to the alkyl, alkenyl or alkynyl parts of other alkyl-, alkenyl- or alkynyl-containing groups.

The organic radical in R₄ and R₅ indicates that practically every substituent used in the art of organic chemistry may be placed in the indicated position at the phenylene bridge member. Preferred are however the more frequently used radicals like C₁-C₈alkyl; C₂-C₈alkenyl; C₂-C₈alkynyl; C₃-C₈cycloalkyl; C₃-C₈cycloalkyl-C₁-C₄alkyl; C₁-C₈alkylthio; C₁-C₈alkylsulfonyl; C₁-C₈alkoxy; C₃-C₈alkenyloxy; C₃-C₈alkynyloxy; C₃-C₈cycloalkoxy; C₁-C₈alkoxy-C₁-C₄alkyl; C₁-C₈alkoxycarbonyl; C₃-C₈alkenyloxycarbonyl; C₃-C₈alkynyloxycarbonyl; C₁-C₈alkanoyl; C₁-C₈dialkylamino; C₁-C₈alkylamino; wherein in each of the above radicals the alkyl, alkenyl, alkynyl or cycloalkyl moieties may be partially or fully halogenated; carboxyl; formyl; halogen; nitro; cyano; hydroxy or amino.

Depending upon the number of carbon atoms mentioned, alkyl on its own or as part of another substituent is to be understood as being, for example, methyl, ethyl, propyl, butyl, pentyl, hexyl, heptyl, octyl, nonyl, decyl, undecyl, dodecyl and the isomers thereof, for example isopropyl, isobutyl, tert-butyl or sec-butyl, isopentyl or tert-pentyl. Cycloalkyl is, depending upon the number of carbon atoms mentioned, cyclopropyl, cyclobutyl, cyclopentyl, cyclohexyl, cycloheptyl or cyclooctyl. Depending upon the number of carbon atoms mentioned, alkenyl as a group or as a structural element of other groups is to be understood as being, for example, ethenyl, allyl, 1-propenyl, buten-2-yl, buten-3-yl, penten-1-yl, penten-3-yl, hexen-1-yl, 4-methyl-3-pentenyl or 4-methyl-3-hexenyl.

Alkynyl as a group or as a structural element of other groups is, for example, ethynyl, propyn-1-yl, propyn-2-yl, butyn-1-yl, butyn-2-yl, 1-methyl-2-butynyl, hexyn-1-yl, 1-ethyl-2-butynyl or octyn-1-yl.

A haloalkyl group may contain one or more (identical or different) halogen atoms, and for example may stand for CHCl₂, CH₂F, CCl₃, CH₂Cl, CHF₂, CF₃, CH₂CH₂Br, C₂C₅, C₂F₅, CH₂Br, CHClBr, CF₃CH₂, etc.

Where R₂ and R₃ together with the carbon atom to which they are attached form a hydrocarbon ring the ring corresponds to cyclopropane, cyclobutane, cyclopentane, cyclohexane, cycloheptane or cyclooctane.

The bridge member A stands for a bivalent cyclic group (optionally substituted saturated or unsaturated C₃-C₈-cycloalkylidene, optionally substituted phenylidene or optionally substituted saturated or unsaturated heterocyclylidene) which comprises at least two carbon atoms as ring members which function as the linking ring members to the remainder of the molecule. The cyclic bivalent bridge bonded via two carbon atoms is either a hydrocarbon ring or a heterocyclic ring containing one to three heteroatoms selected from nitrogen, oxygen or sulfur, and which ring member may be of saturated, unsaturated or aromatic character, and may optionally carry one to three substituents being independently of each other selected from halogen, C₁-C₆alkyl, C₁-C₆alkoxy, C₁-C₆haloalkyl, C₁-C₆alkoxy-carbonyl, nitro or cyano. Typical examples for the bivalent cyclic bridge are cyclopropylidene, cyclopentylidene, cyclopentenylidene, cyclohexylidene, cyclohexenylidene, cyclohexadienylidene, bicyclohexylidene, cycloheptanylidene, bicycloheptylidene, norbonanylidene, norbonenylidene, phenylidene, naphthylidene, tetrahydrofuranylidene, tetrahydrothienylidene, pyrrolidinylidene, pyrazolidinylidene, triazolinylidene, thiazolidinylidene, isothiazolidinylidene, oxazolidinylidene, isoxazolidinylidene, piperidinylidene, piperazinylidene, morpholinylidene, furanylidene, thienylidene, pyrrolylidene, pyrazolylidene, triazolylidene, thiazolylidene, oxazolylidene, isothiazolylidene, isoxazolylidene, oxadiazolylidene, thiadiazolylidene, pyridinylidene, triazinylidene or pyrimidinylidene.

Preferred members of this group are those wherein the two linking carbon atoms have vicinal positions in the cyclic bridge member. However, also remarkable fungicidal activity is associated with other carbon-bonded cyclic bridge members A.

Non-limiting examples of A are the following:

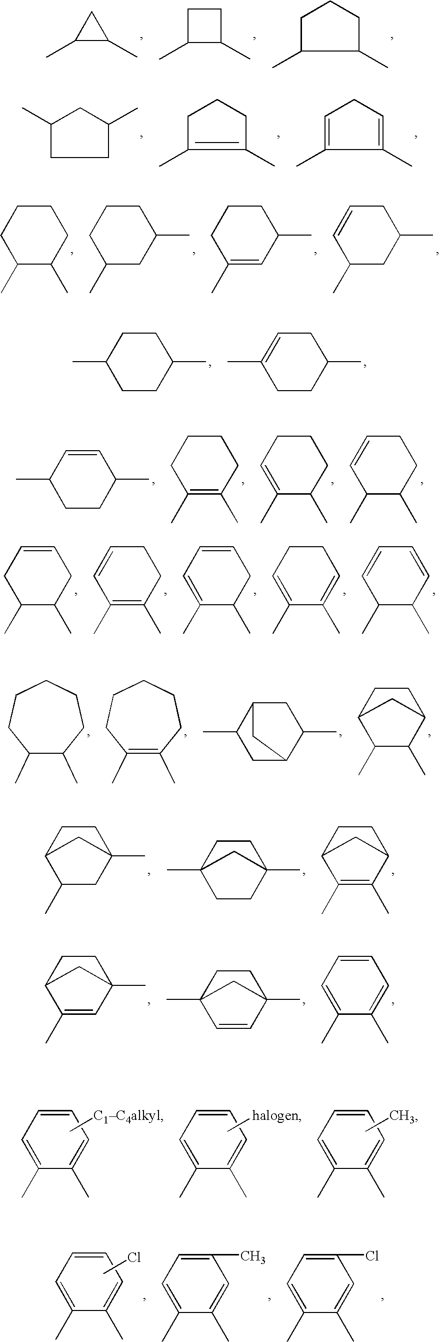

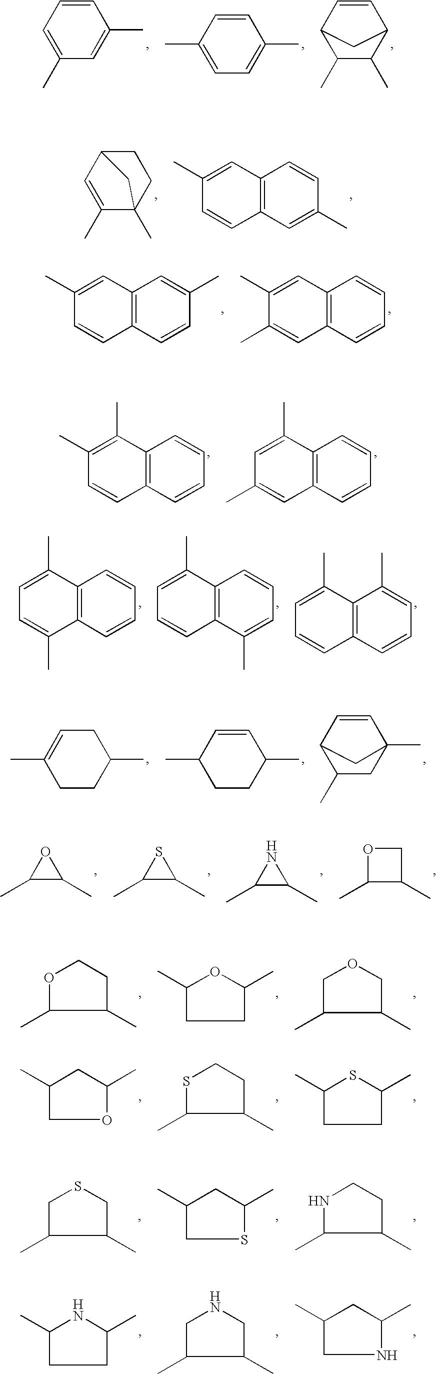

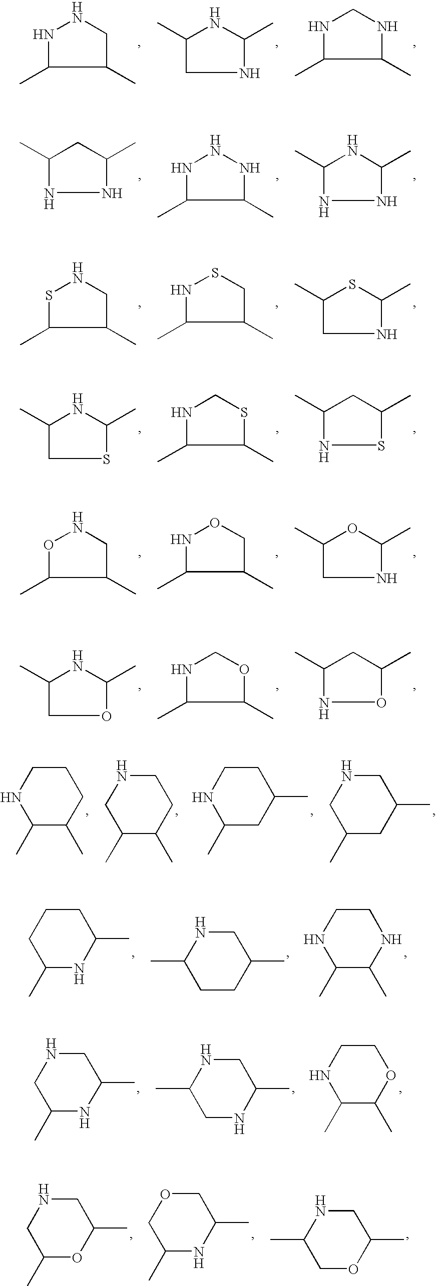

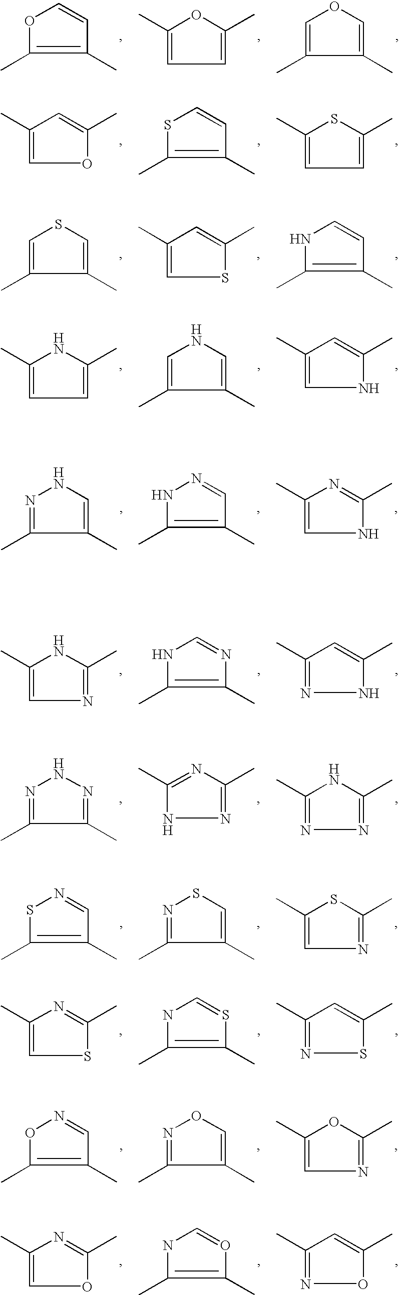

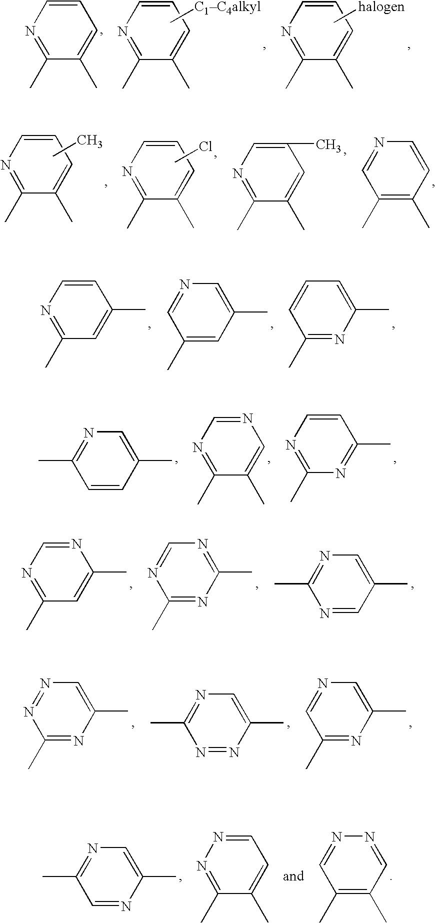

Preferred embodiments of the cyclic bridge A are the vicinally bonded ones:

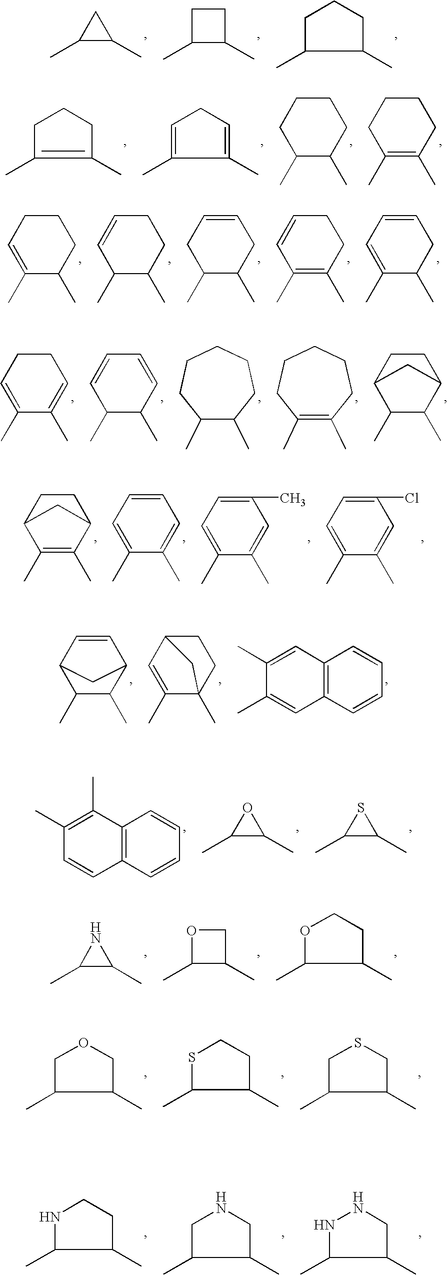

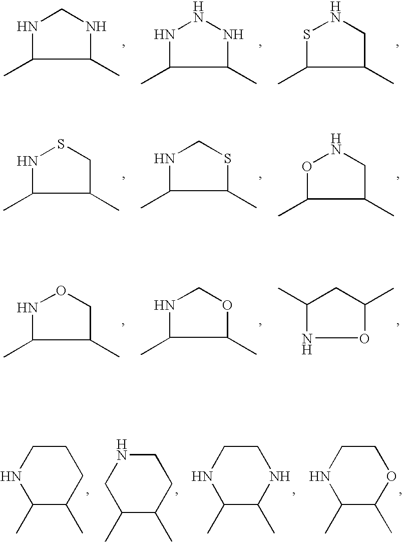

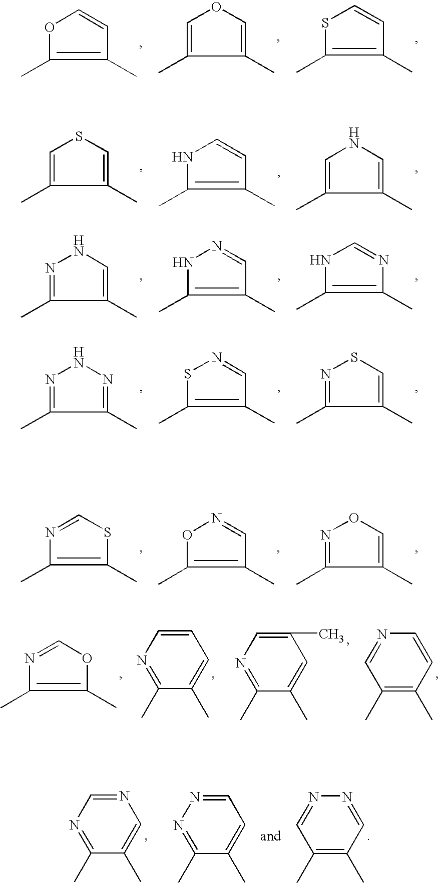

Even more preferred embodiments of the cyclic bridge A are:

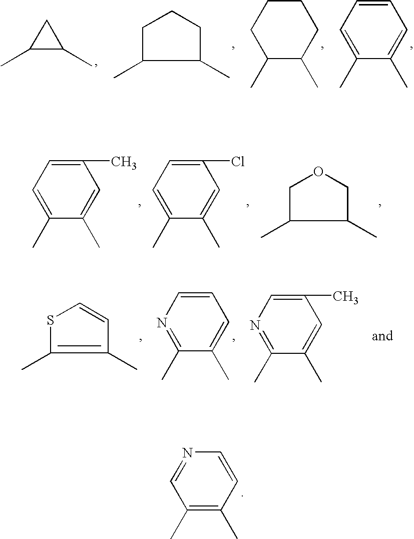

Within the definition of R₆ the optionally substituted alkyl, optionally substituted alkenyl or optionally substituted alkynyl, encompass C₁-C₁₀alkyl; C₃-C₁₀alkenyl; C₃-C₁₀alkynyl; C₁-C₁₀haloalkyl; C₃-C₁₀haloalkenyl; C₃-C₁₀haloalkynyl;

benzyl optionally substituted by C₁-C₈alkyl, C₂-C₈alkenyl, C₂-C₈alkynyl, C₃-C₈cycloalkyl, C₃₋₈cycloalkyl-C₁-C₄alkyl, C₁-C₈alkylthio, C₁-C₈alkylsulfonyl, C₁-C₈alkoxy, C₃-C₈alkenyloxy, C₃-C₈alkynyloxy, C₃-C₈cycloalkoxy, C₁-C₈alkoxy-C₁-C₄alkyl, C₁-C₈alkenyloxy-C₁-C₄alkyl, C₁-C₈alkynyloxy-C₁-C₄alkyl, C₁-C₈alkoxycarbonyl, C₃-C₈alkenyloxycarbonyl, C₃-C₈alkynyloxycarbonyl, C₁-C₈alkanoyl, C₁-C₈dialkylamino, C₁-C₈alkylamino (wherein the alkyl, alkenyl, alkynyl or cycloalkyl moieties may be partially or fully halogenated); carboxyl; formyl; halogen; nitro; cyano; hydroxy or amino;

a group —CR₇R₈-C≡C—B wherein R₇ and Re are independently hydrogen or C₁-C₄alkyl; and

B is either C₃-C₈cycloalkyl; phenyl or phenyl substituted by C₁-C₈alkyl, C₂C₈alkenyl, C₂-C₈alkynyl, C₃-C₈cycloalkyl, C₃-C₈cycloalkyl-C₁-C₄alkyl, C₁-C₈alkylthio, C₁-C₈alkylsulfonyl, C₁-C₈alkoxy, C₃-C₈alkenyloxy, C₃-C₈alkynyloxy, C₃-C₈cycloalkoxy, C₁-C₈alkoxy-C₁-C₄alkyl, C₁-C₈alkoxycarbonyl, C₃-C₈alkenyloxycarbonyl, C₃-C₈alkynyloxycarbonyl, C₁-C₈alkanoyl, C₁ C₈dialkylamino, C₁-C₈alkylamino (wherein the alkyl, alkenyl, alkynyl or cycloalkyl moieties may be partially or fully halogenated); carboxyl; formyl; halogen; nitro; cyano; hydroxy or amino; a group —CR₇R₈—CR₉R₁₀—X—B wherein R₇, R₈, R₉ and R₁₀ are independently hydrogen or C₁-C₄alkyl; X is —O—, —S— or —NR₁₃— where R₁₃ is hydrogen or C₁-C₄alkyl; and B is either C₃-C₈cycloalkyl; phenyl or phenyl substituted by C₁-C₈alkyl, C₂-C₈alkenyl, C₂-C₈alkynyl, C₃-C₈cycloalkyl, C₃-C₈cycloalkyl-C₁-C₄alkyl, C₁-C₈alkylthio, C₁-C₈alkylsulfonyl, C₁-C₈alkoxy, C₃-C₈alkenyloxy, C₃-C₈alkynyloxy, C₃-C₈cycloalkoxy, C₁-C₈alkoxy-C₁-C₄alkyl, C₁-C₈alkoxycarbonyl, C₃-C₈alkenyloxycarbonyl, C₃-C₈alkynyloxycarbonyl, C₁-C₈alkanoyl, C₁-C₈dialkylamino, C₁-C₈alkylamino (where all these alkyl, alkenyl, alkynyl or cycloalkyl containing groups may be partially or fully halogenated); carboxyl; formyl; halogen; nitro; cyano; hydroxy; or amino.

The presence of at least one asymmetric carbon atom and/or at least one asymmetric oxidized sulfur atom in the compounds of formula I means that the compounds may occur in optically isomeric forms. As a result of the presence of a possible aliphatic C═C double bond, geometric isomerism may also occur. Formula I is intended to include all those possible isomeric forms and mixtures thereof.

Preferred subgroups of compounds of formula I are those wherein

n is one; or

R₁ is C₁-C₁₂alkyl; C₁-C₁₂alkyl substituted with C₁-C₄alkoxy, C₁-C₄alkylthio or C₁-C₄alkylsulfonyl; C₂-C₁₂alkenyl; C₂-C₁₂alkynyl; C₁-C₁₂haloalkyl or a group NR₁₁R₁₂ wherein R₁₁ and R₁₂ are each independently of the other hydrogen or C₁-C₆alkyl, or together are tetra- or penta-methylene; or

R₁ is C₁-C₁₋₂alkyl, C₂-C₁₂alkenyl; C₁-C₁₋₂haloalkyl or a group NR₁₁R₁₂ wherein R₁₁ and R₁₂ are each independently of the other hydrogen or C₁-C₆alkyl; or

R₁ is C₁-C₄alkyl, C₂-C₄alkenyl; C₁-C₄haloalkyl or C₁-C₂dialkylamino; or

R₁ is C₁-C₄alkyl, vinyl; C₁-C₄haloalkyl or dimethylamino; or

R₂ is hydrogen and R₃ is C₁-C₈alkyl; C₁-C₈alkyl substituted with hydroxy, C₁-C₄alkoxy, mercapto or C₁-C₄alkylthio; C₃-C₈alkenyl; C₃-C₈alkynyl; C₃-C₈cycloalkyl; C₃-C₈cycloalkyl-C₁-C₄alkyl or is phenyl; naphthyl or heteroaryl formed by 1 or 2 five- or six-membered rings containing 1 to 4 identical or different heteroatoms selected from oxygen nitrogen or sulfur, wherein each aromatic rings is optionally mono- or poly-substituted with C₁₋C₈alkyl, C₂-C₈alkenyl, C₂C₈alkynyl, C₃C₈cycloalkyl, C₃C₈cycloalkyl-C₁-C₆alkyl, C₁ C₈alkoxy, C₃-C₈alkenyloxy, C₃C₈alkynyloxy, C₃C₈cycloalkyloxy, C₁ C₈alkylthio, C₁-C₈alkylsulfonyl, C₁-C₈alkanoyl, C₁-C₈alkoxycarbonyl, C₃C₈alkenyloxycarbonyl, C₃C₈alkynyloxycarbonyl, C₁-C₈dialkylamino, C₁C₈alkylamino, wherein in turn the alkyl, alkenyl, alkynyl or cycloalkyl moieties may be partially or fully halogenated or with halogen, nitro, cyano, hydroxy or amino; or

R₂ is hydrogen and R₃ is C₁-C₄alkyl; C₃-C₄-alkenyl; cyclopropyl or phenyl, naphthyl, furyl, thienyl, imidazolyl, thiazolyl, oxazolyl, pyridyl, pyrimidinyl, benzothienyl, benzthiazolyl, chinolinyl, pyrazolyl, indolyl, benzimidazolyl or pyrrolyl, wherein each of the aromatic rings is optionally-substituted with 1 to 3 substituents selected from C₁-C₈alkyl, C₂C₈alkenyl, C₃C₈cycloalkyl, C₁ C₈alkoxy, C₁-C₈alkylthio, C₁-C₈alkoxycarbonyl, C₁-C₈haloalkyl, C₁-C₈haloalkoxy, C₁ C₈haloalkylthio, halogen, nitro or cyano; or

R₂ is hydrogen and R₃ is C₃-C₄alkyl; allyl; cyclopropyl; phenyl or phenyl substituted with 1 to 3 substituents selected from C₁-C₈alkyl, C₂C₈alkenyl, C₃C₈cycloalkyl, C₁-C₈alkoxy, C₁C₈alkylthio, C₁-C₈alkoxycarbonyl, C₁-C₈haloalkyl, C₁-C₈haloalkoxy, C₁-C₈haloalkylthio, halogen, nitro or cyano; or

R₂ is hydrogen and R₃ is 2-propyl; phenyl; C₁₋₄alkylphenyl or halophenyl; or

A is optionally substituted saturated or unsaturated carbocycle or heterocycle linked to the remainder of the molecule by vicinal ring member carbon atoms; or

A is optionally substituted 1,2-phenylene; optionally substituted 2,3-pyridinylidene; optionally substituted 3,4-pyridinylidene; optionally substituted 2,3-thiophenylidene; optionally substituted 4,5-thiazolinylidene; optionally substituted 1,2-cyclohexylidene; optionally substituted 1,2-cyclopentylidene; optionally substituted 3,4-tetrahydrofuranylidene or optionally substituted 1,2-cyclopropylidene; or

A is 1,2-phenylene; 2,3-pyridinylidene; 3,4-pyridinylidene or 2,3-thiophenylidene; each optionally substituted with halogen, C₁-C₆alkyl, C₁-C₆alkoxy, C₁-C₆haloalkyl, C₁-C₆alkoxycarbonyl, nitro or cyano; or is 1,2-cyclohexylidene; 1,2-cyclopentylidene; 3,4-tetrahydrofuranylidene or 1,2-cyclopropylidene, each optionally substituted with C₁-C₆-alkyl; or

A is 1,2-phenylene; 1,2-cyclohexylidene or 1,2-cyclopropylidene; or

R₄ is hydrogen; C₁-C₈alkyl; C₂-C₈alkenyl; C₂-C₈alkynyl; C₃-C₈cycloalkyl; C₃-C₈cycloalkyl-C₁-C₄alkyl; C₁-C₈alkylthio; C₁-C₈alkylsulfonyl; C₁-C₈alkoxy; C₃-C₈alkenyloxy; C₃-C₈alkynyloxy; C₃-C₈cycloalkoxy; C₁-C₈alkoxy-C₁-C₄alkyl; C₁-C₈alkoxycarbonyl; C₃-C₈alkenyloxycarbonyl; C₃-C₈alkynyloxycarbonyl; C₁-C₈alkanoyl; C₁-C₈dialkylamino or C₁-C₈alkylamino, wherein in turn the alkyl, alkenyl, alkynyl or cycloalkyl moieties may be partially or fully halogenated; or is carboxyl; formyl; halogen; nitro; cyano; hydroxy or amino; or

R₄ is hydrogen; C₁-C₈alkyl; C₁-C₈haloalkyl; C₂-C₈alkenyl; C₂-C₈alkynyl; C₁-C₈alkylthio; C₁-C₈haloalkylthio; C₁-C₈alkoxy; C₁-C₈haloalkoxy; C₁-C₈alkoxy-C₁-C₄alkyl; C₁-C₈alkoxycarbonyl; C₁-C₈alkanoyl; formyl; halogen; nitro; cyano or hydroxy; or

R₄ is hydrogen; C₁-C₄alkyl; C₁-C₄alkoxy; C₁-C₄haloalkoxy or halogen; or

R₄ is hydrogen; methoxy or ethoxy; or

R₅ is hydrogen; C₁-C₈alkyl; C₂-C₈alkenyl; C₂-C₈alkynyl; C₃-C₈cycloalkyl; C₃-C₈cycloalkyl-C₁-C₄alkyl; C₁-C₈alkylthio; C₁-C₈alkylsulfonyl; C₁-C₈alkoxy; C₃-C₈alkenyloxy; C₃-C₈alkynyloxy; C₃-C₈cycloalkoxy; C₁-C₈alkoxy-C₁-C₄alkyl; C₁-C₈alkoxycarbonyl; C₃-C₈alkenyloxycarbonyl; C₃-C₈alkynyloxycarbonyl; C₁-C₈alkanoyl; C₁-C₈dialkylamino or C₁-C₈alkylamino, wherein in turn the alkyl, alkenyl, alkynyl or cycloalkyl moieties may be partially or fully halogenated; or is carboxyl; formyl; halogen; nitro; cyano; hydroxy or amino; or

R₅ is hydrogen; C₁-C₄alkyl; C₁-C₄haloalkyl; C₁-C₄alkoxy; C₁-C₄alkoxycarbonyl; C₁-C₄alkanoyl; formyl; halogen; cyano or hydroxy; or

R₅ is hydrogen; C₁-C₄alkyl; halogen or cyano; or

R₅ is hydrogen; or

R₆ is hydrogen; C₁-C₁₀alkyl; C₃-C₁₀alkenyl; C₃-C₁₀alkynyl; C₁-C₁₀haloalkyl; C₃C₁₀haloalkenyl; C₃-C₁₀haloalkynyl; benzyl; benzyl substituted with C₁-C₈alkyl, C₂-C₈alkenyl, C₂-C₈alkynyl, C₃-C₈cycloalkyl, C₃₋₈cycloalkyl-C₁-C₄alkyl, C₁-C₈alkylthio, C₁-C₈alkylsulfonyl, C₁-C₈alkoxy, C₃-C₈alkenyloxy, C₃-C₈alkynyloxy, C₃-C₈cycloalkoxy, C₁-C₈alkoxy-C₁-C₄alkyl, C₁-C₈alkenyloxy-C₁-C₄alkyl, C₁-C₈alkynyloxy-C₁-C₄alkyl, C₁-C₈alkoxycarbonyl, C₃-C₈alkenyloxycarbonyl, C₃-C₈alkynyloxycarbonyl, C₁-C₈alkanoyl, C₁-C₈dialkylamino, C₁-C₈alkylamino, wherein in turn the alkyl, alkenyl, alkynyl or cycloalkyl moieties may be partially or fully halogenated, carboxyl; formyl; halogen; nitro; cyano; hydroxy; or amino;

a group —CR₇R₈—C═C—B wherein R₇ and R₈ are independently hydrogen or C₁-C₄alkyl; and B is either C₃-C₈cycloalkyl; phenyl or phenyl substituted by C₁-C₈alkyl, C₂-C₈alkenyl, C₂-C₈alkynyl, C₃-C₈cycloalkyl, C₃-C₈cycloalkyl-C₁-C₄alkyl, C₁-C₈alkylthio, C₁-C₈alkylsulfonyl, C₁-C₈alkoxy, C₃-C₈alkenyloxy, C₃-C₈alkynyloxy, C₃-C₈cycloalkoxy, C₁-C₈alkoxy-C₁-C₄alkyl, C₁-C₈alkoxycarbonyl, C₃-C₈alkenyloxycarbonyl, C₃-C₈alkynyloxycarbonyl, C₁-C₈alkanoyl, C₁ C₈dialkylamino, C₁-C₈alkylamino, wherein in turn the alkyl, alkenyl, alkynyl or cycloalkyl moieties may be partially or fully halogenated; carboxyl; formyl; halogen; nitro; cyano; hydroxy or amino; or

a group —CR₇R₈—CR₉R₁₀—X—B wherein R₇, R₈, R₉ and R₁₀ are independently hydrogen or C₁-C₄alkyl; X is —O—, —S— or —NR₁₃— where R₁₃ is hydrogen or C₁-C₄alkyl; and B is either C₃-C₈cycloalkyl; phenyl or phenyl substituted by C₁-C₈alkyl, C₂-C₈alkenyl, C₂-C₈alkynyl, C₃-C₈cycloalkyl, C₃-C₈cycloalkyl-C₁-C₄alkyl, C₁-C₈alkylthio, C₁-C₈alkylsulfonyl, C₁-C₈alkoxy, C₃-C₈alkenyloxy, C₃-C₈alkynyloxy, C₃-C₈cycloalkoxy, C₁-C₈alkoxy-C₁-C₄alkyl, C₁-C₈alkoxycarbonyl, C₃-C₈alkenyloxycarbonyl, C₃-C₈alkynyloxycarbonyl, C₁-C₈alkanoyl, C₁-C₈dialkylamino, C₁-C₈alkylamino, wherein in turn the alkyl, alkenyl, alkynyl or cycloalkyl moieties may be partially or fully halogenated; carboxyl; formyl; halogen; nitro; cyano; hydroxy or amino; or

R₆ is hydrogen; C₁-C₈alkyl; C₃-C₈alkenyl; C₃-C₈alkynyl; C₁-C₈alkoxy-C₁-C₄alkyl; C₃C₆alkenyloxy-C₁-C₄alkyl; C₃-C₆alkynyloxy-C₁-C₄alkyl; benzyl; benzyl substituted with C₁-C₈alkyl, C₂-C₈alkenyl, C₂-C₈alkynyl, C₁-C₈alkylthio, C₁-C₈alkoxy, C₁-C₈haloakyl, halogen, nitro or cyano; a group —CH₂—C≡C—B where B is either C₃-C₆cycloalkyl, phenyl or phenyl substituted with C₁-C₈alkyl, C₁-C₈alkylthio, C₁-C₈alkoxy, C₁-C₈haloalkyl, halogen, nitro or cyano; or a group —CH₂—CH₂—O—B where B is either C₃-C₆cycloalkyl, phenyl or phenyl substituted with C₁-C₈-alkyl, C₁-C₈-alkylthio, C₁-C₈-alkoxy, C₁-C₈-haloalkyl, halogen, nitro or cyano; or

R₆ is C₁-C₆alkyl; C₃-C₆alkenyl; C₃-C₆alkynyl; C₁-C₆alkoxy-C₁-C₄alkyl; C₃-C₆alkenyloxy-C₁-C₄alkyl; C₃-C₆alkynyloxy-C₁-C₄alkyl; benzyl; benzyl substituted with C₁-C₄alkyl; C₁ C₈haloalkyl or halogen; a group —CH₂≡C—C—B where B is either C₃-C₆cycloalkyl, phenyl or phenyl substituted with by C₁-C₄alkyl or halogen; or a group —CH₂—CH₂—O—B where B is either C₃C₆cycloalkyl, phenyl or phenyl substituted with C₁-C₈alkyl, halogen; or

R₆ is C₁-C₆alkyl; C₃-C₆alkenyl; C₃-C₆alkynyl; C₁-C₆alkoxy-C₁-C₄alkyl; C₃-C₆alkenyloxy-C₁-C₄alkyl; C₃-C₆alkynyloxy-C₁-C₄alkyl; benzyl; benzyl substituted with C₁-C₄alkyl, C₁-C₈haloalkyl or halogen; a group —CH₂—C≡C—B where B is either C₃-C₆cycloalkyl, phenyl or phenyl substituted with C₁-C₄alkyl or halogen; or a group —CH₂—CH₂—O—B where B is either C₃C₆cycloalkyl, phenyl or phenyl substituted with C₁-C₈alkyl or halogen.

Further preferred subgroups of the compounds of formula I are those wherein

1) n is zero or one; and R₁ is C₁-C₁₂alkyl; C₁-C₁₂alkyl substituted with C₁-C₄alkoxy, C₁-C₄alkylthio or C₁-C₄alkylsulfonyl; C₂-C₁₂alkenyl; C₂-C₁₂alkynyl; C₁-C₁₂haloalkyl or a group NR₁₁R₁₂ wherein R₁₁ and R₁₂ are each independently of the other hydrogen or C₁-C₆alkyl, or together are tetra- or penta-methylene; and R₂ is hydrogen and R₃ is C₁—C₈alkyl; C₁-C₈alkyl substituted with hydroxy, C₁-C₄alkoxy, mercapto or C₁-C₄alkylthio; C₃-C₈alkenyl; C₃-C₈alkynyl; C₃-C₈cycloalkyl; C₃-C₈cycloalkyl-C₁-C₄alkyl or is phenyl; naphthyl or heteroaryl formed by 1 or 2 five- or six-membered rings containing 1 to 4 identical or different heteroatoms selected from oxygen nitrogen or sulfur, wherein each aromatic rings is optonially mono- or poly-substituted with C₁-C₈alkyl, C₂ C₈alkenyl, C₂C₈alkynyl, C₃-C₈cycloalkyl, C₃-C₈cycloalkyl-C₁-C₆alkyl, C₁-C₈alkoxy, C₃C₈alkenyloxy, C₃C₈alkynyloxy, C₃C₈cycloalkyloxy, C₁ C₈alkylthio, C₁-C₈alkylsulfonyl, C₁-C₈alkanoyl, C₁ C₈alkoxycarbonyl, C₁ C₈alkenyloxycarbonyl, C₃C₈alkynyloxycarbonyl, C₁-C₈dialkylamino, C₁C₈alkylamino, wherein in turn the alkyl, alkenyl, alkynyl or cycloalkyl moieties may be partially or fully halogenated or with halogen, nitro, cyano, hydroxy or amino; and A is optionally substituted saturated or unsaturated carbocycle or heterocycle linked to the remainder of the molecule by vicinal ring member carbon atoms; and R₄ is hydrogen; C₁-C₈alkyl; C₂-C₈alkenyl; C₂-C₈alkynyl; C₃-C₈cycloalkyl; C₃-C₈cycloalkyl-C₁-C₄alkyl; C₁-C₈alkylthio; C₁-C₈alkylsulfonyl; C₁-C₈alkoxy; C₃-C₈alkenyloxy; C₃-C₈alkynyloxy; C₃-C₈cycloalkoxy; C₁-C₈alkoxy-C₁-C₄alkyl; C₁-C₈alkoxycarbonyl; C₃-C₈alke-nyloxycarbonyl; C₃C₈alkynyloxycarbonyl; C₁-Calkanoyl; C₁-C₈dialkylamino or C₁-C₈alkylamino, wherein in turn the alkyl, alkenyl, alkynyl or cycloalkyl moieties may be partially or fully halogenated; or is carboxyl; formyl; halogen; nitro; cyano; hydroxy or amino; and R₅ is hydrogen; C₁-C₈alkyl; C₂-C₈alkenyl; C₂-C₈alkynyl; C₃-C₈cycloalkyl; C₃-C₈cycloalkyl-C₁-C₄alkyl; C₁-C₈alkylthio; C₁-C₈alkylsulfonyl; C₁-C₈alkoxy; C₃-C₈alkenyloxy; C₃-C₈alkynyloxy; C₃-C₈cycloalkoxy; C₁-C₈alkoxy-C₁-C₄alkyl; C₁-C₈alkoxycarbonyl; C₃-C₈alkenyloxycarbonyl; C₃-C₈alkynyloxycarbonyl; C₁-C₈alkanoyl; C₁-C₈dialkylamino or C₁-C₈alkylamino, wherein in turn the alkyl, alkenyl, alkynyl or cycloalkyl moieties may be partially or fully halogenated; or is carboxyl; formyl; halogen; nitro; cyano; hydroxy or amino; and R₆ is hydrogen; C₁-C₁₀alkyl; C₃-C₁₀alkenyl; C₃-C₁₀alkynyl; C₁-C₁₀haloalkyl; C₃C₁₀haloalkenyl; C₃-C₁₀haloalkynyl; benzyl; benzyl substituted with C₁-C₈alkyl, C₂-C₈alkenyl, C₂C₈alkynyl, C₃-C₈cycloalkyl, C₃₋₈cycloalkyl-C₁-C₄alkyl, C₁-C₈alkylthio, C₁-C₈alkylsulfonyl, C₁-C₈alkoxy, C₃-C₈alkenyloxy, C₃-C₈alkynyloxy, C₃-C₈cycloalkoxy, C₁-C₈alkoxy-C₁-C₄alkyl, C₁-C₈alkenyloxy-C₁-C₄alkyl, C₁-C₈alkynyloxy-C, C₄alkyl, C₁-C₈alkoxycarbonyl, C₃-C₈alkenyloxycarbonyl, C₃-C₈alkynyloxycarbonyl, C₁-C₈alkanoyl, C₁-C₈dialkylamino, C₁-C₈alkylamino, wherein in turn the alkyl, alkenyl, alkynyl or cycloalkyl moieties may be partially or fully halogenated, carboxyl; formyl; halogen; nitro; cyano; hydroxy; or amino; a group —CR₇R₈—C≡C—B wherein R₇ and R₈ are independently hydrogen or C₁-C₄alkyl; and B is either C₃-C₈cycloalkyl; phenyl or phenyl substituted by C₁-C₈alkyl, C₂C₈alkenyl, C₂-C₈alkynyl, C₃-C₈cycloalkyl, C₃-C₈cycloalkyl-C₁-C₄alkyl, C₁-C₈alkylthio, C₁-C₈alkylsulfonyl, C₁-C₈alkoxy, C₃-C₈alkenyloxy, C₃-C₈alkynyloxy, C₃-C₈cycloalkoxy, C₁-C₈alkoxy-C₁-C₄alkyl, C₁-C₈alkoxycarbonyl, C₃C₈alkenyloxycarbonyl, C₃-C₈alkynyloxycarbonyl, C₁-C₈alkanoyl, C₁-C₈dialkylamino, C₁-C₈alkylamino, wherein in turn the alkyl, alkenyl, alkynyl or cycloalkyl moieties may be partially or fully halogenated; carboxyl; formyl; halogen; nitro; cyano; hydroxy or amino; or a group —CR₇R₈-CR₉R₁₀—X—B wherein R₇, R₈, R₉ and R₁₀ are independently hydrogen or C₁-C₄alkyl; X is —O—, —S— or —NR₁₃— where R₁₃ is hydrogen or C₁-C₄alkyl; and B is either C₃-C₈cycloalkyl; phenyl or phenyl substituted by C₁-C₈alkyl, C₂-C₈alkenyl, C₂-C₈alkynyl, C₃-C₈cycloalkyl, C₃-C₈cycloalkyl-C₁-C₄alkyl, C₁-C₈alkylthio, C₁-C₈alkylsulfonyl, C₁-C₈alkoxy, C₃-C₈alkenyloxy, C₃-C₈alkynyloxy, C₃-C₈cycloalkoxy, C₁-C₈alkoxy-C₁-C₄alkyl, C₁-C₈alkoxycarbonyl, C₃-C₈alkenyloxycarbonyl, C₃-C₈alkynyloxycarbonyl, C₁-C₈alkanoyl, C₁-C₈dialkylamino, C₁-C₈alkylamino, wherein in turn the alkyl, alkenyl, alkynyl or cycloalkyl moieties may be partially or fully halogenated; carboxyl; formyl; halogen; nitro; cyano; hydroxy or amino; or

2) n is one; and R₁ is C₁-C₁₂alkyl, C₂-C₁₂alkenyl; C₁-C₁₂haloalkyl or a group NR₁₁—R₁₂ wherein R₁₁ and R₁₂ are each independently of the other hydrogen or C₁-C₆alkyl; and R₂ is hydrogen and R₃ is C₁-C₄alkyl; C₃-C₄-alkenyl; cyclopropyl or phenyl, naphthyl, furyl, thienyl, imidazolyl, thiazolyl, oxazolyl, pyridyl, pyrimidinyl, benzothienyl, benzthiazolyl, chinolinyl, pyrazolyl, indolyl, benzimidazolyl or pyrrolyl, wherein each of the aromatic rings is optionally substituted with 1 to 3 substituents selected from C₁ C₈alkyl, C₂C₈alkenyl, C₃C₈cycloalkyl, C₁-C₈alkoxy, C₁ C₈alkylthio, C₁ C₈alkoxycarbonyl, C₁ C₈haloalkyl, C₁ C₈haloalkoxy, C₁ C₈haloalkylthio, halogen, nitro or cyano; and A is optionally substituted 1,2-phenylene; optionally substituted 2,3-pyridinylidene; optionally substituted 3,4-pyridinylidene; optionally substituted 2,3-thiophenylidene; optionally substituted 4,5-thiazolinylidene; optionally substituted 1,2-cyclohexylidene; optionally substituted 1,2-cyclopentylidene; optionally substituted 3,4-tetrahydrofuranylidene or optionally substituted 1,2-cyclopropylidene; and R₄ is hydrogen; C₁-C₈alkyl; C₁-C₈haloalkyl; C₂-C₈alkenyl; C₂-C₈alkynyl; C₁-C₈alkylthio; C₁-C₈haloalkylthio; C₁-C₈alkoxy; C₁-C₈haloalkoxy; C₁-C₈alkoxy-C₁-C₄alkyl; C₁ C₈alkoxycarbonyl; C₁-C₈alkanoyl; formyl; halogen; nitro; cyano or hydroxy; and R₅ is hydrogen; C₁-C₄alkyl; C₁-C₄haloalkyl; C₁-C₄alkoxy; C₁-C₄alkoxycarbonyl; C₁-C₄alkanoyl; formyl; halogen; cyano or hydroxy; and R₆ is hydrogen; C₁-C₈alkyl; C₃-C₈alkenyl; C₃-C₈alkynyl; C₁-C₆alkoxy-C₁-C₄alkyl; C₃C₆alkenyloxy-C₁-C₄alkyl; C₃-C₆alkynyloxy-C₁-C₄alkyl; benzyl; benzyl substituted with C₁-C₈alkyl, C₂-C₈alkenyl, C₂-C₈alkynyl, C₁-C₈alkylthio, C₁-C₈alkoxy, C₁-C₈haloakyl, halogen, nitro or cyano; a group —CH₂—C≡C—B where B is either C₃-C₆cycloalkyl, phenyl or phenyl substituted with C₁-C₈alkyl, C₁-C₈alkylthio, C₁-C₈alkoxy, C₁-C₈haloalkyl, halogen, nitro or cyano; or a group —CH₂—CH₂—O—B where B is either C₃-C₆cycloalkyl, phenyl or phenyl substituted with C₁-C₈-alkyl, C₁-C₈-alkylthio, C₁-C₈-alkoxy, C₁-C₈-haloalkyl, halogen, nitro or cyano; or

3) n is one; and R₁ is C₁-C₄alkyl, C₁C₄alkenyl; C₁-C₄haloalkyl or C₁-C₂dialkylamino; and R₂ is hydrogen and R₃ is C₃-C₄alkyl; allyl; cyclopropyl; phenyl or phenyl substituted with 1 to 3 substituents selected from C₁ C₈alkyl, C₂-C₈alkenyl, C₃ C₈cycloalkyl, C₁-C₈alkoxy, C₁ C₈alkylthio, C₁-C₈alkoxycarbonyl, C₁-C₈haloalkyl, C₁-C₈haloalkoxy, C₁-C₈haloalkylthio, halogen, nitro or cyano; and A is 1,2-phenylene; 2,3-pyridinylidene; 3,4-pyridinylidene or 2,3-thiophenylidene; each optionally substituted with halogen, C₁-C₆alkyl, C₁-C₆alkoxy, C₁-C₆haloalkyl, C₁-C₆alkoxycarbonyl, nitro or cyano; or is 1,2-cyclohexylidene; 1,2-cyclopentylidene; 3,4-tetrahydrofuranylidene or 1,2-cyclopropylidene, each optionally substituted with C₁-C₆-alkyl; and R₄ is hydrogen; C₁-C₄alkyl; C₁-C₄alkoxy; C₁-C₄haloalkoxy or halogen; and R₅ is hydrogen; C₁-C₄alkyl; halogen or cyano; and R₆ is C₁-C₆alkyl; C₃-C₆alkenyl; C₃-C₆alkynyl; C₁-C₆alkoxy-C₁-C₄alkyl; C₃-C₆alkenyloxy-C₁-C₄alkyl; C₃-C₆alkynyloxy-C₁-C₄alkyl; benzyl; benzyl substituted with C₁-C₄alkyl; C₁ C₈haloalkyl or halogen; a group —CH₂—C≡C—B where B is either C₃-C₆cycloalkyl, phenyl or phenyl substituted with by C₁-C₄alkyl or halogen, or a group CH₂—CH₂—O—B where B is either C₃C₆cycloalkyl, phenyl or phenyl substituted with C₁-C₈alkyl, halogen; or

4) n is one; and R₁ is C₁-C₄alkyl, vinyl; C₁-C₄haloalkyl or dimethylamino; and R₂ is hydrogen and R₃ is 2-propyl; phenyl; C₁ alkylphenyl or halophenyl; and A is 1,2-phenylene; 1,2-cyclohexylidene or 1,2-cyclopropylidene; and R₄ is hydrogen; methoxy or ethoxy; and R₅ is hydrogen; and R₆ is C₁-C₆alkyl; C₃-C₆alkenyl; C₃-C₆alkynyl; C₁-C₆alkoxy-C₁-C₄alkyl; C₃-C₆alkenyloxy-C₁-C₄alkyl; C₃-C₆alkynyloxy-C₁-C₄alkyl; benzyl; benzyl substituted with C₁-C₄alkyl, C₁-C₈haloalkyl or halogen; a group —CH₂—C≡C—B where B is either C₃-C₆cycloalkyl, phenyl or phenyl substituted with C₁-C₄alkyl or halogen; or a group —CH₂—CH₂—O—B where B is either C₃C₆cycloalkyl, phenyl or phenyl substituted with C₁-C₈alkyl or halogen.

Preferred individual compounds are:

(2S)-2-ethanesulfonylamino-N-(3′-methoxy-4′-prop-2-ynyloxy-biphenyl-2-yl)-3-methyl-butyramide,

(2S)-2-methanesulfonylamino-N-(3′-methoxy-4′-prop-2-ynyloxy-biphenyl-2-yl)-3-methyl-butyramide,

(2S)-2-{[(dimethylamino)-sulfonyl]-amino}-N-(3′-methoxy-4′-prop-2-ynyloxy-biphenyl-2-yl)-3-methyl-butyramide,

(2S)-N-(3′,4′-dimethoxy-biphenyl-2-yl)-2-methanesulfonylamino-3-methyl-butyramide,

(2S)-N-(3′,4′-dimethoxy-biphenyl-2-yl)-2-ethanesulfonylamino-3-methyl-butyramide,

(2S)-N-(3′,4′-dimethoxy-biphenyl-2-yl)-2-{[(dimethylamino)-sulfonyl]-amino}-3-methyl-butyramide,

(2S)-2-methanesulfonylamino-N-(3′-methoxy-4′-pent-2-ynyloxy-biphenyl-2-yl)-3-methyl-butyramide,

(2S)-2-ethanesulfonylamino-N-(3′-methoxy-4′-pent-2-ynyloxy-biphenyl-2-yl)-3-methyl-butyramide,

(2S)-2-{[(dimethylamino)-sulfonyl]-amino}-N-(3′-methoxy-4′-pent-2-ynyloxy-biphenyl-2-yl)-3-methyl-butyramide,

(2S)-N-(4′-ethoxy-3′-methoxy-biphenyl-2-yl)-2-methanesulfonylamino-3-methyl-butyramide,

(2S)-2-ethanesulfonylamino-N-(4′-ethoxy-3′-methoxy-biphenyl-2-yl)-3-methyl-butyramide,

(2S)-2-{[(dimethylamino)-sulfonyl]-amino}-N-(4′-ethoxy-3′-methoxy-biphenyl-2-yl)-3-methyl-butyramide,

(2S)-2-methanesulfonylamino-N-[trans-2-(3-methoxy-4-prop-2-ynyloxy-phenyl)-cyclohexyl]-3-methyl-butyramide,

(2S)-2-ethanesulfonylamino-N-[trans-2-(3-methoxy-4-prop-2-ynyloxy-phenyl)-cyclohexyl]-3-methyl-butyramide,

(2S)-2-{[(dimethylamino)-sulfonyl]-amino}-N-[trans-2-(3-methoxy-4-prop-2-ynyloxy-phenyl)-cyclohexyl]-3-methyl-butyramide,

(2S)-2-methanesulfonylamino-N-[trans-2-(3-methoxy-4-pent-2-ynyloxy-phenyl)-cyclohexyl]-3-methyl-butyramide,

(2S)-2-ethanesulfonylamino-N-[trans-2-(3-methoxy-4-pent-2-ynyloxy-phenyl)-cyclohexyl]-3-methyl-butyramide, and

(2S)-2-{[(dimethylamino)-sulfonyl]-amino}-N-[trans-2-(3-methoxy-4-pent-2-ynyloxy-phenyl)-cyclohexyl]-3-methyl-butyramide.

Certain α-sulfin- and α-sulfonamino acid derivatives with a distinct chemical structure have been proposed for controlling plant-destructive fungi (for example in WO 95/030651, WO 00/32568 and WO 00/32569). The action of those preparations is not, however, satisfactory in all aspects of agricultural needs. Surprisingly, with the compound structure of formula I, new kinds of microbiocides having a high level of activity have been found.

The N-bisaryl- and N-aryl-cycloalkylidenyl-α-sulfin- and α-sulfonamino acid amides of formula I may be obtained according to one of the following processes:

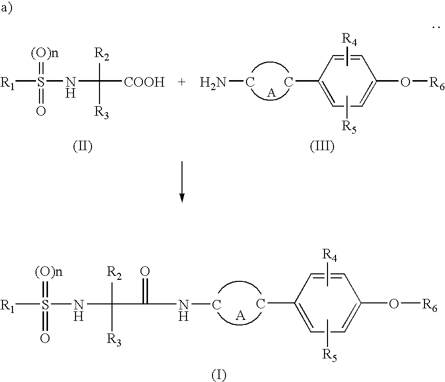

An amino acid of formula II or a carboxyl-activated derivative of an amino acid of formula II wherein R₁, n, R₂ and R₃ are as defined for formula I, is reacted with an amine of formula III wherein A, R₄, R₅ and R₆, are as defined for formula I, optionally in the presence of a base and optionally in the presence of a diluting agent.

Carboxyl-activated derivatives of the amino acid of formula II encompasses all compounds having an activated carboxyl group like an acid halide, such as an acid chloride or an acid fluoride, like symmetrical or mixed anhydrides, such as mixed anhydrides with O-alkylcarbonates, like activated esters, such as p-nitrophenylesters or N-hydroxysuccinimidesters, as well as in situ produced activated forms of the amino acid of formula II by condensating agents, such as dicyclohexylcarbodiimide, carbonyldiimidazol, benzotriazol-1-yloxy-tris-(dimethylamino)phosphonium hexafluorophosphate, O-benzotriazol-1-yl N,N,N′,N′-bis(pentamethylene)uronium hexafluorophosphate, O-benzotriazol-1-yl N,N,N′,N′-bis(tetramethylene)uronium hexafluorophosphate, O-benzotriazol-1-yl N,N,N′,N′-tetramethyluronium hexafluorophosphate or benzotriazol-1-yloxy-tripyrrolidinophosphonium hexafluorophosphate. The mixed anhydrides of the amino acids of the formula II can be prepared by reaction of an amino acid of formula II with chloroformic acid esters like chloroformic acid alkylesters, such as ethyl chloroformate or isobutyl chloroformate, optionally in the presence of an organic or inorganic base like a tertiary amine, such as triethylamine, N,N-diisopropylethylamine, pyridine, N-methyl-piperidine or N-methyl-morpholine. The acid halide of the amino acid of formula II may be prepared by reaction of an amino acid of formula II with an inorganic halide, such as thionyl chloride or phosphorous pentachloride, or with organic halides, such as phosgene or oxalyl chloride.

The present reaction is preferably performed in an inert solvent like aromatic, non-aromatic or halogenated hydrocarbons, such as chlorohydrocarbons e.g. dichloromethane or toluene; ketones e.g. acetone; esters e.g. ethyl acetate; amides e.g. N,N-dimethylformamide; nitriles e.g. acetonitrile; or ethers e.g. diethylether, tert-butyl-methylether, dioxane or tetrahydrofuran or water. It is also possible to use mixtures of these solvents. The reaction is performed optionally in the presence of an organic or inorganic base like a tertiary amine, e.g. triethylamine, N,N-diisopropyl-ethylamine, pyridine, N-methyl-piperidine or N-methyl-morpholine, like a metal hydroxide or a metal carbonate, preferentially an alkali hydroxide or an alkali carbonate, such as lithium hydroxide, sodium hydroxide or potassium hydroxide at temperatures ranging from −80 to +150° C., preferentially at temperatures ranging from −40 to +40 ° C.

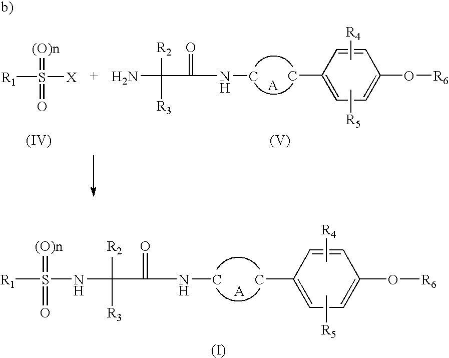

The compounds of formula I may also be prepared by reaction of an amino acid derivative of formula V wherein R₂, R₃, R₄, R₅ and R₅ are as defined for formula I, with a sulfonyl halide or a sulfinyl halide of formula IV wherein R₁ and n are as defined for formula I and where X is halide, preferentially chlorine or bromine.

The reaction is preferably performed in an inert solvent like aromatic, non-aromatic or halogenated hydrocarbons, such as chlorohydrocarbons e.g. dichloromethane or toluene; ketones e.g. acetone; esters e.g. ethyl acetate; amides e.g. N,N-dimethylformamide; nitriles e.g. acetonitrile; or ethers e.g. diethylether, tert-butyl-methylether, dioxane or tetrahydrofuran or water. It is also possible to use mixtures of these solvents. The reaction is performed optionally in the presence of an organic or inorganic base like a tertiary amine, e.g. triethylamine, N,N-diisopropyl-ethylamine, pyridine, N-methyl-piperidine or N-methyl-morpholine, like a metal hydroxide or a metal carbonate, preferentially an alkali hydroxide or an alkali carbonate, such as lithium hydroxide, sodium hydroxide or potassium hydroxide at temperatures ranging from −80 to +150° C., preferentially at temperatures ranging from −40 to +40° C.

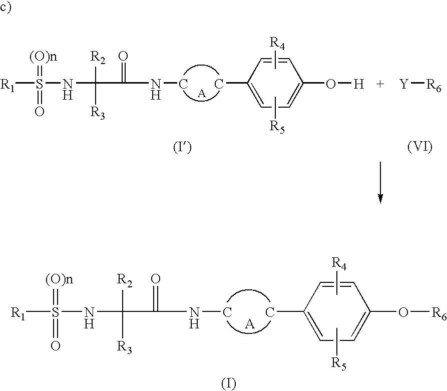

The compounds of formula I may also be prepared by reaction of a phenol of formula I′ where R₁, n, R₂, R₃, R₄, and R₅ are as defined for formula I, with a compound of formula VI where R₆ is as defined for formula I but is not hydrogen and where Y is a leaving group like a halide such as a chloride or bromide or a sulfonic ester such as a tosylate, mesylate or triflate.

The reaction is performed in an inert solvent like aromatic, non-aromatic or halogenated hydrocarbons, such as chlorohydrocarbons e.g. dichloromethane or toluene; ketones e.g. acetone or 2-butanone; esters e.g. ethyl acetate, ethers e.g. diethylether, tert-butyl-methylether, dioxane or tetrahydrofuran, amides e.g. dimethylformamide, nitriles e.g. acetonitrile, alcohols e.g. methanol, ethanol, isopropanol, n-butanol or tert-butanol, sulfoxides e.g. dimethylsulfoxide or water. It is also possible to use mixtures of these solvents. The reaction is performed optionally in the presence of an organic or inorganic base like a tertiary amine, such as triethylamine, N,N-diisopropyl-ethylamine, pyridine, N-methyl-piperidine or N-methyl-morpholine, like a metal hydroxide, a metal carbonate or a metal alkoxide, preferentially an alkali hydroxide, an alkali carbonate or an alkali alkoxide, such as lithium hydroxide, sodium hydroxide, potassium hydroxide, sodium carbonate, potassium carbonate, sodium methoxide, potassium methoxide, sodium ethoxide, potassium ethoxide, sodium tert-butoxide or potassium tert-butoxide at temperatures ranging from −80 to +200° C., preferentially at temperatures ranging from 0 to +120° C.

d) Two alternative methods are availble for the preparation of selected novel intermediates of formula III. The intermediates so obtained have been developed especially for the synthesis of the novel active ingredients according to present invention. Thus these intermediates present another aspect of present invention

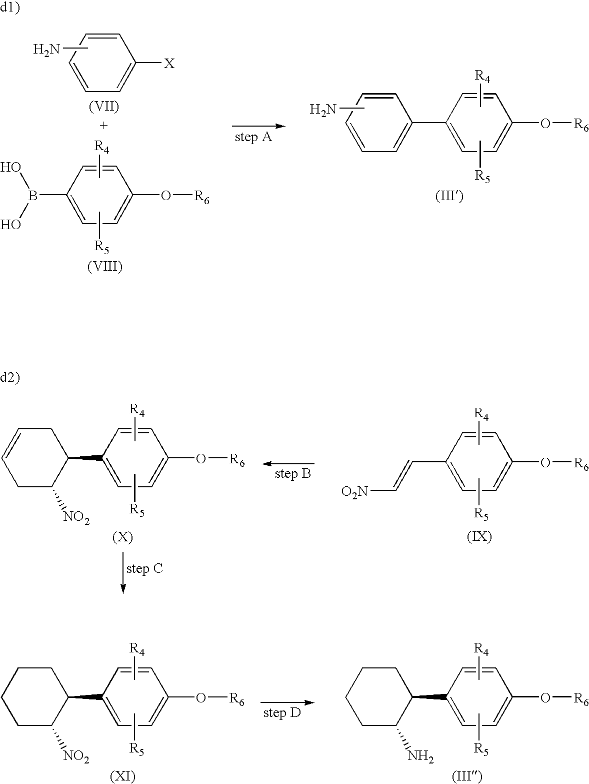

Step A: The compounds of formula III′ wherein R₄, R₅ and R₆ are as defined for formula I and A is optionally substituted phenylidene, here exemplified as 1,4-phenylidene, may be prepared by palladium-catalyzed cross-coupling reaction of an aryl boronic acid derivative of formula VIII wherein R₄, R₅ and R₆ are as defined for formula I, with an aryl halide of formula VII wherein X is a halogen, preferentially bromine or iodine under the conditions of the Suzuki coupling, according to known procedures (Y. Miura et al., Synthesis 1995, 1419; M. Hird et al, Synlett 1999, 438).

Step B: A β-nitrostyrene of formula IX wherein R₄, R₅ and R₆ are as defined for formula I is heated in a Diels-Alder reaction (M. B. Smith and J. March, Advanced Organic Chemistry, 5^{th} ed., Wiley, 2001, p. 1062) together with 1,3-butadiene to give a 4-nitro-5-arylcyclohexenyl derivative of formula X, wherein R₄, R₅ and R₆ are as defined for formula I, and the 4,5-cyclohexenylidene stands for the element A, under conditions known per se (C. M. Nachtsheim and A. W. Frahm, Arch. Pharm. (Weinheim) 1989, 322, 187).

Step C: A 4-nitro-5-aryl-cyclohexenyl derivative of formula X, wherein R₄, R₅ and R₆ are as defined for formula I is reduced to a 1-nitro-2-aryl-cyclohexyl derivative of formula XI, wherein R₄, R₅ and R₆ are as defined for formula I and the 1,2-cyclohexylidene stands for the element A. The reduction is preferably performed by catalytic hydrogenation in the presence of a metal catalyst like palladium on carbon or palladium hydroxide on carbon at pressures ranging from 1 to 100 bar, preferentially at pressures ranging from 1 to 50 bar; and temperatures ranging from 0 to +150° C., preferentially at temperatures ranging from +20 to +100° C.

Step D: A 1-nitro-2-aryl-cyclohexyl derivative of formula XI, wherein R₄, R₅ and R₆ are as defined for formula I is then further reduced to an 2-arylcyclohexylamine of formula III″, wherein R₄, R₅ and R₆ are as defined for formula I. The reduction is preferably performed in the presence of a reagent such as zinc, tin or iron, each of these metals together with a mineral acid like hydrochloric acid or sulfuric acid, indium together with ammonium chloride, hydrazine or hydrazine hydrate together with Raney-Nickel, sodium borohydride, lithium aluminum hydride or by catalytic hydrogenation in the presence of a catalyst such as platinum oxide at temperatures ranging from −80 to +200° C., preferentially at temperatures ranging from −40 to +120° C.

The compounds of formula I are oils or solids at room temperature and are distinguished by valuable microbiocidal properties. They can be used in the agricultural sector or related fields preventively and curatively in the control of plant-destructive microorganisms. The compounds of formula I according to the invention are distinguished at low rates of concentration not only by outstanding microbiocidal, especially fungicidal, activity but also by being especially well tolerated by plants.

Surprisingly, it has now been found that the compounds of formula I have for practical purposes a very advantageous biocidal spectrum in the control of phytopathogenic microorganisms, especially fungi. They possess very advantageous curative and preventive properties and are used in the protection of numerous crop plants. With the compounds of formula I it is possible to inhibit or destroy phytopathogenic microorganisms that occur on various crops of useful plants or on parts of such plants (fruit, blossom, leaves, stems, tubers, roots), while parts of the plants which grow later also remain protected, for example, against phytopathogenic fungi.

The novel compounds of formula I prove to be effective against specific genera of the fungus class Fungi imperfecti (e.g. Cercospora), Basidiomycetes (e.g. Puccinia) and Ascomycetes (e.g. Erysiphe and Venturia) and especially against Oomycetes (e.g. Plasmopara, Peronospora, Pythium and Phytophthora). They therefore represent in plant protection a valuable addition to the compositions for controlling phytopathogenic fungi. The compounds of formula I can also be used as dressings for protecting seed (fruit, tubers, grains) and plant cuttings from fungal infections and against phytopathogenic fungi that occur in the soil.

The invention relates also to compositions comprising compounds of formula I as active ingredient, especially plant-protecting compositions, and to the use thereof in the agricultural sector or related fields.

In addition, the present invention includes the preparation of those compositions, wherein the active ingredient is homogeneously mixed with one or more of the substances or groups of substances described herein. Also included is a method of treating plants which is distinguished by the application of the novel compounds of formula I or of the novel compositions.

Target crops to be protected within the scope of this invention comprise, for example, the following species of plants: cereals (wheat, barley, rye, oats, rice, maize, sorghum and related species); beet (sugar beet and fodder beet); pomes, stone fruit and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans, groundnuts); cucurbitaceae (marrows, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocado, cinnamon, camphor) and plants such as tobacco, nuts, coffee, sugar cane, tea, pepper, vines, hops, bananas and natural rubber plants, and also ornamentals.

The compounds of formula I are normally used in the form of compositions and can be applied to the area or plant to be treated simultaneously or in succession with other active ingredients. Those other active ingredients may be fertilisers, micronutrient donors or other preparations that influence plant growth. It is also possible to use selective herbicides or insecticides, fungicides, bactericides, nematicides, molluscicides or mixtures of several of those preparations, if desired together with further carriers, surfactants or other application-promoting adjuvants customarily employed in formulation technology.

The compounds of formula I can be mixed with other fungicides, resulting in some cases in unexpected synergistic activities.

Mixing components which are particularly preferred are azoles such as azoles, such as azaconazole, bitertanol, bromuconazole, cyproconazole, difenoconazole, diniconazole, epoxiconazole, fenbuconazole, fluquinconazole, flusilazole, flutriafol, hexaconazole, imazalil, S-imazalil, imibenconazole, ipconazole, metconazole, myclobutanil, pefurazoate, penconazole, pyrifenox, prochloraz, propiconazole, tebuconazole, tetraconazole, triadimefon, triadimenol, triflumizole, triticonazole; pyrimidinyl carbinols, such as ancymidol, fenarimol, nuarimol; 2-amino-pyrimidines, such as bupirimate, dimethirimol, ethirimol; morpholines, such as dodemorph, fenpropidine, fenpropimorph, spiroxamine, tridemorph; anilinopyrimidines, such as cyprodinil, mepanipyrim, pyrimethanil; pyrroles, such as fenpiclonil, fludioxonil; phenylamides, such as benalaxyl, furalaxyl, metalaxyl, R-metalaxyl, ofurace, oxadixyl; benzimidazoles, such as benomyl, carbendazim, debacarb, fuberidazole, thiabendazole; dicarboximides, such as chlozolinate, dichlozoline, iprodione, myclozoline, procymidone, vinclozolin; carboxamide, such as carboxin, fenfuram, flutolanil, mepronil, oxycarboxin, thifluzamide; guanidines, such as guazatine, dodine, iminoctadine; strobilurines, such as azoxystrobin, kresoxim-methyl, metominostrobin, SSF-129, CGA 279202 (trifloxystrobin), picoxystrobin; dithiocarbamates, such as ferbam, mancozeb, maneb, metiram, propineb, thiram, zineb, ziram; N-halogenmethylthiophthalimides, such as captafol, captan, dichlofluanid, fluoromide, folpet, tolyfluanid; Cu compounds, such as Bordeaux mixture, copper hydroxide, copper oxychloride, copper sulfate, cuprous oxide, mancopper, oxineopper; nitrophenol derivatives, such as dinocap, nitrothal-isopropyl; organo-P derivatives, such as edifenphos, iprobenphos, isoprothiolane, phosdiphen, pyrazophos, tolclofos-methyl; various, such as AC 382042, acibenzolar-S-methyl, anilazine, blasticidin-S, quinomethionat, chloroneb, chlorothalonil, cymoxanil, dichlone, diclomezine, dicloran, diethofencarb, dimethomorph, dithianon, etridiazole, famoxadone, fenamidone, fenhexamid, fentin, ferimzone, fluazinam, flusulfamide, fosetyl-aluminium, hymexazol, IKF-916, iprovalicarb, kasugamycin, methasulfocarb, MON65500, pencycuron, phthalide, polyoxins, probenazole, propamocarb, pyroquilon, quinoxyfen, quintozene, RH-7281, RPA 407213, pyraclostrobin (BAS 500F), sulfur, SYP-Z071, triazoxide, tricyclazole, triforine, validamycin.

Suitable carriers and surfactants may be solid or liquid and correspond to the substances ordinarily employed in formulation technology, such as e.g. natural or regenerated mineral substances, solvents, dispersants, wetting agents, tackifiers, thickeners, binders or fertilisers. Such carriers and additives are described, for example, in WO 95/30651.

A preferred method of applying a compound of formula I, or an agrochemical composition comprising at least one of those compounds, is application to the foliage (foliar application), the frequency and the rate of application depending upon the risk of infestation by the pathogen in question. The compounds of formula I may also be applied to seed grains (coating) either by impregnating the grains with a liquid formulation of the active ingredient or by coating them with a solid formulation.

The compounds of formula I are used in unmodified form or, preferably, together with the adjuvants conventionally employed in formulation technology, and are for that purpose advantageously formulated in known manner e.g. into emulsifiable concentrates, coatable pastes, directly sprayable or dilutable solutions, dilute emulsions, wettable powders, soluble powders, dusts, granules, and by encapsulation in e.g. polymer substances. As with the nature of the compositions, the methods of application, such as spraying, atomising, dusting, scattering, coating or pouring, are chosen in accordance with the intended objectives and the prevailing circumstances.

Advantageous rates of application are normally from 1 g to 2 kg of active ingredient (a.i.) per hectare (ha), preferably from 10 g to 1 kg a.i./ha, especially from 25 g to 750 g a.i./ha. When used as seed dressings, rates of from 0.001 g to 1.0 g of active ingredient per kg of seed are advantageously used.

The formulations, i.e. the compositions, preparations or mixtures comprising the compound(s) (active ingredient(s)) of formula I and, where appropriate, a solid or liquid adjuvant, are prepared in known manner, e.g. by homogeneously mixing and/or grinding the active ingredient with extenders, e.g. solvents, solid carriers and, where appropriate, surface-active compounds (surfactants).

Further surfactants customarily used in formulation technology will be known to the person skilled in the art or can be found in the relevant technical literature.

The agrochemical compositions usually comprise 0.01 to 99% by weight, preferably 0.1 to 95% by weight, of a compound of formula I, 99.99 to 1% by weight, preferably 99.9 to 5% by weight, of a solid or liquid adjuvant, and 0 to 25% by weight, preferably 0.1 to 25% by weight, of a surfactant.

Whereas commercial products will preferably be formulated as concentrates, the end user will normally employ dilute formulations.

The compositions may also comprise further ingredients, such as stabilisers, antifoams, viscosity regulators, binders and tackifiers, as well as fertilisers or other active ingredients for obtaining special effects.

The Examples which follow illustrate the invention described above, without limiting the scope thereof in any way. Temperatures are given in degrees Celsius.

### PREPARATION EXAMPLES FOR COMPOUNDS OF FORMULA I

### Example A1.1: (S)-2-Ethanesulfonylamino-N-(3′-methoxy-4′-prop-2-ynyloxy-biphenyl-2-yl)-3-methyl-butyramide

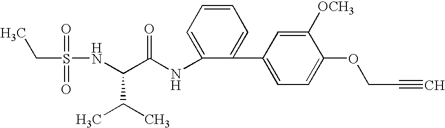

a) (4-Bromo-2-methoxy-phenoxy)-tert-butyl-diphenyl-silane

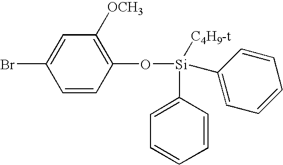

76.8 ml (300 mmol) tert-butyldiphenylchlorosilane are added to a solution of 40.61 g (200 mmol) 4-bromoguaiacol and 27.23 g (400 mmol) imidazole in 200 ml dichloromethane at 0° C., and the mixture is stirred for 4 hours at room temperature. The solution is diluted and extracted with 300 ml water. Flash-chromatography of the residue (ethyl acetate/hexane 3:97) yields (4-bromo-2-methoxy-phenoxy)-tert-butyl-diphenyl-silane as a colorless oil. ¹H-NMR (CDCl₃, 300 MHz): 1.15 (s, 9H, t-Bu), 3.55 (s, 3H, OMe), 6.55 (d, 1H, ar), 6.78 (2m, 1H, ar), 6.66 (s, 1H, ar), 7.3-7.5 (m, 6H, ar), 7.65-7.75 (m, 4H, ar).

b) 4-(tert-Butyl-diphenyl-silanyloxy)-3-methoxy-phenyl-boronic acid

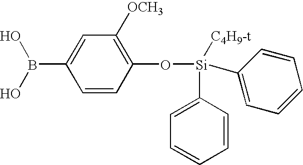

At −78° C., 140 ml n-BuLi (1.6 M in hexane, 223.8 mmol) in 600 ml THF are added to a solution of 89.92 g (203.4 mmol) (4-bromo-2-methoxy-phenoxy)-tert-butyl-diphenyl-silane over a period of 30 minutes. After further 30 minutes at −78° C., 140.9 ml (610.4 mmol) triisopropyl-borate are added over a period of 30 minutes. The mixture is allowed to warm up to room temperature and is hydrolysed at 0° C. with a 10% HCl solution within 30 minutes. After separation of the water phase, the organic phase is dried over MgSO₄ and crystallized from ethyl acetate and a mixture of ethyl acetate/heptane. 4-(tert-Butyl-diphenyl-silanyloxy)-3-methoxy-phenyl-boronic acid is isolated as a light yellow solid (m.p. 193-196° C.).

c) 4′-(tert-Butyl-diphenyl-silanyloxy)-3′-methoxy-biphenyl-2-ylamine

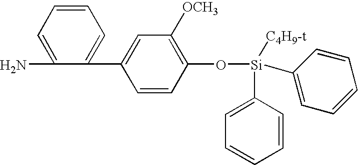

A solution of 17.89 g (44.0 mmol) 4-(tert-butyl-diphenyl-silanyloxy)-3-methoxy-phenyl-boronic acid, 6.89 g (31.45 mmol) 2-iodoaniline, 17.4 g (125.8 mmol) K₂CO₃ and 425 mg (6 mol %) Pd(OAc)₂ in 140 ml THF and 80 ml H₂O is refluxed for 20 hours. After cooling the mixture is filtrated over cellite and concentrated. The residue is dissolved in ethyl acetate and washed with water. After drying (MgSO₄) and evaporating, the residue is subjected to flash-chromatography (ethyl acetate/hexane 1:9). 4′-(tert-Butyl-diphenyl-silanyloxy)-3′-methoxy-biphenyl-2-ylamine is isolated as a colorless oil. ¹H-NMR (CDCl₃, 300 MHz): 1.15 (s, 9H, t-Bu), 3.55 (s, 3H, OMe), 6.6-6.9 (m, 5H, ar), 7.05-7.15 (m, 2H. ar), 7.30-7.50 (m, 6H, ar), 7.75 (m, 4H, ar).

d) (2S)-N-[4′-(tert-Butyl-diphenyl-silanyloxy)-3′-methoxy-biphenyl-2-yl]-2-ethanesulfonylamino-3-methyl-butyramide

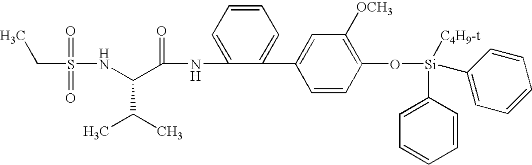

A solution of 2.57 g (12.3 mmol) (2S)-2-ethanesulfonylamino-3-methyl-butyric acid, 1.0 ml (12.3 mmol) pyridine and 0.34 ml (4.1 mmol) cyanurfluoride (2,4,6-trifluor-1,3,5-triazine) in 20 ml dichloromethane is stirred for 3 hours at room temperature under a nitrogen atmosphere. After aqueous extraction, the organic phase is dried over MgSO₄ and evaporated. The crude acide fluoride is dissolved in 10 ml dichloromethane and 4.64 g (10.23 mmol) 4′-(tert-butyl-diphenyl-silanyloxy)-3′-methoxy-biphenyl-2-ylamine as well as 2.31 g (11.25 mmol) 2,6-di-tert-butyl-4-methyl-pyridine are added. The solution is stirred for 20 hours at room temperature under a nitrogen atmosphere. After usual work-up, the crude product is subjected to flash-chromatography (ethyl acetate/hexane 3;7) yielding (2S)-N-[4′-(tert-butyl-diphenyl-silanyloxy)-3′-methoxy-biphenyl-2-yl]-2-ethanesulfonylamino-3-methyl-butyramide as a yellow foam. ¹H-NMR (CDCl₃, 300 MHz): 0.8-1.0 (dd, 6H, 2 Me), 1.15 (s, 9H, t-Bu), 1.35 (t, 3H, Me), 1.9 (m, 1H, CH), 2.90, (dd, 2H, CH₂), 3.55 (m, 1H, CH), 3.60 (s, 3H, OMe), 4.92 (d, 1H), 6.50-6.70 (m, 3H), 7.10-7.30 (m, 2H), 7.30-7.5 (m, 8H), 7.75 (m, 4H), 8.1 (d, 1H).

e) (2S)-2-Ethanesulfonylamino-N-(4′-hydroxy-3′-methoxy-biphenyl-2-yl)-3-methyl butyramide

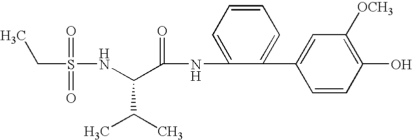

A solution of 4.14 g (6.42 mmol) (2S)-N-[4′-(tert-butyl-liphenyl-silanyloxy)-3′-methoxy-biphenyl-2-yl]-2-ethanesulfonylamino-3-methyl-butyramide, 4.19 g (˜16.05 mmol) tetrabutyl-ammonium fluoride in 30 ml THF is stirred for 18 hours at room temperature. After extracting with water/ethyl acetate and evaporation of the organic phase, the residue is subjected to flash-chromatography (ethyl acetate/hexane 4:6). (2S)-2-Ethanesulfonylamino-N-(4′-hydroxy-3′-methoxy-biphenyl-2-yl)-3-methyl-butyramide is isolated as a yellow foam. ¹H-NMR (CDCl₃, 300 MHz): 0.85-1.05 (dd, 6H, 2 Me), 1.35 (t, 3H, Me), 1.9 (m, 1H, CH), 2.90, (q, 2H, CH₂), 3.61 (m, 1H, CH), 3.92 (s, 3H, OMe), 5.00 (d, 1H), 5.80 (s, 1H), 6.70 (m, 2H), 7.00-7.10 (m, 1H), 7.15-7.30 (m, 2H), 7.45 (m, 1H), 7.62 (s, 1H), 8.27 (d, 1H).

f) A solution of 610 mg (1.5 mmol) (2S)-2-ethanesulfonylamino-N-(4′-hydroxy-3′-methoxy-biphenyl-2-yl)-3-methyl-butyramide, 311 mg (2.25 mmol) K₂CO₃ and 0.8 ml (10.66 mmol) propargyl bromide in 20 ml acetonitrile is heated to reflux for 30 minutes. After usual work-up the product is subjected to flash-chromatography (ethyl acetate/hexane 4:6) to yield (2S)-2-ethanesulfonylamino-N-(3′-methoxy-4′-prop-2-ynyloxy-biphenyl-2-yl)-3-methyl-butyramide as yellow solid (m.p. 97-103° C.).

According to the example A1.1 described above the compounds listed in table A1 are obtained.

TABLE A1

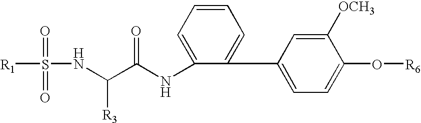

| | | | Config | | |
|---|---|---|---|---|---|
| No. | R₁ | R₃ | α-C | R₆ | physico-chemical data |
| A1.01 | C₂H₅ | C₃H₇-i | (S) | —CH₂—C≡CH | m.p. 97-103 |
| A1.02 | C₂H₅ | C₃H₇-i | (S) | H | ¹H-NMR (CDCl₃)δ(ppm): 0.85-1.05 |
| | | | | | (dd, 6H), 1.35 (t, 3H), 1.9 (m, 1H), |
| | | | | | 2.90, (q, 2H), 3.61 (m, 1H), 3.92 (s, |
| | | | | | 3H), 5.00 (d, 1H), 5.80 (s, 1H), 6.70 |
| | | | | | (m, 2H), 7.00-7.10 (m, 1H), 7.15- |
| | | | | | 7.30 (m, 2H), 7.45 (m, 1H), 7.62 (s, |
| | | | | | 1H), 8.27 (d, 1H). |
| A1.03 | C₂H₅ | C₃H₇-i | (S) | —Si(C₄H₉-t)(C₆H₅)₂ | ¹H-NMR (CDCl₃), δ(ppm): 0.8-1.0 |
| | | | | | (dd, 6H), 1.15 (s, 9H), 1.35 (t, 3H), |
| | | | | | 1.9 (m, 1H), 2.90 (dd, 2H), 3.55 (m, |
| | | | | | 1H), 3.60 (s, 3H), 4.92 (d, 1H), 6.50- |
| | | | | | 6.70 (m, 3H), 7.10-7.30 (m, 2H), |
| | | | | | 7.30-7.5 (m, 8H), 7.75 (m, 4H), 8.1 |
| | | | | | (d, 1H). |
| A1.04 | (CH₃)₂N | C₃H₇-i | (S) | —Si(C₄H₉-t)(C₆H₅)₂ | ¹H-NMR (CDCl₃), δ(ppm): 0.8-1.0 |
| | | | | | (dd, 6H), 1.15 (s, 9H), 1.9 (m, 1H), |
| | | | | | 2.65 (s, 6H), 3.40 (m, 1H), 3.60 (s, 3 |
| | | | | | H), 4.90 (d, 1H), 6.50-6.70 (m, |
| | | | | | 3H), 7.10-7.30 (m, 2H), 7.30-7.5 |
| | | | | | (m, 8H), 7.75 (m, 4H), 8.30 (d, 1H). |
| A1.05 | C₂H₅ | C₃H₇-i | (S) | C₂H₅ | ¹H-NMR (CDCl₃), δ(ppm): 0.8-1.0 |
| | | | | | (dd, 6H), 1.35 (t, 3H), 1,50 (t, 3H), |
| | | | | | 2.0 (m, 1H), 2.90 (m, 2H), 3.70 (m, |
| | | | | | 1H), 3.90 (s, 3H), 4.15 (q, 2H), 4.95 |
| | | | | | (d, 1H), 6.85 (m, 2H), 7.00 (m, 1H), |
| | | | | | 7.15-7.30 (m, 2H), 7.35 (dt, |
| | | | | | 1H), 7.60 (s, 1H), 8.3 (d, 1H). |
| A1.06 | (CH₃)₂N | C₃H₇-i | (S) | —CH₂-(3,4-Cl₂—C₆H₃) | ¹H-NMR (CDCl₃), δ(ppm): 0.8-1.0 |
| | | | | | (dd, 6H), 2.0 (m, 1H), 2.70 (s, 6H), |
| | | | | | 3.45 (m, 1H), 3.90 (s, 3H), 5.15 (d, |
| | | | | | 2H), 6.80-7.00 (m, 3H), 7.15-7.40 |
| | | | | | (m, 4H), 7.42-7.50 (d, 1H), 7.55 |
| | | | | | (m, 2H), 8.30 (d, 1H). |
| A1.07 | (CH₃)₂N | C₃H₇-i | (S) | —CH₂—C≡CH | ¹H-NMR (CDCl₃), δ(ppm): 0.8-1.0 |
| | | | | | (dd, 6H), 2.0 (m, ^{1H}), 2.55 (m, 1H), |
| | | | | | 2.75 (s, 6H), 3.45 (m, 1H), 3.90 (s, 3 |
| | | | | | H), 4.85 (s, 2H), 6.85-6.95 (m, 2H), |
| | | | | | 7.10-7.30 (m, 3H), 7.45 (m, 1H), |
| | | | | | 7.55 (s, 1H), 8.30 (d, 1H). |
| A1.08 | C₂H₅ | 4-Cl—C₆H₅ | (R, S) | —CH₂—C≡CH | ¹H-NMR (CDCl₃), δ(ppm): |
| | | | | | 1.2 (t, 3H), 2.4 (m, 1H), |
| | | | | | 2.55 (m, 2H), 2.75 (s, |
| | | | | | 6H), 3.45 (m, 1H), 3.90 (s, 3H), 4.85 |
| | | | | | (s, 2H), 4.95 (s, 1H), 5.85 (d, 1H), |
| | | | | | 6.5 (d, 1H), 6.6 (s, 1H), 6.95 (d, 1H), |
| | | | | | 7.10-7.40 (m, 8H), 8.30 (d, 1H). |
| A1.09 | C₂H₅ | 4-Cl—C₆H₅ | (R, S) | H | ¹H-NMR (CDCl₃), δ(ppm): 1.2 (t, 3H), |
| | | | | | 2.5-2.8 (2m, 2H), 3.77 (s, 3H), 4.95 |
| | | | | | (s, 1H), 5.75 (s, 1H), 5.85 (m, 1H), |
| | | | | | 6.5 (m, 2H), 6.85 (d, 1H), 7.15- |
| | | | | | 7.40 (m, 8H), 8.30 (d, 1H). |
| A1.10 | C₂H₅ | C₃H₇-i | (S) | —CH₂—C≡C-(4-Cl—C₆H₄) | ¹H-NMR (CDCl₃), δ(ppm): 0.8- |
| | | | | | 1.0 (dd, 6H), 1.15 (1, 3H), |
| | | | | | 2.0 (m, 1H), 2.90 (q, 2H), 3.60 |
| | | | | | (m, 1H), 3.90 (s, 3H), 4.95 (d, |
| | | | | | 1H), 5.15 (m, 2H), 6.90 (m, |
| | | | | | 2H), 6.85 (d, 2H), 7.15-7.45 |
| | | | | | (m, 8H), 7.60 (s, 1H), 8.30 (d, |
| | | | | | 1H). |
| A1.11 | C₂H₅ | C₃H₇-i | (S) | —CH₂—C₆H₅ | ¹H-NMR (CDCl₃) δ(ppm): 0.85 |
| | | | | | (d, 3H); 0.95 (d, 3H); 1.3 (t, |
| | | | | | 3H) 1.9-2.1 (m, 1H); 2.9 (q, |
| | | | | | 2H); 3.6 (dd, 1H); 3.9 (s, 3H); |
| | | | | | 4.95 (d, 1H); 5.2 (s, 2H); 6.75- |
| | | | | | 6.9 (m, 2H); 7.0 (d, 1H); 7.1- |
| | | | | | 7.6 (m, 9H); 8.25 (d, 1H). |
| A1.12 | C₂H₅ | C₃H₇-i | (S) | —CH₂-(4-OCF₃—C₆H₄) | m.p. 140-141° C. |
| A1.13 | C₂H₅ | C₃H₇-i | (S) | —CH₂C≡C—C₆H₅ | m.p. 67-68° C. |
| A1.14 | C₂H₅ | C₃H₇-i | (S) | —CH₂—C≡C—(4-Cl—C₆H₄) | ¹H-NMR (CDCl₃) δ(ppm): 0.85 |
| | | | | | (d, 3H); 0.95 (d, 3H); 1.3 (t, |
| | | | | | 3H); 1.9-2.1 (m, 1H); 2.9 (q, |
| | | | | | 2H); 3.6 (dd, 1H); 3.9 (s, 3H); |
| | | | | | 4.95 (d, 1H); 5.05 (s, 2H); 6.8- |
| | | | | | 7.0 (m, 2H); 7.1-7.4 (m, |
| | | | | | 8H); 7.6 (s, 1H); 8.25 (d, 1H). |
| A1.15 | C₂H₅ | C₃H₇-i | (S) | —CH₂—C≡C-(4-F—C₆H₄) | m.p. 127-129° C. |
| A1.16 | C₂H₅ | C₃H₇-i | (S) | —CH₂—C≡C-(4-Br—C₆H₄) | ¹H-NMR (CDCl₃) δ(ppm): 0.85 |
| | | | | | (d, 3H); 0.⁹⁵ (d, 3H); 1.3 (t, |
| | | | | | 3H); 1.9-2.19 (m, 1H); 2.9 |
| | | | | | (q, 2H); 3.6 (dd, 1H); 3.9 (s, |
| | | | | | 3H); 4.9-5.05 (m, 3H); 6.8- |
| | | | | | 6.95 (m, 2H); 7.1-7.5 (m, |
| | | | | | 8H); 7.6 (s, 1H); 8.25 (d, 1H). |
| A1.17 | C₂H₅ | C₃H₇-i | (S) | —CH₂—CH₂—O—C₆H₅ | m.p. 126-128° C. |
| A1.18 | C₂H₅ | C₃H₇-i | (S) | —CH₂—CH₂—O-(4-F—C₆H₄) | m.p. 117-118° C. |
| A1.19 | C₂H₅ | C₃H₇-i | (S) | —CH₂—CH₂—O-(4-Cl—C₆H₄) | ¹H-NMR (CDCl₃) δ(ppm): 0.9 |
| | | | | | (d, 3H); 1.0 (d, 3H); 1.35 (t, |
| | | | | | 3H); 1.95-2.1 (m, 1H); 2.9 |
| | | | | | (q, 2H); 3.6 (dd, 1H); 3.9 (s, |
| | | | | | 3H); 4.4-4.6 (m, 4H); 4.95 |
| | | | | | (d, 1H); 6.8-6.95 (m, 3H); |
| | | | | | 7.05 (d, 1H); 7.15-7.45 (m, |
| | | | | | 6H); 7.65 (s, 1H); 8.3 (d, 1H). |
| A1.20 | C₂H₅ | C₃H₇-i | (S) | C₂H₅ | Oil |
| A1.21 | C₂H₅ | C₃H₇-i | (S) | —CH₂—C≡C—CH₃ | ¹H-NMR (CDCl₃) δ(ppm): |
| | | | | | 0.9 (d, 3H); 0.95 (d, 3H); 1.3 |
| | | | | | (t, 3H); 1.9 (t, 3H); 1.95- |
| | | | | | 2.15 (m, 1H); 2.9 (q, ^{2H}); 3.6 |
| | | | | | (dd, 1H); 3.9 (s, 3H); 4.75 (d, |
| | | | | | 2H); 5.05 (d, 1H); 6.8-6.95 |
| | | | | | (m, 2H); 7.1-7.4 (m, 4H); |
| | | | | | 7.6 (s, 1H); 8.25 (d, 1H). |
| A1.22 | C₂H₅ | C₃H₇-i | (S) | —CH₂—C≡C-(4-CH₃—C₆H₄) | Oil |
| A1.23 | CH₃ | C₃H₇-i | (S) | —CH₂—C≡C—CH₂—CH₃ | m.p. 52-55° C. |
| A1.24 | C₂H₅ | C₃H₇-i | (S) | —CH₂—C≡C—CH₂—CH₃ | ¹H-NMR (CDCl₃) δ(ppm): |
| | | | | | 0.9 (d, 3H); 1.0 (d, 3H); 1.15 |
| | | | | | (t, 3H); 1.3 (t, 3H); 1.9-2.1 |
| | | | | | (m, 1H); 2.15-2.3 (m, 2H); |
| | | | | | 2.9 (q, 2H); 3.4 (dd, ^{1H}); 3.9 |
| | | | | | (s, 3H); 4.9 (t, 2H); 5.0 (d, |
| | | | | | 1H); 6.8-6.95 (m, 2H); 7.1- |
| | | | | | 7.4 (m, 4H); 7.6 (s, 1H); |
| | | | | | 8.25 (d, 1H). |
| A1.25 | C₂H₅ | C₃H₇-i | (S) | —CH₂—C≡C—CH₂—CH₂—CH₃ | Resin |
| A1.26 | CH₃ | C₃H₇-i | (S) | —CH₂—C≡C—CH₂—CH₂—CH₂—CH₃ | Oil |
| A1.27 | C₂H₅ | C₃H₇-i | (S) | —CH₂—C≡C—CH₂—CH₂—CH₂—CH₃ | ¹H-NMR (CDCl₃) δ(ppm): |
| | | | | | 0.8-1.0 (m, 9H); 1.²⁵-1.6 |
| | | | | | (m, 7H); 1.9-2.1 (m, 1H); |
| | | | | | 2.15-2.3 (m, 2H); 2.9 (q, |
| | | | | | 2H); 3.6 (dd, 1H); 3.9 (s, |
| | | | | | 3H); 4.8 (t, 2H); 5.05 (d, 1H); |
| | | | | | 6.8-6.9 (m, 2H); 7.1-7.4 |
| | | | | | (m, 4H); 7.6 (s, 1H); 8.25 (d, 1H). |
| A1.28 | CH₃ | C₃H₇-i | (S) | —CH₂—C≡C—CH₂—CH₃ | m.p. 138-139° C. |
| A1.29 | CH₃ | C₃H₇-i | (S) | —CH₂—C≡C—C₆H₅ | m.p. 168-170° C. |
| A1.30 | CH₃ | C₃H₇-i | (S) | —CH₂—C≡C-(4-F—C₆H₄) | m.p. 155-156° C. |
| A1.31 | CH₃ | C₃H₇-i | (S) | —CH₂—C≡C-(4-CH₃—C₆H₄) | m.p. 117-121° C. |
| A1.32 | CH₃ | C₃H₇-i | (S) | —CH₂—C₆H₅ | m.p. 62-65° C. |
| A1.33 | CH₃ | C₃H₇-i | (S) | C₂H₅ | m.p. 95-98° C. |
| A1.34 | CH₃ | C₃H₇-i | (S) | —CH₂—C≡C—CH₃ | m.p. 132-134° C. |
| A1.35 | CH₃ | C₃H₇-i | (S) | —CH₂-(4-OCF₃—C₆H₄) | m.p. 165-168° C. |
| A1.36 | CH₃ | C₃H₇-i | (S) | —CH₂—C≡C-(4-Cl—C₆H₄) | m.p. 120-122° C. |
| A1.37 | CH₃ | C₃H₇-i | (S) | —CH₂—CH₂—O—C₆H₅ | m.p. 132-136° C. |
| A1.38 | CH₃ | C₃H₇-i | (S) | —CH₂—CH₂—O-(4-F—C₆H₄) | m.p. 58-60° C. |
| A1.39 | (CH₃)₂N | C₃H₇-i | (S) | C₂H₅ | Oil |
| A1.40 | (CH₃)₂N | C₃H₇-i | (S) | —CH₂-(4-OCF₃—C₆H₄) | m.p. 141-142° C. |
| A1.41 | (CH₃)₂N | C₃H₇-i | (S) | —CH₂—C≡C—C₆H₅ | m.p. 75-78° C. |
| A1.42 | (CH₃)₂N | C₃H₇-i | (S) | —CH₂—C≡C-(4-Cl—C₆H₄) | m.p. 66-68 v |
| A1.43 | (CH₃)₂N | C₃H₇-i | (S) | —CH₂—C≡C-(4-F—C₆H₄) | m.p. 78-81° C. |
| A1.44 | (CH₃)₂N | C₃H₇-i | (S) | —CH₂—C≡C-(4-Br—C₆H₄) | m.p. 77-79° C. |
| A1.45 | (CH₃)₂N | C₃H₇-i | (S) | —CH₂—CH₂—O—C₆H₅ | m.p. 128-131° C. |
| A1.46 | (CH₃)₂N | C₃H₇-i | (S) | —CH₂—CH₂—O-(4-Cl—C₆H₄) | m.p. 53-55° C. |
| A1.47 | CH₃ | C₃H₇-i | (S) | CH₃ | m.p. 68-70° C. |
| A1.48 | CH₃ | C₃H₇-i | (S) | —CH₂—C≡C-(4-Br—C₆H₄) | m.p. 77-79° C. |
| A1.49 | CH₃ | C₃H₇-i | (S) | —CH₂—CH₂—O-(4-Cl—C₆H₄) | m.p. 130-131° C. |
| A1.50 | C₂H₅ | C₃H₇-i | (S) | CH₃ | ¹H-NMR (CDCl₃) δ(ppm): |
| | | | | | 0.9 (d, 3H); 1.0 (d, 3H); 1.35 |
| | | | | | (t, 3H); 1.9-2.1 (m, 1H); 2.9 |
| | | | | | (q, 2H); 3.6 (dd, 1H); 3.9 (s, |
| | | | | | 3H); 3.95 (s, 3H); 5.0 (d, |
| | | | | | 1H); 6.8-7.05 (m, 3H); 7.15- |
| | | | | | 7.4 (m, 3H); 7.6 (s, 1H); |
| | | | | | 8.3 (d, 1H). |
| A1.51 | (CH₃)₂N | C₃H₇-i | (S) | CH₃ | ¹H-NMR (CDCl₃) δ(ppm): |
| | | | | | 0.9 (d, 3H); 0.95 (d, 3H); 1.9- |
| | | | | | 2.05 (m, 1H); 2.7 (s, 6H); |
| | | | | | 3.45 (dd, 1H); 3.9 (s, 3H); |
| | | | | | 3.95 (s, 3H); 4.95 (d, 1H); |
| | | | | | 6.8-7.05 (m, 3H); 7.15- |
| | | | | | 7.4 (m, 3H); 7.6 (s, 1H); 8.35 |
| | | | | | (d, 1H). |
| A1.52 | (CH₃)₂N | C₃H₇-i | (S) | —CH₂—C≡C—CH₃ | m.p. 46-48° C. |
| A1.53 | (CH₃)₂N | C₃H₇-i | (S) | —CH₂—C≡C—CH₂—CH₃ | ¹H-NMR (CDCl₃) δ(ppm): |
| | | | | | 0.9 (d, 3H); 0.95 (d, 3H); |
| | | | | | 1.15 (t, 3H); 1.9-2.1 (m, |
| | | | | | 1H); 2.15-2.3 (m, 2H); 2.7 |
| | | | | | (s, 6H); 3.5 (dd, 1H); 3.9 (s, |
| | | | | | 3H); 4.3 (t, 2H); 5.05 (d, 1H); |
| | | | | | 6.8-6.95 (m, 2H); 7.1- |
| | | | | | 7.45 (m, 4H); 7.6 (s, 1H); 8.3 |
| | | | | | (d, 1H). |
| A1.54 | (CH₃)₂N | C₃H₇-i | (S) | —CH₂—C≡C—CH₂—CH₂—CH₃ | Oil |
| A1.55 | (CH₃)₂N | C₃H₇-i | (S) | —CH₂—C₆H₅ | Oil |
| A1.56 | (CH₃)₂N | C₃H₇-i | (S) | —CH₂—C≡C-(4-CH₃—C₆H₄) | m.p. 64-67° C. |
| A1.57 | (CH₃)₂N | C₃H₇-i | (S) | —CH₂—CH₂—O-(4-F-C₆H₄) | Oil |
| A1.58 | (CH₃)₂N | C₃H₇-i | (S) | —CH₂—C≡C—C₆H₁₁-cycl | ¹H-NMR (CDCl₃) δ(ppm): |
| | | | | | 0.85 (d, 3H); 0.95 (d, 3H); |
| | | | | | 1.2-1.85(m, 13H); 1.9- |
| | | | | | 2.1 (m, 1H); 2.3-2.5 (m, |
| | | | | | 1H); 2.9 (q, 2H); 3.6 (dd, |
| | | | | | 1H); 3.85 (s, 3H); 4.8 (t, |
| | | | | | 2H); 5.1 (d, 1H); 6.8-6.95 |
| | | | | | (m, 2H); 7.1-7.4 (m, 4H); |
| | | | | | 7.7 (s, 1H); 8.25 (d, 1H). |
| A1.59 | C₂H₅ | C₃H₇-i | (S) | —CH₂-(3,4-Cl₂—C₆H₃) | m.p. 160-161° C. |
| A1.60 | CH₃ | CH₂—C≡H | (R, S) | CH₃ | Oil |
| A1.61 | CH₃ | C₄H₉-i | (S) | CH₃ | Oil |
| A1.62 | CH₃ | C₂H₅ | (S) | CH₃ | Oil |
| A1.63 | CH₃ | CH₂—CH═CH₂ | (R, S) | CH₃ | Oil |
| A1.64 | CH₃ | C₃H₅-cycl | (R, S) | CH₃ | m.p. 153-154° C. |
| A1.65 | CH₃ | H | — | CH₃ | m.p. 158-160° C. |

According to the example A1.1 above the compounds listed in table A2 are obtained.

TABLE A2

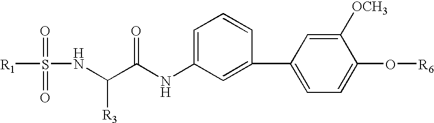

| | | | Config | | |
|---|---|---|---|---|---|
| No. | R₁ | R₃ | α-C | R₆ | physico-chemical data |
| A2.01 | C₂H₅ | C₃H₇i | (S) | —Si(C₄H₉-t)(C₆H₅)₂ | m.p. 100-102° C. |
| A2.02 | (CH₃)₂N | C₃H₇-i | (S) | —Si(C₄H₉-t)(C₆H₅)₂ | ¹H-NMR (CDCl₃), δ(ppm): 0.95- |
| | | | | | 1.1 (dd, 6H), 1.15(s, 9 H), 2.2(m, |
| | | | | | 1H), 2.80(s, 6H), 3.60(s, 3H), 3.75 |
| | | | | | (m, 1H), 5.18 (d, 1H), 6.70 (d, |
| | | | | | 1H), 6.85 (dd, 1H), 7.0 (m, 1H), |
| | | | | | 7.15-7.50 (m, 9H), 7.65 (s, 1H), |
| | | | | | 7.75 (m, 4H), 8.0 (s, 1H). |
| A2.03 | C₂H₅ | C₃H₇-i | (S) | H | m.p. 187-189.5° C. |
| A2.04 | (CH₃)₂N | C₃H₇-i | (S) | H | m.p. 185-188.5° C. |
| A2.05 | C₂H₅ | C₃H₇-i | (S) | —CH₂-(3,4-Cl₂—C₆H₃) | m.p. 146-149° C. |
| A2.06 | C₂H₅ | C₃H₇-i | (S) | —CH₂—C≡CH | m.p. 178-180° C. |
| A2.07 | C₂H₅ | C₃H₇-i | (S) | C₂H₅ | m.p. 202-203° C. |
| A2.08 | (CH₃)₂N | C₃H₇-i | (S) | —CH₂C≡CH | m.p. 131-136° C. |
| A2.09 | (CH₃)₂N | C₃H₇-i | (S) | —CH₂-(3,4-Cl₂—C₆H₃) | ¹H-NMR (CDCl₃), δ(ppm): 0.9- |
| | | | | | 1.1 (dd, 6H), 2.15 (m, 1H), 2.70 |
| | | | | | (s, 6H), 3.75 (m, 1 H), 3.95 (s, 3 |
| | | | | | H), 5.10 (s, 2H), 6.80 (d, 1H), |
| | | | | | 7.00-7.10 (m, 2H), 7.20-7.50 |
| | | | | | (m, 5H), 7.55 (d, 1H), 7.70 (s, |
| | | | | | 1H), 7.95 (s, 1H). |

According to the example A1.1, above the compounds listed in table A3 are obtained.

TABLE A3

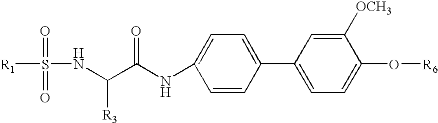

| | | | Config | | |
|---|---|---|---|---|---|
| No. | R₁ | R₃ | α-C | R₆ | physico-chemical data |
| A3.01 | C₂H₅ | C₃H₇-i | (S) | —Si(C₄H₉-t)(C₆H₅)₂ | ¹H-NMR (CDCl₃), δ(ppm): 0.95- |
| | | | | | 1.1 (dd, 6H), 1.15 (s, 9H), 1.38 (t, |
| | | | | | 3H), 2.15 (m, 1H), 3.15 (m, 2H), |
| | | | | | 3.60 (s, 3H), 3.85 (m, 1H), 5.30 |
| | | | | | (d, 1H), 6.65-7.00 (3m, 3H), |
| | | | | | 7.30-7.50 (m, 8H), 7.5 (m, 2H), |
| | | | | | 7.75 (m, 4H), 8.2 (s, 1H). |
| A3.02 | (CH₃)₂N | C₃H₇-i | (S) | —Si(C₄H₉-t)(C₆H₅)₂ | ¹H-NMR (CDCl₃), δ(ppm): 0.90- |
| | | | | | 1.1 (dd, 6H), 1.15 (s, 9H), 2.20 |
| | | | | | (m, 1H), 2.70 (s, 6H), 3.60 (s, |
| | | | | | 3H), 3.70 (m, 1H), 5.15 (d, 1H), |
| | | | | | 6.70 (d, 1H), 6.80 (m, 1H), 6.95 |
| | | | | | (m, 1H), 7.30-7.45 (m, 8H), |
| | | | | | 7.55 (d, 2H), 7.75 (m, 4H), |
| | | | | | 7.95 (s, 1H). |
| A3.03 | C₂H₅ | C₃H₇-i | (S) | H | m.p. 191-192° C. |
| A3.04 | (CH₃)₂N | C₃H₇-i | (S) | H | m.p. 187.5-188.5° C. |
| A3.05 | C₂H₅ | C₃H₇-i | (S) | —CH₂-(3,4-Cl₂—C₆H₃) | m.p. 201-202° C. |
| A3.06 | C₂H₅ | C₃H₇-i | (S) | C₂H₅ | m.p. 182-184° C. |
| A3.07 | (CH₃)₂N | C₃H₇-i | (S) | —CH₂—C≡CH | m.p. 148-150° C. |
| A3.08 | (CH₃)₂N | C₃H₇-i | (S) | C₂H₅ | m.p. 186-187° C. |
| A3.09 | (CH₃)₂N | C₃H₇-i | (S) | —CH₂-(3,4-Cl₂—C₅H₃) | m.p. 201-202° C. |

### Example A1.2

### (2S)-2-Ethanesulfonylamino-N-[trans-2-(3-methoxy-4-prop-2-ynyloxy-phenyl)yclohexyl]-3-methyl-butyramide

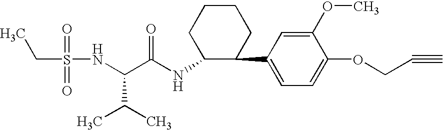

a) trans-2-Methoxy-4-(6-nitro-cyclohex-3-enyl)-phenol

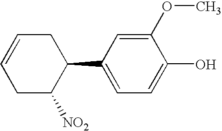

A solution of 50 g (0.25 mol) of 4-hydroxy-3-methoxy-β-nitrostyrene and 1.0 g (9.1 mmol) of hydrochinone in 200 ml toluene is cooled to −78° C. and 55 g (1.02 mol) of 1,3-butadiene is added. This mixture is transferred into an autoclave and stirred at +130° C. for 4 days. Subsequently, the toluene is evaporated in vacuum. The dark brown oil is purified by crystallization from ethanol to obtain trans-2-methoxy-4-(6-nitro-cyclohex-3-enyl)-phenol. ¹H-NMR (CDCl₃, 300 MHz); 2.28-2.83 (m, 4H, CH₂), 3.34 (td, 1H), 3.87 (s113H, OH₃), 4.89 (td, 1H), 5.53 (s, 1H, OH), 5.71-5.84 (m, 2H, CH═CH), 6.69 (d, 1H, ar), 6.73 (dd, 1H, ar), 6.85 (d, 1H, ar).

b) trans-2-Methoxy-4-(2-nitro-cyclohexyl)-phenol

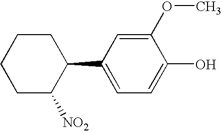

trans-2-Methoxy-4-(6-nitro-cyclohex-3-enyl)-phenol (8.4 g, 33.7 mmol) is dissolved in 300 ml methanol and 500 mg of 10% Pd/C is added. The mixture is hydrogenated at room temperature for 6 hours. The mixture is then filtered through Celite and evaporation of the filtrate in vacuum gives trans-2-methoxy-4-(2-nitro-cyclohexyl)-phenol as a light yellow solid. ¹H-NMR (CDCl₃, 300 MHz): 1.40-2.40 (m, 8H, CH₂), 3.05 (td, 1H), 3.85 (s, 3H, OCH₃), 4.62 (td, 1H), 6.65 (d, 1H, ar), 6.69 (dd, 1H, ar), 6.83 (d, 1H, ar).

c) trans-4-(2-Amino-cyclohexyl)-2-methoxy-phenol

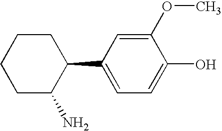

trans-2-Methoxy-4-(2-nitro-cyclohexyl)-phenol (8.5 g, 33.8 mmol) is dissolved in 300 ml methanol. To this mixture are added simultaneously 7 ml of hydrazine hydrate and 2.5 g of Raney-Nickel over 8 hours with vigorous stirring. Upon completion of the addition the reaction mixture is stirred for 16 hours at room temperature. The mixture is then filtered and evaporation of the solvent in vacuum gives trans-4-(2-amino-cyclohexyl)-2-methoxy-phenol as a light yellow solid. ¹H-NMR (CDCl₃, 300 MHz): 1.20-2.10 (m, 8H, CH₂), 2.17 (td, 1H), 2.77 (td, 1H), 3.87 (s, 3H, OCH3), 6.72 (d, 1H, ar), 6.79 (dd, 1H, ar), 6.89 (d, 1H, ar).

d) (2S)-2-Ethanesulfonylamino-N-[trans-2-(4-hydroxy-3-methoxy-phenyl)-cyclohexyl]-3-methyl-butyramide

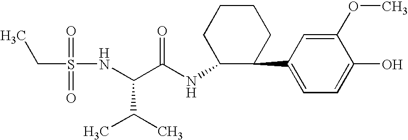

To a stirred solution of N-ethylsulfonyl-L-valine (1.3 g, 6.2 mmol), trans-4-(2-amino-cyclo-hexyl)-2-methoxy-phenol (1.23 g, 5.6 mmol) and N,N-diisopropylethylamine (0.76 g, 5.9 mmol) in 20 ml N,N-dimethylformamide is added 2.6 g (5.9 mmol) of benzotriazol-1-yloxy-tris(dimethylamino)phosphonium hexafluorophosphate in one portion. The reaction mixture is then stirred at ambient temperature for about 2 hours and subsequently poured into 150 ml of aqueous saturated sodium chloride solution. The mixture is extracted with two 150 ml portions of ethyl acetate. The extract is concentrated under reduced pressure to give a residue, which is subjected to column chromatography on silica gel, with 1:1 ethyl acetate/i-hexane as the eluant yielding (2S)-2-ethanesulfonylamino-N-[trans-2-(4-hydroxy-3-methoxy-phenyl)-cyclohexyl]-3-methyl-butyramide. ¹H-NMR (CDCl₃, 300 MHz): 0.79 (d, 3H, CH₃), 0.92 (d, 3H, CH₃), 1.10 (t, 3H, CH₃), 1.20-2.88 (m, 12H), 3.38 (dd, 1H), 3.87 (s, 3H, OCH₃), 3.98-4.15 (m, 1H), 4.95 (d, 1H), 5.42 (d, 1H), 6.62-0.6.81 (m, 3H, ar).

e) A solution of (2S)-2-ethanesulfonylamino-N-[trans-2-(4-hydroxy-3-methoxy-phenyl)-cyclohexyl]-3-methyl-butyramide (1.0 g, 2.43 mmol), propargyl bromide (0.42 g, 3.6 mmol) and 4.6 ml of 1 M solution of sodium methoxide ml 6 ml methanol is refluxed for 3 hours. The reaction mixture is cooled and poured into 30 ml of aqueous saturated sodium chloride solution. The mixture is extracted with two 100 ml portions of ethyl acetate and the extract is concentrated under reduced pressure to a residue, which is subjected to column chromatography on silica gel, with 1:1 ethyl acetate/1-hexane as the eluant to obtain (2S)-2-ethane-sulfonylamino-N-[trans-2-(3-methoxy-4-prop-2-ynyloxy-phenyl)-cyclohexyl]-3-methyl-butyramide. ¹H-NMR (CDCl₃, 300 MHz): 0.78 (d, 3H, CH₃), 0.93 (d, 3H, CH₃), 1.10 (t, 3H, CH₃), 1.21-2.00 (m, 8H), 2.12 (sep, 1H), 2.24 (dq, 1H), 2.37 (td, 1H), 2.40 (dq, 1H), 2.51 (t, 1H, C≡CH), 3.29 (dd, 1H), 3.86 (s, 3H, OCH₃), 4.12 (m, 1H), 4.72 (d, 2H, CH₂C≡C), 4.80 (d, 1H), 5.40 (d, 1H), 6.72 (dd, 1H, ar), 6.77 (d, 1H, ar), 6.92 (d, 1H, ar).

According to the example A1.2 above the compounds listed in table A4 are obtained.

TABLE A4

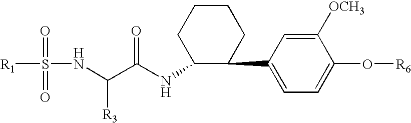

| | | | Config | | |
|---|---|---|---|---|---|
| No. | R₁ | R₃ | α-C | R₆ | physico-chemical data |
| A4.01 | C₂H₅ | C₃H₇-i | (S) | —CH₂—C≡CCH₂CH₃ | m.p. 133-136 |
| A4.02 | CH₃ | C₃H₇-i | (S) | CH₃ | m.p. 158-164 |
| A4.03 | (CH₃)₂N | C₃H₇-i | (S) | CH₃ | m.p. 182-184 |
| A4.04 | (CH₃)₂N | C₃H₇-i | (S) | —CH₂—C≡CH | Oil |
| A4.05 | C₂H₅ | C₃H₇-i | (S) | H | Oil |
| A4.06 | C₂H₅ | C₃H₇-i | (S) | CH₃ | Oil |
| A4.07 | (CH₃)₂N | C₃H₇-i | (S) | —CH₂—C≡CCH₂CH₃ | m.p. 158-160 |
| A4.08 | (CH₃)₂N | C₃H₇-i | (S) | H | Oil |
| A4.09 | CH₃ | C₃H₇-i | (S) | —CH₂—C≡CH | m.p. 183-185 |
| A4.10 | CH₃ | C₃H₇-i | (S) | —CH₂—C≡CCH₂CH₃ | m.p. 166-168 |
| A4.11 | C₂H₅ | C₃H₇-i | (S) | —CH₂—C≡CH | m.p. 149-151 |

Analogously to the above Examples the following compounds of Tables 1 to 44 may be prepared. In the tables Ph means phenyl.

TABLE 1
Compounds represented by the Formula I.1 wherein the combination
of the groups R₁, R₄, R₅ and R₆ corresponds
to each row in table A.

| | |
|---|---|
| | I.1 |
| 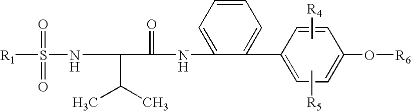 | |

TABLE 2
Compounds represented by the Formula I.2 wherein the combination
of the groups R₁, R₄, R₅ and R₆ corresponds
to each row in table A.

| | |
|---|---|
| | I.2 |
| 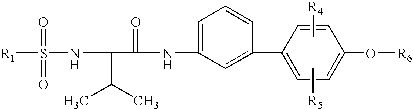 | |

TABLE 3
Compounds represented by the Formula I.3 wherein the combination
of the groups R₁, R₄, R₅ and R₆ corresponds
to each row in table A.

| | |
|---|---|
| | I.3 |
| 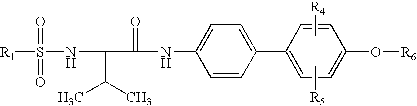 | |

TABLE 4
Compounds represented by the Formula I.4 wherein the combination
of the groups R₁, R₄, R₅ and R₆ corresponds
to each row in table A.

| | |
|---|---|
| | I.4 |
| 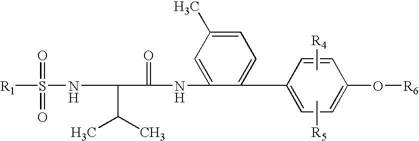 | |

TABLE 5
Compounds represented by the Formula I.5 wherein the combination
of the groups R₁, R₄, R₅ and R₆ corresponds
to each row in table A.

| | |
|---|---|
| | I.5 |
| 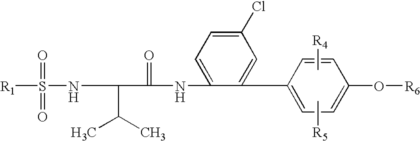 | |

TABLE 6
Compounds represented by the Formula I.6 wherein the combination
of the groups R₁, R₄, R₅ and R₆ corresponds
to each row in table A.

| | |
|---|---|
| | I.6 |
| 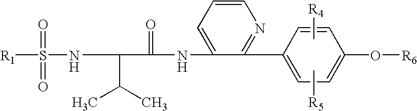 | |

TABLE 7
Compounds represented by the Formula I.7 wherein the combination of
the groups R₁, R₄, R₅ and R₆ corresponds to each row in table A.

| | |
|---|---|
| | I.7 |
| 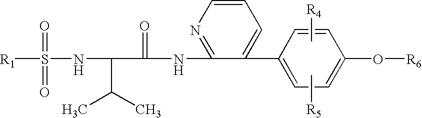 | |

TABLE 8
Compounds represented by the Formula I.8 wherein the combination of
the groups R₁, R₄, R₅ and R₆ corresponds to each row in table A.

| | |
|---|---|
| | I.8 |
| 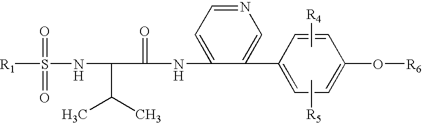 | |

TABLE 9
Compounds represented by the Formula I.9 wherein the combination of
the groups R₁, R₄, R₅ and R₆ corresponds to each row in table A.

| | |
|---|---|
| | I.9 |
| 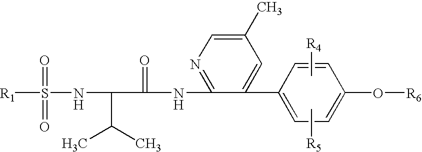 | |

TABLE 10
Compounds represented by the Formula I.10 wherein the combination
of the groups R₁, R₄, R₅ and R₆ corresponds to each row in table A.

| | |
|---|---|
| | I.10 |
| 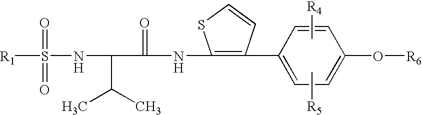 | |

TABLE 11
Compounds represented by the Formula I.11 wherein the combination
of the groups R₁, R₄, R₅ and R₆ corresponds to each row in table A.

| | |
|---|---|
| | I.11 |
| 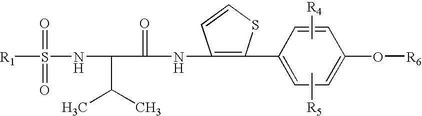 | |

TABLE 12
Compounds represented by the Formula I.12 wherein the combination
of the groups R₁, R₄, R₅ and R₆ corresponds to each row in table A.

| | |
|---|---|
| | I.12 |
| 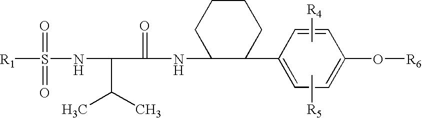 | |

TABLE 13
Compounds represented by the Formula I.13 wherein the combination
of the groups R₁, R₄, R₅ and R₆ corresponds to each row in table A.

| | |
|---|---|
| | I.13 |
| 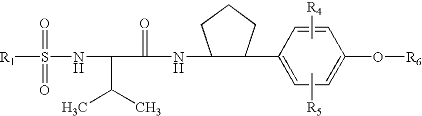 | |

TABLE 14
Compounds represented by the Formula I.14 wherein the combination
of the groups R₁, R₄, R₅ and R₆ corresponds to each row in table A.

| | |
|---|---|
| | I.14 |
| 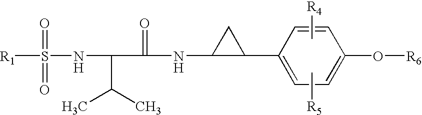 | |

TABLE 15
Compounds represented by the Formula I.15 wherein the combination
of the groups R₁, R₄, R₅ and R₆ corresponds to each row in table A.

| | |
|---|---|
| | I.15 |
| 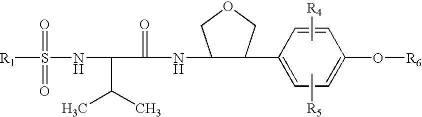 | |

TABLE 16
Compounds represented by the Formula I.16 wherein the combination
of the groups R₁, R₄, R₅ and R₆ corresponds to each row in table A.

| | |
|---|---|
| | I.16 |
| 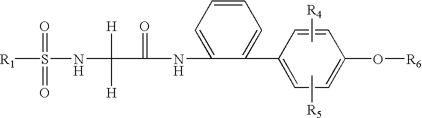 | |

TABLE 17
Compounds represented by the Formula I.17 wherein the combination of
the groups R₁, R₄, R₅ and R₆ corresponds to each row in table A.

I.17

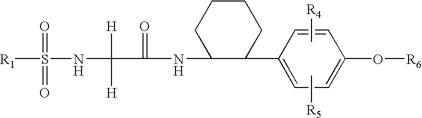

TABLE 18
Compounds represented by the Formula I.18 wherein the combination of
the groups R₁, R₄, R₅ and R₆ corresponds to each row in table A.

I.18

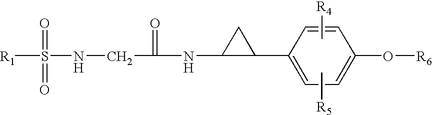

TABLE 19
Compounds represented by the Formula I.19 wherein the combination of
the groups R₁, R₄, R₅ and R₆ corresponds to each row in table A.

I.19

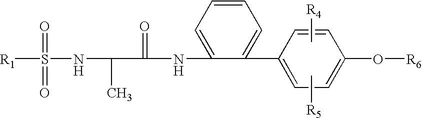

TABLE 20
Compounds represented by the Formula I.20 wherein the combination of
the groups R₁, R₄, R₅ and R₆ corresponds to each row in table A.

I.20

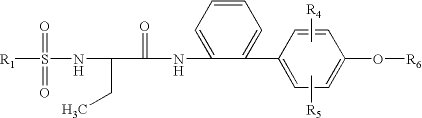

TABLE 21
Compounds represented by the Formula I.21 wherein the combination of
the groups R₁, R₄, R₅ and R₆ corresponds to each row in table A.

I.21

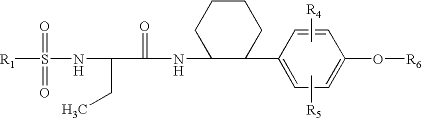

TABLE 22
Compounds represented by the Formula I.22 wherein the combination of
the groups R₁, R₄, R₅ and R₆ corresponds to each row in table A.

I.22

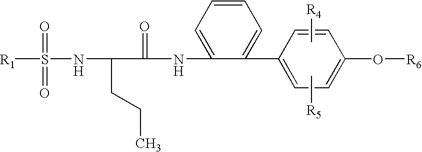

TABLE 23
Compounds represented by the Formula I.23 wherein the combination of
the groups R₁, R₄, R₅ and R₆ corresponds to each row in table A.

I.23

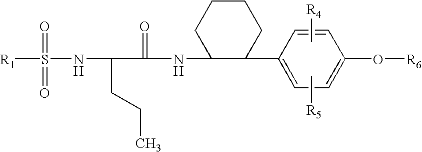

TABLE 24
Compounds represented by the Formula I.24 wherein the combination of
the groups R₁, R₄, R₅ and R₆ corresponds to each row in table A.

I.24

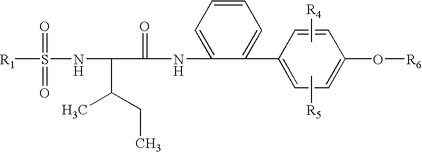

TABLE 25
Compounds represented by the Formula I.25 wherein the combination of
the groups R₁, R₄, R₅ and R₆ corresponds to each row in table A.

I.25

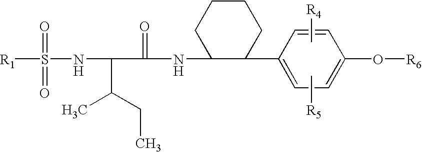

TABLE 26
Compounds represented by the Formula I.26 wherein the combination of
the groups R₁, R₄, R₅ and R₆ corresponds to each row in table A.

I.26

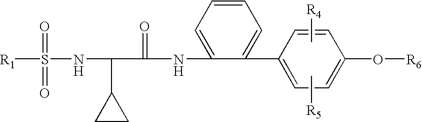

TABLE 27
Compounds represented by the Formula 1.27 wherein the combination of
the groups R₁, R₄, R₅ and R₆ corresponds to each row in table A.

| | |
|---|---|
| | I.27 |
| 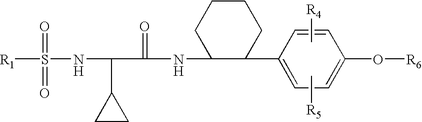 | |

TABLE 28
Compounds represented by the Formula 1.28 wherein the combination of
the groups R₁, R₄, R₅ and R₆ corresponds to each row in table A.

| | |
|---|---|
| | I.28 |
| 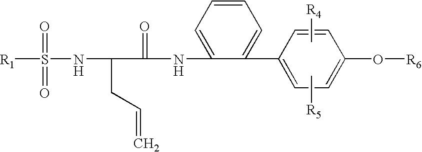 | |

TABLE 29
Compounds represented by the Formula 129 wherein the combination of
the groups R₁, R₄, R₅ and R₆ corresponds to each row in table A.

| | |
|---|---|
| | I.29 |
| 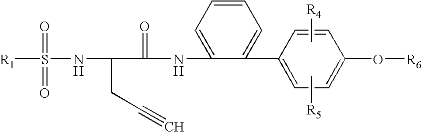 | |

TABLE 30
Compounds represented by the Formula 1.30 wherein the combination of
the groups R₁, R₄, R₅ and R₆ corresponds to each row in table A.

| | |
|---|---|
| | I.30 |
| 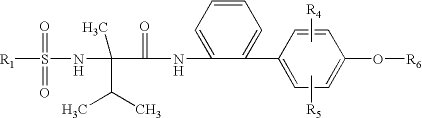 | |

TABLE 31
Compounds represented by the Formula 1.31 wherein the combination of
the groups R₁, R₄, R₅ and R₆ corresponds to each row in table A.

| | |
|---|---|
| | I.31 |
| 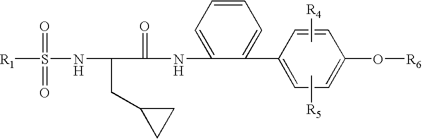 | |

TABLE 32
Compounds represented by the Formula 1.32 wherein the combination of
the groups R₁, R₄, R₅ and R₆ corresponds to each row in table A.

| | |
|---|---|
| | I.32 |
| 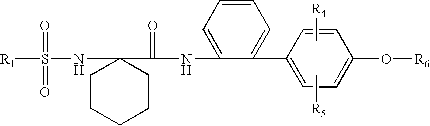 | |

TABLE 33
Compounds represented by the Formula 1.33 wherein the combination of
the groups R₁, R₄, R₅ and R₆ corresponds to each row in table A.

| | |
|---|---|
| | I.33 |
| 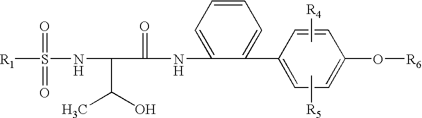 | |

TABLE 34
Compounds represented by the Formula 1.34 wherein the combination of
the groups R₁, R₄, R₅ and R₆ corresponds to each row in table A.

| | |
|---|---|
| | I.34 |
| 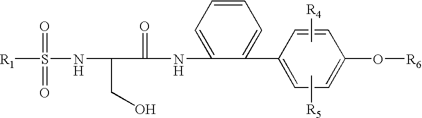 | |

TABLE 35
Compounds represented by the Formula 1.35 wherein the combination of
the groups R₁, R₄, R₅ and R₆ corresponds to each row in table A.

| | |
|---|---|
| | I.35 |
| 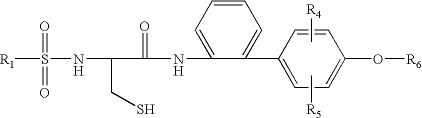 | |

TABLE 36
Compounds represented by the Formula 1.36 wherein the combination of
the groups R₁, R₄, R₅ and R₆ corresponds to each row in table A.

| | |
|---|---|
| | I.36 |
| 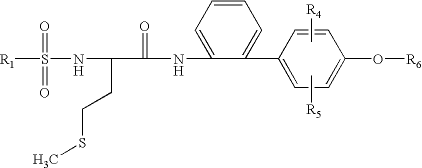 | |

TABLE 37
Compounds represented by the Formula I.37 wherein the combination
of the groups R₁, R₄, R₅ and R₆ corresponds to each row in table A.

| | |
|---|---|
| | I.37 |
| 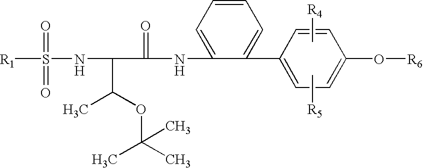 | |

TABLE 38
Compounds represented by the Formula I.38 wherein the combination
of the groups R₁, R₄, R₅ and R₆ corresponds to each row in table A.

| | |
|---|---|
| | I.38 |
| 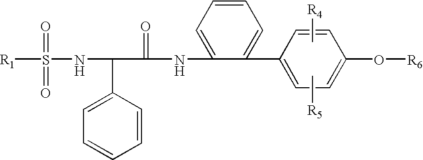 | |

TABLE 39
Compounds represented by the Formula I.39 wherein the combination
of the groups R₁, R₄, R₅ and R₆ corresponds to each row in table A.

| | |
|---|---|
| | I.39 |
| 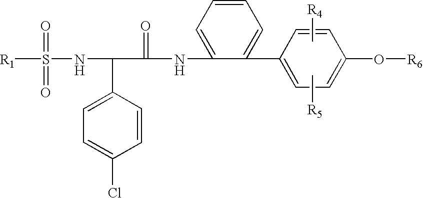 | |

TABLE 40
Compounds represented by the Formula I.40 wherein the combination
of the groups R₁, R₄, R₅ and R₆ corresponds to each row in table A.

| | |
|---|---|
| | I.40 |
| 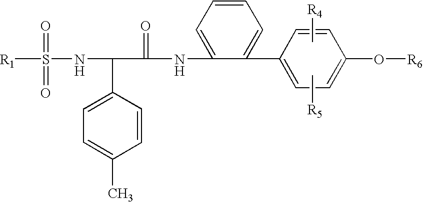 | |

TABLE 41
Compounds represented by the Formula I.41 wherein the combination
of the groups R₁, R₄, R₅ and R₆ corresponds to each row in table A.

| | |
|---|---|
| | I.41 |
| 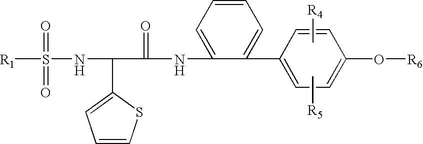 | |

TABLE 42
Compounds represented by the Formula I.42 wherein the combination
of the groups R₁, R₄, R₅ and R₆ corresponds to each row in table A.

| | |
|---|---|
| | I.42 |
| 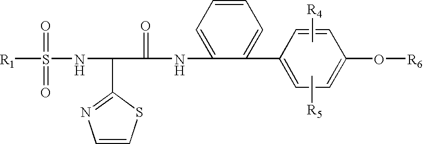 | |

TABLE 43
Compounds represented by the Formula I.43 wherein the combination
of the groups R₁, R₄, R₅ and R₆ corresponds to each row in table A.

| | |
|---|---|
| | I.43 |
| 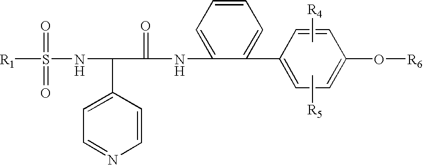 | |

TABLE 44
Compounds represented by the Formula I.44 wherein the combination
of the groups R₁, R₄, R₅ and R₆ corresponds to each row in table A.

| | |
|---|---|
| | I.44 |
| 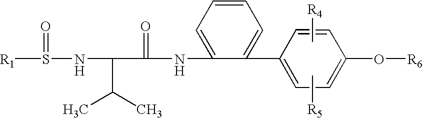 | |

TABLE A

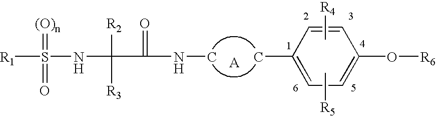

Ph designates a phenyl ring

| No. | R₁ | R₄ | R₅ | R₆ |
|---|---|---|---|---|
| 001 | CH₃— | H— | H— | —H |
| 002 | CH₃— | H— | H— | —CH₃ |
| 003 | CH₃— | H— | H— | —CH₂—CH₃ |
| 004 | CH₃— | H— | H— | —CH₂—CH₂—CH₃ |
| 005 | CH₃— | H— | H— | —CH₂—CH═CH₂ |
| 006 | CH₃— | H— | H— | —CH₂—CH═CH—CH₃ |
| 007 | CH₃— | H— | H— | —CH₂—(CH₃)C═CH₂ |
| 008 | CH₃— | H— | H— | —CH₂—CH═CHCl |
| 009 | CH₃— | H— | H— | —CH₂—C≡CH |
| 010 | CH₃— | H— | H— | —CH₂—C≡C—CH₃ |
| 011 | CH₃— | H— | H— | —CH₂—C≡C—CH₂—CH₃ |
| 012 | CH₃— | H— | H— | —CH₂—C≡C—(CH₂)₂—CH₃ |
| 013 | CH₃— | H— | H— | —CH₂—C≡C—C₃H₅-cycl |
| 014 | CH₃— | H— | H— | —CH₂—C≡C—C₅H₉-cycl |
| 015 | CH₃— | H— | H— | —CH₂—C≡C—C₆H₁₁-cycl |
| 016 | CH₃— | H— | H— | —CH₂—Ph |
| 017 | CH₃— | H— | H— | —CH₂—(3-Cl—Ph) |
| 018 | CH₃— | H— | H— | —CH₂—(4-Cl—Ph) |
| 019 | CH₃— | H— | H— | —CH₂—(3,4-Cl₂—Ph) |
| 020 | CH₃— | H— | H— | —CH₂—(3-CF₃—Ph) |
| 021 | CH₃— | H— | H— | —CH₂—C≡C—Ph |
| 022 | CH₃— | H— | H— | —CH₂—C≡C—(4-CH₃—Ph) |
| 023 | CH₃— | H— | H— | —CH₂—C≡C—(4-Cl—Ph) |
| 024 | CH₃— | H— | H— | —CH₂—C≡C—(4-F—Ph) |
| 025 | CH₃— | H— | H— | —CH₂—C≡C—(4-Br—Ph) |
| 026 | CH₃— | H— | H— | —CH₂—CH₂—O—Ph |
| 027 | CH₃— | H— | H— | —CH₂—CH₂—O—(4-F—Ph) |
| 028 | CH₃— | H— | H— | —CH₂—CH₂—O—(4-Cl—Ph) |
| 029 | CH₃—CH₂— | H— | H— | —H |
| 030 | CH₃—CH₂— | H— | H— | —CH₃ |
| 031 | CH₃—CH₂— | H— | H— | —CH₂—CH₃ |
| 032 | CH₃—CH₂— | H— | H— | —CH₂—CH₂—CH₃ |
| 033 | CH₃—CH₂— | H— | H— | —CH₂—CH═CH₂ |
| 034 | CH₃—CH₂— | H— | H— | —CH₂—CH═CH—CH₃ |
| 035 | CH₃—CH₂— | H— | H— | —CH₂—(CH₃)C═CH₂ |
| 036 | CH₃—CH₂— | H— | H— | —CH₂—CH═CHCl |
| 037 | CH₃—CH₂— | H— | H— | —CH₂—C≡CH |
| 038 | CH₃—CH₂— | H— | H— | —CH₂—C≡C—CH₃ |
| 039 | CH₃—CH₂— | H— | H— | —CH₂—C≡C—CH₂—CH₃ |
| 040 | CH₃—CH₂— | H— | H— | —CH₂—C≡C—(CH₂)₂—CH₃ |
| 041 | CH₃—CH₂— | H— | H— | —CH₂—C≡C—C₃H₅-cycl |
| 042 | CH₃—CH₂— | H— | H— | —CH₂—C≡C—C₅H₉-cycl |
| 043 | CH₃—CH₂— | H— | H— | —CH₂—C≡C—C₆H₁₁-cycl |
| 044 | CH₃—CH₂— | H— | H— | —CH₂—Ph |
| 045 | CH₃—CH₂— | H— | H— | —CH₂—(3-Cl—Ph) |
| 046 | CH₃—CH₂— | H— | H— | —CH₂—(4-Cl—Ph) |
| 047 | CH₃—CH₂— | H— | H— | —CH₂—(3,4-Cl₂—Ph) |
| 048 | CH₃—CH₂— | H— | H— | —CH₂—(3-CF₃—Ph) |
| 049 | CH₃—CH₂— | H— | H— | —CH₂—C≡C—Ph |
| 050 | CH₃—CH₂— | H— | H— | —CH₂—C≡C—(4-CH₃—Ph) |
| 051 | CH₃—CH₂— | H— | H— | —CH₂—C≡C—(4-Cl—Ph) |
| 052 | CH₃—CH₂— | H— | H— | —CH₂—C≡C—(4-F—Ph) |
| 053 | CH₃—CH₂— | H— | H— | —CH₂—C≡C—(4-Br—Ph) |
| 054 | CH₃—CH₂— | H— | H— | —CH₂—CH₂—O—Ph |
| 055 | CH₃—CH₂— | H— | H— | —CH₂—CH₂—O—(4-F—Ph) |
| 056 | CH₃—CH₂— | H— | H— | —CH₂—CH₂—O—(4-Cl—Ph) |
| 057 | (CH₃)₂N— | H— | H— | —H |
| 058 | (CH₃)₂N— | H— | H— | —CH₃ |
| 059 | (CH₃)₂N— | H— | H— | —CH₂—CH₃ |
| 060 | (CH₃)₂N— | H— | H— | —CH₂—CH₂—CH₃ |
| 061 | (CH₃)₂N— | H— | H— | —CH₂—CH═CH₂ |
| 062 | (CH₃)₂N— | H— | H— | —CH₂—CH═CH—CH₃ |
| 063 | (CH₃)₂N— | H— | H— | —CH₂—(CH₃)C═CH₂ |
| 064 | (CH₃)₂N— | H— | H— | —CH₂—CH═CHCl |
| 065 | (CH₃)₂N— | H— | H— | —CH₂—C≡CH |
| 066 | (CH₃)₂N— | H— | H— | —CH₂—C≡C—CH₃ |
| 067 | (CH₃)₂N— | H— | H— | —CH₂—C≡C—CH₂—CH₃ |
| 068 | (CH₃)₂N— | H— | H— | —CH₂—C≡C—(CH₂)₂—CH₃ |
| 069 | (CH₃)₂N— | H— | H— | —CH₂—C≡C—C₃H₅-cycl |
| 070 | (CH₃)₂N— | H— | H— | —CH₂—C≡C—C₅H₉-cycl |
| 071 | (CH₃)₂N— | H— | H— | —CH₂—C≡C—C₆H₁₁-cycl |
| 072 | (CH₃)₂N— | H— | H— | —CH₂—Ph |
| 073 | (CH₃)₂N— | H— | H— | —CH₂—(3-Cl—Ph) |
| 074 | (CH₃)₂N— | H— | H— | —CH₂—(4-Cl—Ph) |
| 075 | (CH₃)₂N— | H— | H— | —CH₂—(3,4-Cl₂—Ph) |
| 076 | (CH₃)₂N— | H— | H— | —CH₂—(3-CF₃—Ph) |
| 077 | (CH₃)₂N— | H— | H— | —CH₂—C≡C—Ph |
| 078 | (CH₃)₂N— | H— | H— | —CH₂—C≡C—(4-CH₃—Ph) |
| 079 | (CH₃)₂N— | H— | H— | —CH₂—C≡C—(4-Cl—Ph) |
| 080 | (CH₃)₂N— | H— | H— | —CH₂—C≡C—(4-F—Ph) |
| 081 | (CH₃)₂N— | H— | H— | —CH₂—C≡C—(4-Br—Ph) |
| 082 | (CH₃)₂N— | H— | H— | —CH₂—CH₂—O—Ph |
| 083 | (CH₃)₂N— | H— | H— | —CH₂—CH₂—O—(4-F—Ph) |
| 084 | (CH₃)₂N— | H— | H— | —CH₂—CH₂—O—(4-Cl—Ph) |
| 085 | CH₃—CH₂— | 3-CH₃—O— | H— | —H |
| 086 | CH₃—CH₂— | 3-CH₃—O— | H— | —CH₃ |
| 087 | CH₃—CH₂— | 3-CH₃—O— | H— | —CH₂—CH₃ |
| 088 | CH₃—CH₂— | 3-CH₃—O— | H— | —CH₂—CH₂—CH₃ |
| 089 | CH₃—CH₂— | 3-CH₃—O— | H— | —CH₂—CH═CH₂ |
| 090 | CH₃—CH₂— | 3-CH₃—O— | H— | —CH₂—CH═CH—CH₃ |
| 091 | CH₃—CH₂— | 3-CH₃—O— | H— | —CH₂—(CH₃)C≡CH₂ |
| 092 | CH₃—CH₂— | 3-CH₃—O— | H— | —CH₂—CH═CHCl |
| 093 | CH₃—CH₂— | 3-CH₃—O— | H— | —CH₂—C≡CH |
| 094 | CH₃—CH₂— | 3-CH₃—O— | H— | —CH₂—C≡C—CH₃ |
| 095 | CH₃—CH₂— | 3-CH₃—O— | H— | —CH₂—C≡C—CH₂—CH₃ |
| 096 | CH₃—CH₂— | 3-CH₃—O— | H— | —CH₂—C≡C—(CH₂)₂—CH₃ |
| 097 | CH₃—CH₂— | 3-CH₃—O— | H— | —CH₂—C≡C—C₃H₅-cycl |
| 098 | CH₃—CH₂— | 3-CH₃—O— | H— | —CH₂—C≡C—C₅H₉-cycl |
| 099 | CH₃—CH₂— | 3-CH₃—O— | H— | —CH₂—C≡C—C₆H₁₁-cycl |
| 100 | CH₃—CH₂— | 3-CH₃—O— | H— | —CH₂—Ph |
| 101 | CH₃—CH₂— | 3-CH₃—O— | H— | —CH₂—(3-Cl—Ph) |
| 102 | CH₃—CH₂— | 3-CH₃—O— | H— | —CH₂—(4-Cl—Ph) |
| 103 | CH₃—CH₂— | 3-CH₃—O— | H— | —CH₂—(3,4-Cl₂—Ph) |
| 104 | CH₃—CH₂— | 3-CH₃—O— | H— | —CH₂—(3-CF₃—Ph) |
| 105 | CH₃—CH₂— | 3-CH₃—O— | H— | —CH₂—C≡C—Ph |
| 106 | CH₃—CH₂— | 3-CH₃—O— | H— | —CH₂—C≡C—(4-CH₃—Ph) |
| 107 | CH₃—CH₂— | 3-CH₃—O— | H— | —CH₂—C≡C—(4-Cl—Ph) |
| 108 | CH₃—CH₂— | 3-CH₃—O— | H— | —CH₂—C≡C—(4-F—Ph) |
| 109 | CH₃—CH₂— | 3-CH₃—O— | H— | —CH₂—C≡C—(4-Br—Ph) |
| 110 | CH₃—CH₂— | 3-CH₃—O— | H— | —CH₂—CH₂—O—Ph |
| 111 | CH₃—CH₂— | 3-CH₃—O— | H— | —CH₂—CH₂—O—(4-F—Ph) |
| 112 | CH₃—CH₂— | 3-CH₃—O— | H— | —CH₂—CH₂—O—(4-Cl—Ph) |
| 113 | CH₃— | 3-CH₃—O— | H— | —H |
| 114 | CH₃— | 3-CH₃—O— | H— | —CH₃ |
| 115 | CH₃— | 3-CH₃—O— | H— | —CF₃ |
| 116 | CH₃— | 3-CH₃—O— | H— | CHF₂ |
| 117 | CH₃— | 3-CH₃—O— | H— | —CH₂—CH₃ |
| 118 | CH₃— | 3-CH₃—O— | H— | —CH₂—CH₂—CH₃ |
| 119 | CH₃— | 3-CH₃—O— | H— | —CH₂—CH═CH₂ |
| 120 | CH₃— | 3-CH₃—O— | H— | —CH₂—CH═CH—CH₃ |
| 121 | CH₃— | 3-CH₃—O— | H— | —CH₂—(CH₃)C═CH₂ |
| 122 | CH₃— | 3-CH₃—O— | H— | —CH₂—CH═CHCl |
| 123 | CH₃— | 3-CH₃—O— | H— | —CH₂—C≡CH |
| 124 | CH₃— | 3-CH₃—O— | H— | —CH(CH₃)—C≡CH |
| 125 | CH₃— | 3-CH₃—O— | H— | —CH₂—C≡C—CF₃ |
| 126 | CH₃— | 3-CH₃—O— | H— | —CH₂—C≡C—CH₃ |
| 127 | CH₃— | 3-CH₃—O— | H— | —CH₂—C≡C—CH₂—CH₃ |
| 128 | CH₃— | 3-CH₃—O— | H— | —CH₂—C≡C—(CH₂)₂—CH₃ |
| 129 | CH₃— | 3-CH₃—O— | H— | —CH₂—C≡C—(CH₂)₄—CH₃ |
| 130 | CH₃— | 3-CH₃—O— | H— | —CH₂—C≡C—C₃H₅-cycl |
| 131 | CH₃— | 3-CH₃—O— | H— | —CH₂—C≡C—C₅H₉-cycl |
| 132 | CH₃— | 3-CH₃—O— | H— | —CH₂—C≡C—C₆H₁₁-cycl |
| 133 | CH₃— | 3-CH₃—O— | H— | —CH₂—Ph |
| 134 | CH₃— | 3-CH₃—O— | H— | —CH₂—(3-Cl—Ph) |
| 135 | CH₃— | 3-CH₃—O— | H— | —CH₂—(4-F—Ph) |
| 136 | CH₃— | 3-CH₃—O— | H— | —CH₂—(4-Cl—Ph) |
| 137 | CH₃— | 3-CH₃—O— | H— | —CH₂—(4-Br—Ph) |
| 138 | CH₃— | 3-CH₃—O— | H— | —CH₂—(4-I—Ph) |
| 139 | CH₃— | 3-CH₃—O— | H— | —CH₂—(4-CH₃—Ph) |
| 140 | CH₃— | 3-CH₃—O— | H— | —CH₂—(3-NO₂—Ph) |
| 141 | CH₃— | 3-CH₃—O— | H— | —CH₂—(4-CN—Ph) |
| 142 | CH₃— | 3-CH₃—O— | H— | —CH₂—(4-CH₃O—Ph) |
| 143 | CH₃— | 3-CH₃—O— | H— | —CH₂—(4-H₂C═CH—Ph) |
| 144 | CH₃— | 3-CH₃—O— | H— | —CH₂—(4-CH₃S—Ph) |
| 145 | CH₃— | 3-CH₃—O— | H— | —CH₂—(4-CF₃S—Ph) |
| 146 | CH₃— | 3-CH₃—O— | H— | —CH₂—(3,4-Cl₂—Ph) |
| 147 | CH₃— | 3-CH₃—O— | H— | —CH₂—(3-CF₃—Ph) |
| 148 | CH₃— | 3-CH₃—O— | H— | —CH₂—C≡C—Ph |
| 149 | CH₃— | 3-CH₃—O— | H— | —CH₂—C≡C—(4-CH₃—Ph) |
| 150 | CH₃— | 3-CH₃—O— | H— | —CH₂—C≡C—(4-Cl—Ph) |
| 151 | CH₃— | 3-CH₃—O— | H— | —CH₂—C≡C—(4-F—Ph) |
| 152 | CH₃— | 3-CH₃—O— | H— | —CH₂—C≡C—(4-Br—Ph) |
| 153 | CH₃— | 3-CH₃—O— | H— | —CH₂—C≡C—(3-CN—Ph) |
| 154 | CH₃— | 3-CH₃—O— | H— | —CH₂—C≡C—(3,4-Cl₂—Ph) |
| 155 | CH₃— | 3-CH₃—O— | H— | —CH₂—CH₂—O—Ph |
| 156 | CH₃— | 3-CH₃—O— | H— | —CH₂—CH₂—O—(4-F—Ph) |
| 157 | CH₃— | 3-CH₃—O— | H— | —CH₂—CH₂—O—(4-Cl—Ph) |
| 158 | CH₃— | 3-CH₃—O— | H— | —CH₂—CH₂—O—(4-Br—Ph) |
| 159 | CH₃— | 3-CH₃—O— | H— | —CH₂—CH₂—O—(4-CH₃—Ph) |
| 160 | CH₃— | 3-CH₃—O— | H— | —CH₂—CH₂—O—(4-CH₃O—Ph) |
| 161 | CH₃— | 3-CH₃—O— | H— | —CH₂—CH₂—S—Ph |
| 162 | CH₃— | 3-CH₃—O— | H— | —CH₂—CH₂—NH—Ph |
| 163 | CH₃— | 3-CH₃—O— | H— | —CH₂—CH₂—O—CH₃ |
| 164 | CH₃— | 3-CH₃—O— | H— | —CH₂—CH₂—O—CH₂—CH₃ |
| 165 | CH₃— | 3-CH₃—O— | H— | —CH₂—CH₂—O—CH₂—CH═CH₂ |
| 166 | CH₃— | 3-CH₃—O— | H— | —CH₂—CH₂—O—CH₂—C═OH |
| 167 | (CH₃)₂N— | 3-CH₃—O— | H— | —H |
| 168 | (CH₃)₂N— | 3-CH₃—O— | H— | —CH₃ |
| 169 | (CH₃)₂N— | 3-CH₃—O— | H— | —CF₃ |
| 170 | (CH₃)₂N— | 3-CH₃—O— | H— | CHF₂ |
| 171 | (CH₃)₂N— | 3-CH₃—O— | H— | —CH₂—CH₃ |
| 172 | (CH₃)₂N— | 3-CH₃—O— | H— | —CH₂—CH₂—CH₃ |
| 173 | (CH₃)₂N— | 3-CH₃—O— | H— | —CH₂—CH═CH₂ |
| 174 | (CH₃)₂N— | 3-CH₃—O— | H— | —CH₂—CH═CH—CH₃ |
| 175 | (CH₃)₂N— | 3-CH₃—O— | H— | —CH₂—(CH₃)C═CH₂ |
| 176 | (CH₃)₂N— | 3-CH₃—O— | H— | —CH₂—CH═CHCl |
| 177 | (CH₃)₂N— | 3-CH₃—O— | H— | —CH₂—C≡CH |
| 178 | (CH₃)₂N— | 3-CH₃—O— | H— | —CH(CH₃)—C≡CH |
| 179 | (CH₃)₂N— | 3-CH₃—O— | H— | —CH₂—C≡C—CF₃ |
| 180 | (CH₃)₂N— | 3-CH₃—O— | H— | —CH₂—C≡C—CH₃ |
| 181 | (CH₃)₂N— | 3-CH₃—O— | H— | —CH₂—C≡C—CH₂—CH₃ |
| 182 | (CH₃)₂N— | 3-CH₃—O— | H— | —CH₂—C≡C—(CH₂)₂—CH₃ |
| 183 | (CH₃)₂N— | 3-CH₃—O— | H— | —CH₂—C≡C—(CH₂)₄—CH₃ |
| 184 | (CH₃)₂N— | 3-CH₃—O— | H— | —CH₂—C≡C—C₃H₅-cycl |
| 185 | (CH₃)₂N— | 3-CH₃—O— | H— | —CH₂—C≡C—C₅H₉-cycl |
| 186 | (CH₃)₂N— | 3-CH₃—O— | H— | —CH₂—C≡C—C₆H₁₁-cycl |
| 187 | (CH₃)₂N— | 3-CH₃—O— | H— | —CH₂—Ph |
| 188 | (CH₃)₂N— | 3-CH₃—O— | H— | —CH₂—(3-Cl—Ph) |
| 189 | (CH₃)₂N— | 3-CH₃—O— | H— | —CH₂—(4-F—Ph) |
| 190 | (CH₃)₂N— | 3-CH₃—O— | H— | —CH₂—(4-Cl—Ph) |
| 191 | (CH₃)₂N— | 3-CH₃—O— | H— | —CH₂—(4-Br—Ph) |
| 192 | (CH₃)₂N— | 3-CH₃—O— | H— | —CH₂—(4-I—Ph) |
| 193 | (CH₃)₂N— | 3-CH₃—O— | H— | —CH₂—(4-CH₃—Ph) |
| 194 | (CH₃)₂N— | 3-CH₃—O— | H— | —CH₂—(3-NO₂—Ph) |
| 195 | (CH₃)₂N— | 3-CH₃—O— | H— | —CH₂—(4-CN—Ph) |
| 196 | (CH₃)₂N— | 3-CH₃—O— | H— | —CH₂—(4-CH₃O—Ph) |
| 197 | (CH₃)₂N— | 3-CH₃—O— | H— | —CH₂—(4-H₂C═CH—Ph) |
| 198 | (CH₃)₂N— | 3-CH₃—O— | H— | —CH₂—(4-CH₃S—Ph) |
| 199 | (CH₃)₂N— | 3-CH₃—O— | H— | —CH₂—(4-CF₃S—Ph) |
| 200 | (CH₃)₂N— | 3-CH₃—O— | H— | —CH₂—(3,4-Cl₂—Ph) |
| 201 | (CH₃)₂N— | 3-CH₃—O— | H— | —CH₂—(3-CF₃—Ph) |
| 202 | (CH₃)₂N— | 3-CH₃—O— | H— | —CH₂—C≡C—Ph |
| 203 | (CH₃)₂N— | 3-CH₃—O— | H— | —CH₂—C≡C—(4-CH₃—Ph) |
| 204 | (CH₃)₂N— | 3-CH₃—O— | H— | —CH₂—C≡C—(4-Cl—Ph) |
| 205 | (CH₃)₂N— | 3-CH₃—O— | H— | —CH₂—C≡C—(4-F—Ph) |
| 206 | (CH₃)₂N— | 3-CH₃—O— | H— | —CH₂—C≡C—(4-Br—Ph) |
| 207 | (CH₃)₂N— | 3-CH₃—O— | H— | —CH₂—C≡C—(3-CN—Ph) |
| 208 | (CH₃)₂N— | 3-CH₃—O— | H— | —CH₂—C≡C—(3,4-Cl₂Ph) |
| 209 | (CH₃)₂N— | 3-CH₃—O— | H— | —CH₂—CH₂—O—Ph |
| 210 | (CH₃)₂N— | 3-CH₃—O— | H— | —CH₂—CH₂—O—(4-F—Ph) |
| 211 | (CH₃)₂N— | 3-CH₃—O— | H— | —CH₂—CH₂—O—(4-Cl—Ph) |
| 212 | (CH₃)₂N— | 3-CH₃—O— | H— | —CH₂—CH₂—O—(4-Br—Ph) |
| 213 | (CH₃)₂N— | 3-CH₃—O— | H— | —CH₂—CH₂—O—(4-CH₃—Ph) |
| 214 | (CH₃)₂N— | 3-CH₃—O— | H— | —CH₂—CH₂—O—(4-CH₃O—Ph) |
| 215 | (CH₃)₂N— | 3-CH₃—O— | H— | —CH₂—CH₂—S—Ph |
| 216 | (CH₃)₂N— | 3-CH₃—O— | H— | —CH₂—CH₂—NH—Ph |
| 217 | (CH₃)₂N— | 3-CH₃—O— | H— | —CH₂—CH₂—O—CH₃ |
| 218 | (CH₃)₂N— | 3-CH₃—O— | H— | —CH₂—CH₂—O—CH₂—CH₃ |
| 219 | (CH₃)₂N— | 3-CH₃—O— | H— | —CH₂—CH₂—O—CH₂—CH═CH₂ |
| 220 | (CH₃)₂N— | 3-CH₃—O— | H— | —CH₂—CH₂—O—CH₂—C≡CH |
| 221 | CH₃—CH₂—CH₂— | 3-CH₃—O— | H— | —CH₃ |
| 222 | CH₃—CH₂—CH₂— | 3-CH₃—O— | H— | —CH₂—CH₃ |
| 223 | CH₃—CH₂—CH₂— | 3-CH₃—O— | H— | —CH₂—CH═CH₂ |
| 224 | CH₃—CH₂—CH₂— | 3-CH₃—O— | H— | —CH₂—C≡CH |
| 225 | CH₃—CH₂—CH₂— | 3-CH₃—O— | H— | —CH₂—C≡C—CH₂—CH₃ |
| 226 | CH₃—CH₂—CH₂— | 3-CH₃—O— | H— | —CH₂—C≡C—C₃H₅-cycl |
| 227 | CH₃—CH₂—CH₂— | 3-CH₃—O— | H— | —CH₂—C≡C—Ph |
| 228 | CH₃—CH₂—CH₂— | 3-CH₃—O— | H— | —CH₂—C≡C—(4-Cl—Ph) |
| 229 | CH₃—CH₂—CH₂— | 3-CH₃—O— | H— | —CH₂—CH₂—O—Ph |
| 230 | CH₃—CH₂—CH₂— | 3-CH₃—O— | H— | —CH₂—CH₂—O—(4-F—Ph) |
| 231 | CH₃—CH₂—CH₂— | 3-CH₃—O— | H— | —CH₂—CH₂—O—(4-Cl—Ph) |
| 232 | (CH₃)₂CH— | 3-CH₃—O— | H— | —CH₃ |
| 233 | (CH₃)₂CH— | 3-CH₃—O— | H— | —CH₂—CH₃ |
| 234 | (CH₃)₂CH— | 3-CH₃—O— | H— | —CH₂—CH═CH₂ |
| 235 | (CH₃)₂CH— | 3-CH₃—O— | H— | —CH₂—C≡CH |
| 236 | (CH₃)₂CH— | 3-CH₃—O— | H— | —CH₂—C≡C—CH₂—CH₃ |
| 237 | (CH₃)₂CH— | 3-CH₃—O— | H— | —CH₂—C≡C—C₃H₅-cycl |
| 238 | (CH₃)₂CH— | 3-CH₃—O— | H— | —CH₂—C≡C—Ph |
| 239 | (CH₃)₂CH— | 3-CH₃—O— | H— | —CH₂—C≡C—(4-Cl—Ph) |
| 240 | (CH₃)₂CH— | 3-CH₃—O— | H— | —CH₂—CH₂—O—Ph |
| 241 | (CH₃)₂CH— | 3-CH₃—O— | H— | —CH₂—CH₂—O—(4-F—Ph) |
| 242 | (CH₃)₂CH— | 3-CH₃—O— | H— | —CH₂—CH₂—O—(4-Cl—Ph) |
| 243 | CH₃—(CH₂)₃— | 3-CH₃—O— | H— | —CH₃ |
| 244 | CH₃—(CH₂)₃— | 3-CH₃—O— | H— | —CH₂—CH₃ |
| 245 | CH₃—(CH₂)₃— | 3-CH₃—O— | H— | —CH₂—CH═CH₂ |
| 246 | CH₃—(CH₂)₃— | 3-CH₃—O— | H— | —CH₂—C≡CH |
| 247 | CH₃—(CH₂)₃— | 3-CH₃—O— | H— | —CH₂—C≡C—CH₂—CH₃ |
| 248 | CH₃—(CH₂)₃— | 3-CH₃—O— | H— | —CH₂—C≡C—C₃H₅-cycl |
| 249 | CH₃—(CH₂)₃— | 3-CH₃—O— | H— | —CH₂—C≡C—Ph |
| 250 | CH₃—(CH₂)₃— | 3-CH₃—O— | H— | —CH₂—C≡C—(4-Cl—Ph) |
| 251 | CH₃—(CH₂)₃— | 3-CH₃—O— | H— | —CH₂—CH₂—O—Ph |
| 252 | CH₃—(CH₂)₃— | 3-CH₃—O— | H— | —CH₂—CH₂—O—(4-F—Ph) |
| 253 | CH₃—(CH₂)₃— | 3-CH₃—O— | H— | —CH₂—CH₂—O—(4-Cl—Ph) |
| 254 | CH₂═CH— | 3-CH₃—O— | H— | —CH₃ |
| 255 | CH₂═CH— | 3-CH₃—O— | H— | —CH₂—CH₃ |
| 256 | CH₂═CH— | 3-CH₃—O— | H— | —CH₂—CH≡CH₂ |
| 257 | CH₂═CH— | 3-CH₃—O— | H— | —CH₂—C≡CH |
| 258 | CH₂═CH— | 3-CH₃—O— | H— | —CH₂—C≡C—CH₂—CH₃ |
| 259 | CH₂═CH— | 3-CH₃—O— | H— | —CH₂—C≡C—C₃H₅-cycl |
| 260 | CH₂═CH— | 3-CH₃—O— | H— | —CH₂—C≡C—Ph |
| 261 | CH₂═CH— | 3-CH₃—O— | H— | —CH₂—C≡O-(4-Cl—Ph) |
| 262 | CH₂═CH— | 3-CH₃—O— | H— | —CH₂—CH₂—O—Ph |
| 263 | CH₂═CH— | 3-CH₃—O— | H— | —CH₂—CH₂—O—(4-F—Ph) |
| 264 | CH₂═CH— | 3-CH₃—O— | H— | —CH₂—CH₂—O—(4-Cl—Ph) |
| 265 | CH₃— | 3-CH₃—CH₂—O— | H— | —CH₃ |
| 266 | CH₃— | 3-CH₃—CH₂—O— | H— | —CH₂—CH₃ |
| 267 | CH₃— | 3-CH₃—CH₂—O— | H— | —CH₂—CH═CH₂ |
| 268 | CH₃— | 3-CH₃—CH₂—O— | H— | —CH₂—C≡CH |
| 269 | CH₃— | 3-CH₃—CH₂—O— | H— | —CH₂—C≡C—CH₂—CH₃ |
| 270 | CH₃— | 3-CH₃—CH₂—O— | H— | —CH₂—C≡C—C₃H₆-cycl |
| 271 | CH₃— | 3-CH₃—CH₂—O— | H— | —CH₂—C≡C—Ph |
| 272 | CH₃— | 3-CH₃—CH₂—O— | H— | —CH₂—C≡C—(4-Cl—Ph) |
| 273 | CH₃— | 3-CH₃—CH₂—O— | H— | —CH₂—CH₂—O—Ph |
| 274 | CH₃— | 3-CH₃—CH₂—O— | H— | —CH₂—CH₂—O—(4-F—Ph) |
| 275 | CH₃— | 3-CH₃—CH₂—O— | H— | —CH₂—CH₂—O—(4-Cl—Ph) |
| 276 | (CH₃)₂N— | 3-CH₃—CH₂—O— | H— | —CH₃ |
| 277 | (CH₃)₂N— | 3-CH₃—CH₂—O— | H— | —CH₂—CH₃ |
| 278 | (CH₃)₂N— | 3-CH₃—CH₂—O— | H— | —CH₂—CH═CH₂ |
| 279 | (CH₃)₂N— | 3-CH₃—CH₂—O— | H— | —CH₂—C≡CH |
| 280 | (CH₃)₂N— | 3-CH₃—CH₂—O— | H— | —CH₂—C≡C—CH₂—CH₃ |
| 281 | (CH₃)₂N— | 3-CH₃—CH₂—O— | H— | —CH₂—C≡C—C₃H₅-cycl |
| 282 | (CH₃)₂N— | 3-CH₃—CH₂—O— | H— | —CH₂—C≡C—Ph |
| 283 | (CH₃)₂N— | 3-CH₃—CH₂—O— | H— | —CH₂—C≡C—(4-Cl—Ph) |
| 284 | (CH₃)₂N— | 3-CH₃—CH₂—O— | H— | —CH₂—CH₂—O—Ph |
| 285 | (CH₃)₂N— | 3-CH₃—CH₂—O— | H— | —CH₂—CH₂—O—(4-F—Ph) |
| 286 | (CH₃)₂N— | 3-CH₃—CH₂—O— | H— | —CH₂—CH₂—O—(4-Cl—Ph) |
| 287 | CH₃— | 3-CH₃— | H— | —CH₃ |
| 288 | CH₃— | 3-CH₃— | H— | —CH₂—CH₃ |
| 289 | CH₃— | 3-CH₃— | H— | —CH₂—CH═CH₂ |
| 290 | CH₃— | 3-CH₃— | H— | —CH₂—C≡CH |
| 291 | CH₃— | 3-CH₃— | H— | —CH₂—C≡C—CH₂—CH₃ |
| 292 | CH₃— | 3-CH₃— | H— | —CH₂—C≡C—C₃H₅-cycl |
| 293 | CH₃— | 3-CH₃— | H— | —CH₂—C≡C—Ph |
| 294 | CH₃— | 3-CH₃— | H— | —CH₂—C≡C—(4-Cl—Ph) |
| 295 | CH₃— | 3-CH₃— | H— | —CH₂—CH₂—O—Ph |
| 296 | CH₃— | 3-CH₃— | H— | —CH₂—CH₂—O—(4-F—Ph) |
| 297 | CH₃— | 3-CH₃— | H— | —CH₂—CH₂—O—(4-Cl—Ph) |
| 298 | (CH₃)₂N— | 3-CH₃— | H— | —CH₃ |
| 299 | (CH₃)₂N— | 3-CH₃— | H— | —CH₂—CH₃ |
| 300 | (CH₃)₂N— | 3-CH₃— | H— | —CH₂—CH═CH₂ |
| 301 | (CH₃)₂N— | 3-CH₃— | H— | —CH₂—C≡CH |
| 302 | (CH₃)₂N— | 3-CH₃— | H— | —CH₂—C≡C—CH₂—CH₃ |
| 303 | (CH₃)₂N— | 3-CH₃— | H— | —CH₂—C≡C—C₃H₅-cycl |
| 304 | (CH₃)₂N— | 3-CH₃— | H— | —CH₂—C≡C—Ph |
| 305 | (CH₃)₂N— | 3-CH₃— | H— | —CH₂—C≡C—(4-Cl—Ph) |
| 306 | (CH₃)₂N— | 3-CH₃— | H— | —CH₂—CH₂—O—Ph |
| 307 | (CH₃)₂N— | 3-CH₃— | H— | —CH₂—CH₂—O—(4-F—Ph) |
| 308 | (CH₃)₂N— | 3-CH₃— | H— | —CH₂—CH₂—O—(4-Cl—Ph) |
| 309 | CH₃— | 3-Cl— | H— | —CH₃ |
| 310 | CH₃— | 3-Cl— | H— | —CH₂—CH₃ |
| 311 | CH₃— | 3-Cl— | H— | —CH₂—CH═CH₂ |
| 312 | CH₃— | 3-Cl— | H— | —CH₂—C≡CH |
| 313 | CH₃— | 3-Cl— | H— | —CH₂—C≡C—CH₂—CH₃ |
| 314 | CH₃— | 3-Cl— | H— | —CH₂—C≡C—C₃H₅-cycl |
| 315 | CH₃— | 3-Cl— | H— | —CH₂—C≡C—Ph |
| 316 | CH₃— | 3-Cl— | H— | —CH₂—C≡C—(4-Cl—Ph) |
| 317 | CH₃— | 3-Cl— | H— | —CH₂—CH₂—O—Ph |
| 318 | CH₃— | 3-Cl— | H— | —CH₂—CH₂—O—(4-F—Ph) |
| 319 | CH₃— | 3-Cl— | H— | —CH₂—CH₂—O—(4-Cl—Ph) |
| 320 | (CH₃)₂N— | 3-Cl— | H— | —CH₃ |
| 321 | (CH₃)₂N— | 3-Cl— | H— | —CH₂—CH₃ |
| 322 | (CH₃)₂N— | 3-Cl— | H— | —CH₂—CH═CH₂ |
| 323 | (CH₃)₂N— | 3-Cl— | H— | —CH₂—C≡CH |
| 324 | (CH₃)₂N— | 3-Cl— | H— | —CH₂—C≡C—CH₂—CH₃ |
| 325 | (CH₃)₂N— | 3-Cl— | H— | —CH₂—C≡C—C₃H₅-cycl |
| 326 | (CH₃)₂N— | 3-Cl— | H— | —CH₂—C≡C—Ph |
| 327 | (CH₃)₂N— | 3-Cl— | H— | —CH₂—C≡C—(4-Cl—Ph) |
| 328 | (CH₃)₂N— | 3-Cl— | H— | —CH₂—CH₂—O—Ph |
| 329 | (CH₃)₂N— | 3-Cl— | H— | —CH₂—CH₂—O—(4-F—Ph) |
| 330 | (CH₃)₂N— | 3-Cl— | H— | —CH₂—CH₂—O—(4-Cl—Ph) |
| 331 | CH₃— | 3-CH₃—O— | 5-CH₃—O— | —CH₃ |
| 332 | CH₃— | 3-CH₃—O— | 5-CH₃—O— | —CH₂—CH₃ |
| 333 | CH₃— | 3-CH₃—O— | 5-CH₃—O— | —CH₂—CH═CH₂ |
| 334 | CH₃— | 3-CH₃—O— | 5-CH₃—O— | —CH₂—C≡CH |
| 335 | CH₃— | 3-CH₃—O— | 5-CH₃—O— | —CH₂—C≡C—CH₂—CH₃ |
| 336 | CH₃— | 3-CH₃—O— | 5-CH₃—O— | —CH₂—C≡C—C₃H₅-cycl |
| 337 | CH₃— | 3-CH₃—O— | 5-CH₃—O— | —CH₂—C≡C—Ph |
| 338 | CH₃— | 3-CH₃—O— | 5-CH₃—O— | —CH₂—C≡O-(4-Cl—Ph) |
| 339 | CH₃— | 3-CH₃—O— | 5-CH₃—O— | —CH₂—CH₂—O—Ph |
| 340 | CH₃— | 3-CH₃—O— | 5-CH₃—O— | —CH₂—CH₂—O—(4-F—Ph) |
| 341 | CH₃— | 3-CH₃—O— | 5-CH₃—O— | —CH₂—CH₂—O—(4-Cl-Ph) |
| 342 | (CH₃)₂N— | 3-CH₃—O— | 5-CH₃—O— | —CH₃ |
| 343 | (CH₃)₂N— | 3-CH₃—O— | 5-CH₃—O— | —CH₂—CH₃ |
| 344 | (CH₃)₂N— | 3-CH₃—O— | 5-CH₃—O— | —CH₂—CH═CH₂ |
| 345 | (CH₃)₂N— | 3-CH₃—O— | 5-CH₃—O— | —CH₂—C≡CH |
| 346 | (CH₃)₂N— | 3-CH₃—O— | 5-CH₃—O— | —CH₂—C≡C—CH₂—CH₃ |
| 347 | (CH₃)₂N— | 3-CH₃—O— | 5-CH₃—O— | —CH₂—C≡C—C₃H₅-cycl |
| 348 | (CH₃)₂N— | 3-CH₃—O— | 5-CH₃—O— | —CH₂—C≡C—Ph |
| 349 | (CH₃)₂N— | 3-CH₃—O— | 5-CH₃—O— | —CH₂—C≡C—(4-Cl—Ph) |
| 350 | (CH₃)₂N— | 3-CH₃—O— | 5-CH₃—O— | —CH₂—CH₂—O—Ph |
| 351 | (CH₃)₂N— | 3-CH₃—O— | 5-CH₃—O— | —CH₂—CH₂—O—(4-F—Ph) |
| 352 | (CH₃)₂N— | 3-CH₃—O— | 5-CH₃—O— | —CH₂—CH₂—O—(4-Cl—Ph) |
| 353 | (CH₃)—(CH₂)₃— | 3-CH₃—O— | H— | —CH₃ |
| 354 | Cl—(CH₂)₃— | 3-CH₃—O— | H— | —CH₃ |
| 355 | —C₅H₉-cycl | 3-CH₃—O— | H— | —CH₃ |
| 356 | —C₆H₁₁-cycl | 3-CH₃—O— | H— | —CH₃ |
| 357 | CH₃—SO₂—CH₂— | 3-CH₃—O— | H— | —CH₃ |
| 358 | CH₃OOC—CH₂— | 3-CH₃—O— | H— | —CH₃ |
| 359 | —N(CH₂)₄ | 3-CH₃—O— | H— | —CH₃ |
| 360 | (CH₃)—(CH₂)₃— | 3-CH₃—O— | H— | —CH₂—CH₂—O—Ph |
| 361 | Cl—(CH₂)₃— | 3-CH₃—O— | H— | —CH₂—CH₂—O—Ph |
| 362 | —C₅H₉-cycl | 3-CH₃—O— | H— | —CH₂—CH₂—O—Ph |
| 363 | —C₆H₁₁-cycl | 3-CH₃—O— | H— | —CH₂—CH₂—O—Ph |
| 364 | CH₃—SO₂—CH₂— | 3-CH₃—O— | H— | —CH₂—CH₂—O—Ph |
| 365 | CH₃OOC—CH₂— | 3-CH₃—O— | H— | —CH₂—CH₂—O—Ph |
| 366 | —N(CH₂)₄ | 3-CH₃—O— | H— | —CH₂—CH₂—O—Ph |
| 367 | (CH₃)—(CH₂)₃— | 3-CH₃—O— | H— | —CH₂—C≡C—(4-Cl—Ph) |
| 368 | Cl—(CH₂)₃— | 3-CH₃—O— | H— | —CH₂—C≡C—(4-Cl—Ph) |
| 369 | —C₅H₉-cycl | 3-CH₃—O— | H— | —CH₂—C≡C—(4-Cl—Ph) |
| 370 | —C₆H₁₁-cycl | 3-CH₃—O— | H— | —CH₂—C≡C—(4-Cl—Ph) |
| 371 | CH₃—SO₂—CH₂— | 3-CH₃—O— | H— | —CH₂—C≡C—(4-Cl—Ph) |
| 372 | CH₃OOC—CH₂— | 3-CH₃—O— | H— | —CH₂—C≡C—(4-Cl—Ph) |
| 373 | —N(CH₂)₄ | 3-CH₃—O— | H— | —CH₂—C≡C—(4-Cl—Ph) |
| 374 | CH₃— | 3-Br— | H— | —CH₃ |
| 375 | CH₃— | 3-Br— | H— | —CH₂—CH₂—O—Ph |
| 376 | CH₃— | 3-Br— | H— | —CH₂—C≡C—(4-Cl—Ph) |
| 377 | (CH₃)₂N— | 3-Br— | H— | —CH₃ |
| 378 | (CH₃)₂N— | 3-Br— | H— | —CH₂—CH₂—O—Ph |
| 379 | (CH₃)₂N— | 3-Br— | H— | —CH₂—C≡C—(4-Cl—Ph) |
| 380 | CH₃— | 2-F— | H— | —CH₃ |
| 381 | CH₃— | 2-F— | H— | —CH₂—CH₂—O—Ph |
| 382 | CH₃— | 2-F— | H— | —CH₂—O═O—(4-Cl—Ph) |
| 383 | (CH₃)₂N— | 2-F— | H— | —CH₃ |
| 384 | (CH₃)₂N— | 2-F— | H— | —CH₂—CH₂—O—Ph |
| 385 | (CH₃)₂N— | 2-F— | H— | —CH₂—C≡C—(4-Cl—Ph) |
| 386 | CH₃— | 3-(CH₂═CH—CH₂—O)— | H— | —CH₃ |
| 387 | CH₃— | 3-(CH₂═CH—CH₂—O)— | H— | —CH₂—CH₂—O—Ph |
| 388 | CH₃— | 3-(CH₂═OH—CH₂—O)— | H— | —CH₂—C≡C—(4-Cl—Ph) |
| 389 | (CH₃)₂N— | 3-(CH₂═CH—CH₂—O)— | H— | —CH₃ |
| 390 | (CH₃)₂N— | 3-(CH₂═CH—CH₂—O)— | H— | —CH₂—CH₂—O—Ph |
| 391 | (CH₃)₂N— | 3-(CH₂═CH—CH₂—O)— | H— | —CH₂—C≡C—(4-Cl—Ph) |
| 392 | CH₃— | 3-(CH≡C—CH₂—O)— | H— | —CH₃ |
| 393 | CH₃— | 3-(CH≡C—CH₂—O)— | H— | —CH₂—CH₂—O—Ph |
| 394 | CH₃— | 3-(CH≡C—CH₂—O)— | H— | —CH₂—C≡C—(4-Cl—Ph) |
| 395 | (CH₃)₂N— | 3-(CH≡C—CH₂—O)— | H— | —CH₃ |
| 396 | (CH₃)₂N— | 3-(CH≡C—CH₂—O)— | H— | —CH₂—CH₂—O—Ph |
| 397 | (CH₃)₂N— | 3-(CH≡C—CH₂—O)— | H— | —CH₂—C≡C—(4-Cl—Ph) |

Formulations may be prepared analogously to those described in, for example, WO 5/30651.

Biological Examples

D-1: Action Against Plasmopara viticola (Downy Mildew) on Vines

5 week old grape seedlings cv. Gutedel are treated with the formulated test compound in a spray chamber. One day after application grape plants are inoculated by spraying a sporangia suspension (4×10⁴ sporangia/ml) on the lower leaf side of the test plants. After an incubation period of 6 days at +21° C. and 95% r. h. in a greenhouse the disease incidence is assessed.

Compounds of Tables 1 to 44 exhibit a good fungicidal action against Plasmopara viticola on vines. Compounds 1.087, 1.093, 1.094, 1.095, 1.100, 1.107, 1.110, 1.117, 1.126, 1.127, 1.177, 1.202, 1.204, 1.205, 1.210, 1.211, 12.093, 12.095, 12.123, 12.177 and 12.181 at 200 ppm inhibit fungal infestation in this test to at least 80%, while under the same conditions untreated control plants are infected by the phytopathogenic fungi to over 80%.

D-2: Action Against Phytophthora (Late Blight) on Tomato Plants

3 week old tomato plants cv. Roter Gnom are treated with the formulated test compound in a spray chamber. Two day after application the plants are inoculated by spraying a sporangia suspension (2×10⁴ sporangia/ml) on the test plants. After an incubation period of 4 days at +18° C. and 95% r. h. in a growth chamber the disease incidence is assessed. Compounds of Tables 1 to 44 exhibit a long-lasting effect against fungus infestation. Compounds 1.087, 1.094, 1.095, 1.100, 1.107, 1.110, 1.117, 1.126, 1.127, 1.202, 1.204, 1.205, 1.210, 1.211, 12.093, 12.095, 12.123, 12.127, 12.177 and 12.181 at 200 ppm inhibit fungal infestation in this test to at least 80%, while under the same conditions untreated control plants are infected by the phytopathogenic fungi to over 80%.

D-3: Action Against Phytophthora (Late Blight) on Potato Plants

5 week old potato plants cv. Bintje are treated with the formulated test compound in a spray chamber. Two day after application the plants are inoculated by spraying a sporangia suspension (14×10⁴ sporangia/ml) on the test plants. After an incubation period of 4 days at +18° C. and 95% r. h. in a growth chamber the disease incidence is assessed. Fungal infestation is effectively controlled with compounds of Tables 1 to 44. Compounds 1.107, 1.126, 1.127, 1.202, 1.204, 1.205, 1.210, 1.211, 12.127 and 12.181 at 200 ppm inhibit fungal infestation in this test to at least 80%, while under the same conditions untreated control plants are infected by the phytopathogenic fungi to over 80%.

What is claimed is:

1. N-Bisaryl- and N-aryl-cycloalkylidenyl-α-sulfin- and α-sulfonamino acid amides of the general formula I 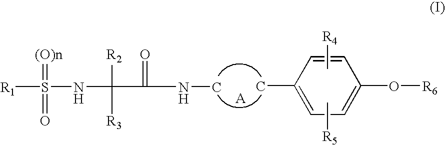
including the optical isomers thereof and mixtures of such isomers, wherein
n is a number zero or one;
R₁ is C₁-C₁₂alkyl; C₁-C₁₂alkyl substituted with C₁-C₄alkoxy, C₁-C₄alkylthio, C₁-C₄alkylsulfonyl, C₃-C₈cycloalkyl, cyano, C₁-C₆alkoxycarbonyl, C₃-C₆alkenyloxycarbonyl or C₃-C₆alkynyloxy-carbonyl; C₂-C₁₂alkenyl; C₂-C₁₂alkynyl; C₁-C₁₂haloalkyl; or a group NR₁₁R₁₂ wherein R₁₁ and R₁₂ are each independently of the other C₁-C₆alkyl, or together are tetra- or penta-methylene;
R₂ and R₃ are each independently hydrogen; C₁-C₈alkyl; C₁-C₈alkyl substituted with hydroxy, mercapto, C₁-C₄alkoxy or C₁-C₄alkylthio; C₃-C₈alkenyl; C₃-C₈alkynyl; C₃-C₈cycloalkyl;
C₃C₈cycloalkyl-C₁-C₄alkyl; optionally substituted aryl; optionally substituted heteroaryl; or
the two groups R₂ and R₃ together with the carbon atom to which they are bonded form a three- to eight-membered hydrocarbon ring;
A is an optionally substituted saturated or unsaturated C₃-C₈-cycloalkylidene, optionally substituted phenylidene or optionally substituted saturated or unsaturated heterocyclylidene bridge,
R₄ and R₅ are each independently hydrogen or an organic radical, and
R₆ is hydrogen; tri-C₁-C₄alkyl-silyl; di-C₁-C₄alkyl-phenylsilyl; C₁-C₄alkyl-diphenylsilyl; tri-phenylsilyl; optionally substituted alkyl; optionally substituted alkenyl or optionally substituted alkynyl.

2. A compound according to claim 1 wherein n is one.

3. A compound of formula I according to claim 1 wherein
R₁ is C₁-C₁₂alkyl; C₁-C₁₋₂alkyl substituted with C₁-C₄alkoxy, C₁-C₄alkylthio or C₁-C₄alkylsulfonyl; C₂-C₁₂alkenyl; C₂-C₁₂alkynyl; C₁-C₁₂haloalkyl or a group NR₁₁R₁₂ wherein R₁, and R₁₂ are each independently of the other hydrogen or C₁-C₆alkyl, or together are tetra- or penta-methylene.

4. A compound of formula I according to claim 1 wherein
R₂ is hydrogen and R₃ is C₁-C₈alkyl; C₁-C₈alkyl substituted with hydroxy, C₁-C₄alkoxy, mercapto or C₁-C₄alkylthio; C₃-C₈alkenyl; C₃-C₈alkynyl; C₃-C₈cycloalkyl; C₃-C₈cycloalkyl-C₁-C₄alkyl or is phenyl; naphthyl or heteroaryl formed by 1 or 2 five- or six-membered rings containing 1 to 4 identical or different heteroatoms selected from oxygen nitrogen or sulfur, wherein each aromatic ring is optionally mono- or poly-substituted with C₁-C₈alkyl, C₂C₈alkenyl, C₂C₈alkynyl, C₃C₈cycloalkyl, C₃C₈cycloalkyl-C₁-C₆alkyl, C₁-C₈alkoxy, C₃C₈alkenyloxy, C₃C₈alkynyloxy, C₁₃C₈cycloalkyloxy, C₁-C₈alkylthio, C₁-C₈alkylsulfonyl, C₁-C₈alkanoyl, C₁-C₈alkoxycarbonyl, C₃C₈alkenyloxycarbonyl, C₃C₈alkynyloxycarbonyl, C₁-C₈dialkylamino, C₁-C₈alkylamino, wherein in turn the alkyl, alkenyl, alkynyl or cycloalkyl moieties may be partially or fully halogenated or with halogen, nitro, cyano, hydroxy or amino.

5. A compound of formula I according to claim 1 wherein
A is optionally substituted saturated or unsaturated carbocycle or heterocycle linked to the remainder of the molecule by vicinal ring member carbon atoms, preferably selected from optionally substituted 1,2-phenylene; optionally substituted 2,3-pyridinylidene; optionally substituted 3,4-pyridinylidene; optionally substituted 2,3-thiophenylidene; optionally substituted 4,5-thiazolinylidene; optionally substituted 1,2-cyclohexylidene; optionally substituted 1,2-cyclopentylidene; optionally substituted 3,4-tetrahydrofuranylidene or optionally substituted 1,2-cyclopropylidene.

6. A compound of formula I according to claim 1 wherein
R₄ is hydrogen; C₁-C₈alkyl; C₂-C₈alkenyl; C₂-C₈alkynyl; C₃-C₈cycloalkyl; C₃-C₈cycloalkyl-C₁-C₄alkyl; C₁-C₈alkylthio; C₁-C₈alkylsulfonyl; C₁-C₈alkoxy; C₃-C₈alkenyloxy; C₃-C₈alkynyloxy; C₃-C₈cycloalkoxy; C₁-C₈alkoxy-C₁-C₄alkyl; C₁-C₈alkoxycarbonyl; C₃-C₈alkenyloxycarbonyl; C₃-C₈alkynyloxycarbonyl; C₁-C₈alkanoyl; C₁-C₈dialkylamino or C₁-C₈alkylamino, wherein in turn the alkyl, alkenyl, alkynyl or cycloalkyl moieties may be partially or fully halogenated; or is carboxyl; formyl; halogen; nitro; cyano; hydroxy or amino.

7. A compound of formula I according to claim 1 wherein
R₅ is hydrogen; C₁-C₈alkyl; C₂-C₈alkenyl; C₂-C₈alkynyl; C₃-C₈cycloalkyl; C₃-C₈cycloalkyl-C₁-C₄alkyl; C₁-C₈alkylthio; C₁-C₈alkylsulfonyl; C₁-C₈alkoxy; C₃-C₈alkenyloxy; C₃-C₈alkynyloxy; C₃-C₈cycloalkoxy; C₁-C₈alkoxy-C₁-C₄alkyl; C₁-C₈alkoxycarbonyl; C₃-C₈alkenyloxycarbonyl; C₃-C₈alkynyloxycarbonyl; C₁-C₈alkanoyl; C₁-C₈dialkylamino or C₁-C₈alkylamino, wherein in turn the alkyl, alkenyl, alkynyl or cycloalkyl moieties may be partially or fully halogenated; or is carboxyl; formyl; halogen; nitro; cyano; hydroxy or amino.

8. A compound of formula I according to claim 1 wherein
R₆ is hydrogen; C₁-C₁₀alkyl; C₃-C₁₀alkenyl; C₃-C₁₀alkynyl; C₁-C₁₀haloalkyl; C₃C₁₀haloalkenyl; C₃-C₁₀haloalkynyl; benzyl; benzyl substituted with C₁-C₈alkyl, C₂-C₈alkenyl, C₂-C₈alkynyl, C₃-C₈cycloalkyl, C₃₋₈cycloalkyl-C₁-C₄alkyl, C₁-C₈alkylthio, C₁-C₈alkylsulfonyl, C₁-C₈alkoxy, C₃-C₈alkenyloxy, C₃-C₈alkynyloxy, C₃-C₈cycloalkoxy, C₁-C₈alkoxy-C₁-C₄alkyl, C₁-C₈alkenyloxy-C₁-C₄alkyl, C₁-C₈alkynyloxy-C₁-C₄alkyl, C₁-C₈alkoxycarbonyl, C₃-C₈alkenyloxycarbonyl, C₃-C₈alkynyloxycarbonyl, C₁-C₈alkanoyl, C₁-C₈dialkylamino, C₁-C₈alkylamino, wherein in turn the alkyl, alkenyl, alkynyl or cycloalkyl moieties may be partially or fully halogenated, carboxyl; formyl; halogen; nitro; cyano; hydroxy; or amino;
a group —CR₇R₈—C≡C—B wherein R₇ and R₅ are independently hydrogen or C₁-C₄alkyl; and B is either C₃-C₈cycloalkyl; phenyl or phenyl substituted by C₁-C₈alkyl, C₂C₈alkenyl, C₂-C₈alkynyl, C₃-C₈cycloalkyl, C₃-C₈cycloalkyl-C₁-C₄alkyl, C₁-C₈alkylthio, C₁-C₈alkylsulfonyl, C₁-C₈alkoxy, C₃-C₈alkenyloxy, C₃-C₈alkynyloxy, C₃-C₈cycloalkoxy, C₁-C₈alkoxy-C₁-C₄alkyl, C₁-C₈alkoxycarbonyl, C₃-C₈alkenyloxycarbonyl, C₃-C₈alkynyloxycarbonyl, C₁-C₈alkanoyl, C₁-C₈dialkylamino, C₁-C₈alkylamino, wherein in turn the alkyl, alkenyl, alkynyl or cycloalkyl moieties may be partially or fully halogenated; carboxyl; formyl; halogen; nitro; cyano; hydroxy or amino; or
a group —CR₇R₈—CR₉R₁₀—X—B wherein R₇, R₈, R₉ and R₁₀ are independently hydrogen or C₁-C₄alkyl; X is —O—, —S— or —NR₁₃— where R₁₃ is hydrogen or C₁-C₄alkyl; and B is either C₃-C₈cycloalkyl; phenyl or phenyl substituted by C₁-C₈alkyl, C₂-C₈alkenyl, C₂-C₈alkynyl, C₃-C₈cycloalkyl, C₃-C₈cycloalkyl-C₁-C₄alkyl, C₁-C₈alkylthio, C₁-C₈alkylsulfonyl, C₁-C₈alkoxy, C₃-C₈alkenyloxy, C₃-C₈alkynyloxy, C₃-C₈cycloalkoxy, C₁-C₈alkoxy-C₁-C₄alkyl, C₁-C₈alkoxycarbonyl, C₃-C₈alkenyloxycarbonyl, C₃-C₈alkynyloxycarbonyl, C₁-C₈alkanoyl, C₁-C₈dialkylamino, C₁-C₈alkylamino, wherein in turn the alkyl, alkenyl, alkynyl or cycloalkyl moieties may be partially or fully halogenated; carboxyl; formyl; halogen; nitro; cyano; hydroxy or amino.

9. A compound of formula I according to claim 1 wherein
n is zero or one; and R₁ is C₁-C₁₂alkyl; C₁-C₁₂alkyl substituted with C₁-C₄alkoxy, C₁-C₄alkylthio or C₁-C₄alkylsulfonyl; C₂-C₁₂alkenyl; C₂-C₁₂alkynyl; C₁-C₁₂haloalkyl or a group NR₁₁R₁₂ wherein R₁₁ and R₁₂ are each independently of the other hydrogen or C₁-C₆alkyl, or together are tetra- or penta-methylene; and R₂ is hydrogen and R₃ is C₁-C₈alkyl; C₁-C₈alkyl substituted with hydroxy, C₁-C₄alkoxy, mercapto or C₁-C₄alkylthio; C₃-C₈alkenyl; C₃-C₈alkynyl; C₃-C₈cycloalkyl; C₃-C₈cycloalkyl-C₁-C₄alkyl or is phenyl; naphthyl or heteroaryl formed by 1 or 2 five- or six-membered rings containing 1 to 4 identical or different heteroatoms selected from oxygen nitrogen or sulfur, wherein each aromatic rings is optionally mono- or poly-substituted with C₁-C₈alkyl, C₂C₈alkenyl, C₂C₈alkynyl, C₃C₈cycloalkyl, C₃-C₈cycloalkyl-C₁C₆alkyl, C₁ C₈alkoxy, C₃-C₈alkenyloxy, C₃C₈alkynyloxy, C₃C₈cycloalkyloxy, C₁ C₈alkylthio, C₁-C₈alkylsulfonyl, C₁-C₈alkanoyl, C₁-C₈alkoxycarbonyl, C₃-C₈alkenyloxycarbonyl, C₃C₈alkynyloxycarbonyl, C₁-C₈dialkylamino, C₁-C₈alkylamino, wherein in turn the alkyl, alkenyl, alkynyl or cycloalkyl moieties may be partially or fully halogenated or with halogen, nitro, cyano, hydroxy or amino; and A is optionally substituted saturated or unsaturated carbocycle or heterocycle linked to the remainder of the molecule by vicinal ring member carbon atoms; and R₄ is hydrogen; C₁-C₈alkyl; C₂-C₈alkenyl; C₂-C₈alkynyl; C₃-C₈cycloalkyl; C₃-C₈cycloalkyl-C₁-C₄alkyl; C₁-C₈alkylthio; C₁-C₈alkylsulfonyl; C₁-C₈alkoxy; C₃-C₈alkenyloxy; C₃-C₈alkynyloxy; C₃-C₈cycloalkoxy; C₁-C₈alkoxy-C₁-C₄alkyl; C₁-C₈alkoxycarbonyl; C₃-C₈alkenyloxycarbonyl; C₃C₈alkynyloxycarbonyl; C₁-C₈alkanoyl; C₁-C₈dialkylamino or C₁-C₈alkylamino, wherein in turn the alkyl, alkenyl, alkynyl or cycloalkyl moieties may be partially or fully halogenated; or is carboxyl; formyl; halogen; nitro; cyano; hydroxy or amino; and R₅ is hydrogen; C₁-C₈alkyl; C₂-C₈alkenyl; C₂-C₈alkynyl; C₃-C₈cycloalkyl; C₃-C₈cycloalkyl-C₁-C₄alkyl; C₁-C₈alkylthio; C₁-C₈alkylsulfonyl; C₁-C₈alkoxy; C₃-C₈alkenyloxy; C₃-C₈alkynyloxy; C₃-C₈cycloalkoxy; C₁-C₈alkoxy-C₁-C₄alkyl; C₁-C₈alkoxycarbonyl; C₃-C₈alkenyloxycarbonyl; C₃-C₈alkynyloxycarbonyl; C₁-C₈alkanoyl; C₁-C₈dialkylamino or C₁-C₈alkylamino, wherein in turn the alkyl, alkenyl, alkynyl or cycloalkyl moieties may be partially or fully halogenated; or is carboxyl; formyl; halogen; nitro; cyano; hydroxy or amino; and R₆ is hydrogen; C₁-C₁₀alkyl; C₃-C₁₀alkenyl; C₃-C₁₀alkynyl; C₁-C₁₀haloalkyl; C₃C₁₀haloalkenyl; C₃-C₁₀haloalkynyl; benzyl; benzyl substituted with C₁-C₈alkyl, C₂-C₈alkenyl, C₂-C₈alkynyl, C₃-C₈cycloalkyl, C₃₋₈cycloalkyl-C₁-C₄alkyl, C₁-C₈alkylthio, C₁-C₈alkylsulfonyl, C₁-C₈alkoxy, C₃-C₈alkenyloxy, C₃-C₈alkynyloxy, C₃-C₈cycloalkoxy, C₁-C₈alkoxy-C₁-C₄alkyl, C₁-C₈alkenyloxy-C₁-C₄alkyl, C₁-C₈alkynyloxy-C₁-C₄alkyl, C₁-C₈alkoxycarbonyl, C₃-C₈alkenyloxycarbonyl, C₃-C₈alkynyloxycarbonyl, C₁-C₈alkanoyl, C₁-C₈dialkylamino, C₁-C₈alkylamino, wherein In turn the alkyl, alkenyl, alkynyl or cycloalkyl moieties may be partially or fully halogenated, carboxyl; formyl; halogen; nitro; cyano; hydroxy; or amino; a group —CR₇R₈—C≡C—B wherein R₇ and R₈ are independently hydrogen or C₁-C₄alkyl; and B is either C₃-C₈cycloalkyl; phenyl or phenyl substituted by C₁-C₈alkyl, C₂-C₈alkenyl, C₂-C₈alkynyl, C₃-C₈cycloalkyl, C₃-C₈cycloalkyl-C₁-C₄alkyl, C₁-C₈alkylthio, C₁-C₈alkylsulfonyl, C₁-C₈alkoxy, C₃-C₈alkenyloxy, C₃-C₈alkynyloxy, C₃-C₈cycloalkoxy, C₁-C₈alkoxy-C₁-C₄alkyl, C₁-C₈alkoxycarbonyl, C₃C₈alkenyloxycarbonyl, C₃-C₈alkynyloxycarbonyl, C₁-C₈alkanoyl, C₁-C₈dialkylamino, C₁-C₈alkylamino, wherein in turn the alkyl, alkenyl, alkynyl or cycloalkyl moieties may be partially or fully halogenated; carboxyl; formyl; halogen; nitro; cyano; hydroxy or amino; or a group —CR₇R₈—CR₉R₁₀—X-B wherein R₇, R₃, R₉ and R₁₀ are independently hydrogen or C₁-C₄alkyl; X is —O—, —S— or —NR₁₃— where R₁₃ is hydrogen or C₁-C₄alkyl; and B is either C₃-Cacycloalkyl; phenyl or phenyl substituted by C₁-C₈alkyl, C₂-C₈alkenyl, C₂-C₈alkynyl, C₃-C₈cycloalkyl, C₃-C₈cycloalkyl-C₁-C₄alkyl, C₁-C₈alkylthio, C₁-C₈alkylsulfonyl, C₁-C₈alkoxy, C₃-C₈alkenyloxy, C₃-C₈alkynyloxy, C₃-C₈cycloalkoxy, C₁-C₈alkoxy-C₁-C₄alkyl, C₁-C₈alkoxycarbonyl, C₃-C₈alkenyloxycarbonyl, C₃-C₈alkynyloxycarbonyl, C₁-C₈alkanoyl, C₁-C₈dialkylamino, C₁-C₈alkylamino, wherein in turn the alkyl, alkenyl, alkynyl or cycloalkyl moieties may be partially or fully halogenated; carboxyl; formyl; halogen; nitro; cyano; hydroxy or amino.

10. A compound of formula I according to claim 1 wherein
n is one; and R₁ is C₁-C₁₂alkyl, C₂-C₁₂alkenyl; C₁-C₁₂haloalkyl or a group NR₁₁R₁₂ wherein R₁₁ and R₁₂ are each independently of the other hydrogen or C₁-C₆alkyl; and R₂ is hydrogen and R₃ is C₁-C₄alkyl; C₃-C₄-alkenyl; cyclopropyl or phenyl, naphthyl, furyl, thienyl, imidazolyl, thiazolyl, oxazolyl, pyridyl, pyrimidinyl, benzothienyl, benzthiazolyl, chinolinyl, pyrazolyl, indolyl, benzimidazolyl or pyrrolyl, wherein each of the aromatic rings is optionally substituted by 1 to 3 substituents selected from C₁-C₈alkyl, C₂-C₈alkenyl, C₃C₈cycloalkyl, C₁-C₈alkoxy, C₁-C₈alkylthio, C₁-C₈alkoxycarbonyl, C₁-C₈haloalkyl, C₁-C₈haloalkoxy, C₁-C₈haloalkylthio, halogen, nitro or cyano; and A is optionally substituted 1,2-phenylene; optionally substituted 2,3-pyridinylidene; optionally substituted 3,4-pyridinylidene; optionally substituted 2,3-thiophenylidene; optionally substituted 4,5-thiazolinylidene; optionally substituted 1,2-cyclohexylidene; optionally substituted 1,2cyclopentylidene; optionally substituted 3,4-tetrahydrofuranylidene or optionally substituted 1,2-cyclopropylidene; and R₄ is hydrogen; C₁-C₈alkyl; C₁-C₈haloalkyl; C₂-C₈alkenyl; C₂-C₈alkynyl; C₁-C₈alkylthio; C₁-C₈haloalkylthio; C₁-C₈alkoxy; C₁-C₈haloalkoxy; C₁-C₈alkoxy-C₁-C₄alkyl; C₁-C₈alkoxycarbonyl; C₁-C₈alkanoyl; formyl; halogen; nitro; cyano or hydroxy; and R₅ is hydrogen; C₁-C₄alkyl; C₁-C₄haloalkyl; C₁-C₄alkoxy; C₁-C₄alkoxycarbonyl; C₁-C₄alkanoyl; formyl; halogen; cyano or hydroxy; and R₆ is hydrogen; C₁-C₈alkyl; C₃-C₈alkenyl; C₃C₈alkynyl; C₁-C₆alkoxy-C₁-C₄alkyl; C₃C₆alkenyloxy-C₁-C₄alkyl; C₃-C₆alkynyloxy-C₁-C₄alkyl; benzyl; benzyl substituted with C₁-C₈alkyl, C₂-C₈alkenyl, C₂-C₈alkynyl, C₁-C₈alkylthio, C₁-C₈alkoxy, C₁-C₈haloakyl, halogen, nitro or cyano; a group —CH₂—C≡C—B where B is either C₃-C₆cycloalkyl, phenyl or phenyl substituted with C₁-C₈alkyl, C₁-C₈alkylthio, C₁-C₈alkoxy, C₁-C₈haloalkyl, halogen, nitro or cyano; or a group CH₂—CH₂—O—B where B is either C₃-C₆cycloalkyl, phenyl or phenyl substituted with C₁-C₈-alkyl, C₁-C₈-alkylthio, C₁-C₈-alkoxy, C₁-C₈-haloalkyl, halogen, nitro or cyano.

11. A compound of formula I according to claim 1 wherein
n is one; and R₁ is C₁-C₄alkyl, C₂-C₄alkenyl; C₁-C₄haloalkyl or C₁-C₂dialkylamino; and R₂ is hydrogen and R₃ is C₃-C₄alkyl; allyl; cyclopropyl; phenyl or phenyl substituted with 1 to 3 substituents selected from C₁-C₈alkyl, C₂-C₈alkenyl, C₃C₈cycloalkyl, C₁-C₈alkoxy, C₁-C₈alkylthio, C₁-C₈alkoxycarbonyl, C₁-C₈haloalkyl, C₁-C₈haloalkoxy, C₁-C₈haloalkylthio, halogen, nitro or cyano; and A is 1,2-phenylene; 2,3-pyridinylidene; 3,4-pyridinylidene or 2,3-thiophenylidene; each optionally substituted with halogen, C₁-C₆alkyl, C₁-C₆alkoxy, C₁-C₆haloalkyl, C₁-C₆alkoxycarbonyl, nitro or cyano; or is 1,2-cyclohexylidene; 1,2-cyclopentylidene; 3,4-tetrahydrofuranylidene or 1,2-cyclopropylidene, each optionally substituted with C₁-C₆-alkyl; and R₄ is hydrogen; C₁-C₄alkyl; C₁-C₄alkoxy; C₁-C₄haloalkoxy-or halogen; and R₅ is hydrogen; C₁-C₄alkyl; halogen or cyano; and R₆ is C₁-C₆alkyl; C₃-C₆alkenyl; C₃-C₆alkynyl; C₁-C₆alkoxy-C₁-C₄alkyl; C₃-C₆alkenyloxy-C₁-C₄alkyl; C₃-C₆alkynyloxy-C₁-C₄alkyl; benzyl; benzyl substituted with C₁-C₄alkyl; C₁-C₈haloalkyl or halogen; a group —CH₂—C≡C—B where B is either C₃-C₆cycloalkyl, phenyl or phenyl substituted with by C₁-C₄alkyl or halogen, or a group —CH₂—CH₂—O—B where B is either C₃C₆cycloalkyl, phenyl or phenyl substituted with C₁-C₈alkyl, halogen.

12. A compound of formula I according to claim 1 wherein
n is one; and R₁ is C₁-C₄alkyl, vinyl; C₁-C₄haloalkyl or dimethylamino; and R₂ is hydrogen and R₃ is 2-propyl; phenyl; C₁₋₄alkylphenyl or halophenyl; and A is 1,2-phenylene; 1,2-cyclohexylidene or 1,2-cyclopropylidene; and R₄ is hydrogen; methoxy or ethoxy; and R₅ is hydrogen; and R₆ is C₁-C₆alkyl; C₃-C₆alkenyl; C₃-C₆alkynyl; C₁-C₆alkoxy-C₁-C₄alkyl; C₁-C₆alkenyloxy-C₁-C₄alkyl; C₃-C₆alkynyloxy-C₁-C₄alkyl; benzyl; benzyl substituted with C₁-C₄alkyl, C₁-C₈haloalkyl or halogen; a group —CH₂—C≡C—B where B is either C₃-C₆cycloalkyl, phenyl or phenyl substituted with C₁-C₄alkyl or halogen; or a group —CH₂—CH₂—O—B where B is either C₃C₆cycloalkyl, phenyl or phenyl substituted with C₁-C₈alkyl or halogen.

13. A compound of formula I according to claim 1 selected from the group comprising
(2S)-2-ethanesulfonylamino-N-(3′-methoxy-4′-prop-2-ynyloxy-biphenyl-2-yl)-3-methyl-butyramide,
(2S)-2-methanesulfonylamino-N-(3′-methoxy-4′-prop-2-ynyloxy-biphenyl-2-yl)-3-methyl-butyramide,
(2S)-2-{[(dimethylamino)-sulfonyl]-amino}-N-(3′-methoxy-4′-prop-2-ynyloxy-biphenyl-2-yl)-3-methyl-butyramide,
(2S)-N-(3′,4′-dimethoxy-biphenyl-2-yl)-2-methanesulfonylamino-3-methyl-butyramide,
(2S)-N-(3′,4′-dimethoxy-biphenyl-2-yl)-2-ethanesulfonylamino-3-methyl-butyramide,
(2S)-N-(3′, 4-dimethoxy-biphenyl-2-yl)-2-{[(dimethylamino)-sulfonyl]-amino}-3-methyl-butyramide,
(2S)-2-methanesulfonylamino-N-(3′-methoxy-4′-pent-2-ynyloxy-biphenyl-2-yl)-3-methyl-butyramide,
(2S)-2-ethanesulfonylamino-N-(3′-methoxy-4′-pent-2-ynyloxy-biphenyl-2-yl)-3-methyl-butyramide,
(2S)-2-{[(dimethylamino)-sulfonyl]-amino}-N-(3′-methoxy-4′-pent-2-ynyloxy-biphenyl-2-yl)-3-methyl-butyramide,
(2S)-N-(4′-ethoxy-3′-methoxy-biphenyl-2-yl)-2-methanesulfonylamino-3-methyl-butyramide,
(2S)-2-ethanesulfonylamino-N-(4′-ethoxy-3′-methoxy-biphenyl-2-yl)-3-methyl-butyramide,
(2S)-2-{[(dimethylamino)-sulfonyl]-amino}-N-(4′-ethoxy-3′-methoxy-biphenyl-2-yl)-3-methyl-butyramide,
(2S)-2-methanesulfonylamino-N-[trans-2-(3-methoxy-4-prop-2-ynyloxy-phenyl)-cyclohexyl]-3-methyl-butyramide,
(2S)-2-ethanesulfonylamino-N-[trans-2-(3-methoxy-4-prop-2-ynyloxy-phenyl)-cyclohexyl]-3-methyl-butyramide,
(2S)-2-{[(dimethylamino)-sulfonyl]-amino}-N-[trans-2-(3-methoxy-4-prop-2-ynyloxy-phenyl)-cyclohexyl]-3-methyl-butyramide,
(2S)-2-methanesulfonylamino-N-[trans-2-(3-methoxy-4-pent-2-ynyloxy-phenyl)-cyclohexyl]-3-methyl-butyramide,
(2S)-2-ethanesulfonylamino-N-[trans-2-(3-methoxy-4-pent-2-ynyloxy-phenyl)-cyclohexyl]-3-methyl-butyramide, and
(2S)-2-{[(dimethylamino)-sulfonyl]-amino}N-[trans-2-(3-methoxy-4-pent-2-ynyloxy-phenyl)-cyclohexyl]-3-methyl-butyramide.

14. A process for the preparation of a compound of formula I according to claim 1, which comprises reacting
a) an amino acid of formula II or a carboxyl-activated derivative of an amino acid of formula II 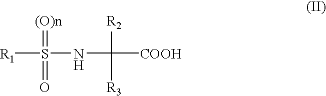
wherein R₁, n, R₂ and R₃ are as defined for formula I, with an amine of formula III 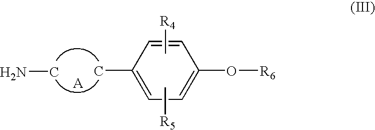
wherein A, R₄, R₅ and R₆, are as defined for formula I, or
b) an amino acid derivative of formula V 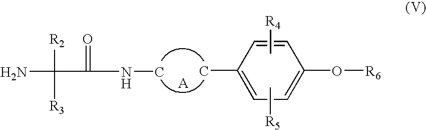
wherein R₂, R₃, R₄, R₅ and R₆ are as defined for formula I, with a sulfonyl halide or a sulfinyl halide of formula IV 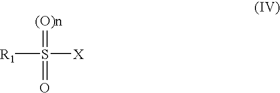
wherein R₁ and n are as defined for formula I and where X is halide, preferentially chlorine or bromine, or
c) a phenol of formula I′ 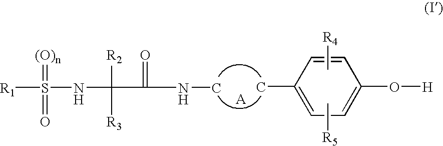
where R₁, n, R₂, R₃, R₄, and R₅ are as defined for formula I, with a compound of formula VI
Y—R₆ (VI)
where R₆ is as defined for formula I but is not hydrogen and where Y is a leaving group like
